(19) United States
(12) Patent Application Publication
(10) Pub. No.: US 2020/0395584 A1
(43) Pub. Date: Dec. 17, 2020

(54) CATHOLYTE MANAGEMENT FOR A SOLID-STATE SEPARATOR

(71) Applicant: QUANTUMSCAPE CORPORATION, San Jose, CA (US)

(72) Inventors: William H. GARDNER, Concord, CA (US); Joseph SALVI, Santa Clara, CA (US)

(21) Appl. No.: 16/766,214

(22) PCT Filed: Nov. 28, 2018
(86) PCT No.: PCT/US2018/062915

§ 371 Date: May 21, 2020

Related U.S. Application Data
(60) Provisional application No. 62/591,684, filed on Nov. 28, 2017.
(60) Provisional application No. 62/671,927, filed on May 15, 2018.

(51) Int. Cl. H01M 2/16; H01M 4/38; H01M 10/0565; H01M 4/64

(52) U.S. Cl. CPC H01M 2/1653; H01M 4/382; H01M 10/0565; H01M 2004/028; H01M 2300/0068; H01M 2300/0085; H01M 4/64

(57) ABSTRACT

Provided herein are electrochemical cells that include a seal impermeable to a liquid electrolyte and that is bonded to a solid-state Li ion-conducting electrolyte in a manner that effectively isolates and protects a Li metal negative electrode from exposure to either, or both, a liquid electrolyte or a gel electrolyte used as a catholyte in the positive electrode. Some of the electrochemical cells include a series of electrochemical stacks, which may be stacked in a variety of configurations including configurations that share a Li metal negative electrode.

### CROSS REFERENCE

This application claims the benefit of priority to U.S. Provisional Patent Application Ser. No. 62/591,684, filed Nov. 28, 2017, and U.S. Provisional Patent Application Ser. No. 62/671,927, filed May 15, 2018, of which each application is entirely incorporated herein by reference in their entirety for all purposes.

The present disclosure sets forth solid-state lithium (Li) ion-conducting electrolytes and electrochemical cells including these electrolytes. The present disclosure concerns solid-state rechargeable batteries, which are also known as secondary batteries.

### BACKGROUND

As one strategy for maximizing the energy density is a rechargeable Li-ion battery, researchers try to incorporate Li-metal anodes. The voltage of a battery is determined by the potential difference for Li situated in the anode with respect to Li situated in the cathode. Since the voltage of Li in Li-metal is OV, the difference between any cathode and any anode in a rechargeable Li-ion battery is maximized when the anode is Li-metal. Because Li-metal is so reactive, systems and methods for limiting the exposure of Li-metal to reactive species, e.g., organic solvents, are required for rechargeable Li-ion battery having Li-metal anodes to be stable enough for commercial applications.

Certain strategies for protecting the Li-metal anodes in an electrochemical cell are known, e.g., U.S. Pat. No. 8,129,052. However, these strategies rely on bonds between a seal around the Li-metal anode and the container of the electrochemical cell, as well as other components of the electrochemical cell, to isolate the Li metal anode from exposure to ambient conditions. These strategies also suffer from low energy density due to the volume of materials needed to protect the Li-metal anode.

Rechargeable batteries, which include electrochemical cells having solid-state separator electrolytes, are attractive alternatives to conventional batteries, which use organic solvent, liquid-based electrolytes. These advantages include safety, since solid-state separators are not flammable like organic solvents, as well as other advantages such as improved energy density.

One problem is that some cathode architectures, useful for achieving high energy density as well as high capacity and power output, introduce new safety and performance challenges that must be overcome. For example, cathode architectures that include liquid solvents introduce safety and performance challenges when paired with solid-state separators that are designed for lithium metal anodes. If the liquid solvent contacts the lithium metal anode, detrimental chemical reactions occur which degrade the battery performance.

Other challenges remain regarding how safely to combine cathode architectures that include liquid solvents with solid-state separator electrolytes.

Accordingly, new materials, methods, and uses of seals for protecting Li-metal anodes in rechargeable Li-ion batteries is needed. Set forth herein are solutions to this problem as well as other unmet needs in the relevant field to which the instant disclosure pertains.

### SUMMARY

In one embodiment, set forth herein is an electrochemical stack, including a solid-state electrolyte; a positive electrode that includes a liquid electrolyte, a gel electrolyte, or both; a positive electrode current collector; and a seal impermeable to the liquid electrolyte or the gel electrolyte that bonds to the positive electrode current collector and to the solid-state electrolyte. The seal isolates the liquid electrolyte, the gel electrolyte, or both, in the positive electrode from the negative electrode.

In a second embodiment, set forth herein is an electrochemical cell that includes a container, at least one electrochemical stack in the container, in which the electrochemical stack includes at least a solid-state electrolyte, a positive electrode that includes a liquid electrolyte, a gel electrolyte, or both, and a positive electrode current collector. The electrochemical cell also includes a seal impermeable to the liquid electrolyte or the gel electrolyte. The seal bonds to the positive electrode current collector and to the solid-state electrolyte, and in which the seal is not bonded to the container. The seal isolates the liquid electrolyte, the gel electrolyte, or both, in the positive electrode from the negative electrode.

In a third embodiment, set forth herein is a method of making an electrochemical cell, including the following: providing a positive electrode current collector on a substrate; applying a seal material on the current collector; providing an electrochemical stack on the seal material, wherein the electrochemical stack includes: a solid-state electrolyte; and a positive electrode that includes a liquid electrolyte, a gel electrolyte, or both. The electrochemical stack is applied so that the positive electrode current collector contacts the positive electrode. The seal material is impermeable to the liquid electrolyte or the gel electrolyte and bonds to the positive electrode current collector and to the solid-state electrolyte. The method also includes enclosing the cell stack within polyether ether ketone (PEEK); and applying at least 3 pounds per square inch (PSI) to the electrochemical cell.

In a fourth embodiment, set forth herein is a method of making an electrochemical cell, including the following: providing a positive electrode current collector on a substrate; providing a seal material on the positive electrode current collector; providing a polyether ether ketone (PEEK) enclosure; providing an electrochemical stack on the seal material and within the PEEK enclosure, wherein the electrochemical stack includes: a solid-state electrolyte; and a positive electrode that includes a liquid electrolyte or a gel electrolyte. The seal material is impermeable to the liquid electrolyte or the gel electrolyte that bonds to the positive electrode current collector and to the solid-state electrolyte. The method further includes applying at least 3 pounds per square inch (PSI) to the electrochemical cell.

In one embodiment, set forth herein is an electrochemical cell comprising: a positive electrode current collector; a positive electrode comprising a liquid electrolyte; a bilayer solid-state electrolyte having a first layer comprising a sulfide and a second layer comprising a lithium phosphorus sulfur halide; a negative electrode current collector; and a seal impermeable to the liquid electrolyte, which seals the interface between the positive electrode current collector and the positive electrode; and which seals the interface between the positive electrode and the first layer of the bilayer solid-state electrolyte; wherein the first layer is in direct contact with the positive electrode.

In another embodiment, set forth herein is a rechargeable battery comprising an electrochemical cell set forth herein.

In another embodiment, set forth herein is an electric vehicle comprising a rechargeable battery set forth herein.

In another embodiment, set forth herein is a process for making an electrochemical cell, comprising:
providing a bilayer solid-state electrolyte having a first layer comprising a sulfide and a second layer comprising a lithium phosphorus sulfur halide on a substrate;
   wherein the second layer is in direct contact with the substrate;
providing a first seal around and in contact with the bilayer solid-state electrolyte;
   wherein the seal covers the edges of the solid-state electrolyte;
providing a positive electrode comprising a liquid electrolyte on top of the solid-state electrolyte;
pressing the positive electrode comprising a liquid electrolyte onto the solid-state electrolyte and first seal;
applying a second seal around the first seal; and
applying at least 3 pounds per square inch (PSI) to the electrochemical cell.

In an aspect, the present disclosure provides an electrochemical stack, comprising: a solid-state electrolyte; a positive electrode comprising a liquid electrolyte or a gel electrolyte; a positive electrode current collector; and a seal impermeable to the liquid electrolyte or the gel electrolyte that bonds to the positive electrode current collector and to the solid-state electrolyte. In some embodiments, the seal contains the liquid electrolyte or the gel electrolyte in the positive electrode. In some embodiments, the solid-state electrolyte is impermeable to the liquid electrolyte or the gel electrolyte. In some embodiments, the seal bonds to a face of the positive electrode current collector. In some embodiments, the seal bonds to a face of the solid-state electrolyte. In some embodiments, the seal bonds to a side-edge of the solid-state electrolyte. In some embodiments, the seal bonds to a face of the solid-state electrolyte and to a side-edge of the solid-state electrolyte. In some embodiments, the electrochemical stack further comprises a lithium (Li) metal negative electrode. In some embodiments, the electrochemical stack further comprises a negative electrode current collector.

In some embodiments, the electrochemical stack is in a container and wherein the seal is not bonded to the container. In some embodiments, the container comprises conductive tab leads. In some embodiments, the diameter of the solid-state electrolyte is greater than the diameter of the lithium metal negative electrode. In some embodiments, the diameter of the solid-state electrolyte is greater than the diameter of the positive electrode. In some embodiments, the width or diameter of the solid-state electrolyte is greater than either of the diameter of the lithium metal negative electrode or of the positive electrode. In some embodiments, the width or diameter of the solid-state electrolyte is greater than the width or diameter of the lithium metal negative electrode. In some embodiments, the width or diameter of the solid-state electrolyte is greater than the width or diameter of the positive electrode.

In some embodiments, the width or diameter of the solid-state electrolyte is greater than both the width and the diameter of the lithium metal negative electrode and the width and the diameter of the positive electrode. In some embodiments, the solid-state electrolyte has raised edges. In some embodiments, the solid-state electrolyte has coated edges. In some embodiments, the solid-state electrolyte has edges with a composition that differs from bulk by more than 10% in any element, wherein the edge is the outer 0.01-1 mm. In some embodiments, the coated edges comprise a coating selected from parylene, polypropylene, polyethylene, alumina, Al₂O₃, ZrO₂, TiO₂, SiO₂, a binary oxide, La₂Zr₂O₇, a lithium carbonate species, or a glass, wherein the glass is selected from SiO₂—B₂O₃, and Al₂O₃. In some embodiments, the solid-state electrolyte has tapered edges. In some embodiments, the seal has a hardness of 30-150 durometer.

In some aspects, the present disclosure provides an electrochemical cell comprising at least one or more electrochemical stacks disclosed herein.

In some aspects, the present disclosure provides an electrochemical cell, comprising: a container; at least one electrochemical stack in the container, the electrochemical stack comprising at least: a solid-state electrolyte; a positive electrode comprising a liquid electrolyte or a gel electrolyte; a positive electrode current collector; and a seal impermeable to the liquid electrolyte or the gel electrolyte that bonds to the positive electrode current collector and to the solid-state electrolyte, wherein the seal is not bonded to the container. In some embodiments, the seal contains the liquid electrolyte or the gel electrolyte in the positive electrode. In some embodiments, the electrochemical cell further comprises a lithium (Li) metal negative electrode. In some embodiments, the electrochemical cell further comprises a negative electrode current collector. In some embodiments, the electrochemical cell further comprises a negative electrode current collector and Li metal, wherein the Li metal is between and in contact with the solid-state electrolyte and the negative electrode current collector.

In some embodiments, the solid-state electrolyte is impermeable to the liquid electrolyte or the gel electrolyte. In some embodiments, the seal bonds to a face of the positive electrode current collector. In some embodiments, the seal bonds to a face of the solid-state electrolyte. In some embodiments, the seal bonds to a side-edge of the solid-state electrolyte. In some embodiments, the seal bonds to a face of the solid-state electrolyte and to a side-edge of the solid-state electrolyte. In some embodiments, the seal is made of a single material. In some embodiments, the seal comprises more than a single type of material. In some embodiments, the seal is made of polypropylene. In some embodiments, the seal is made of a multilayer. In some embodiments, the seal comprises a top layer, a bottom layer, and a middle layer. In some embodiments, the seal comprises a material selected from the group consisting of polyisobutylene (PIB), polyether ether ketone (PEEK), polypropylene, a polyolefin, and combinations thereof. In some embodiments, the top layer of the seal and bottom layer of the seal are the same material. In some embodiments, the middle layer of the seal is a different material than the top layer or bottom layer. In some embodiments, the top layer and the bottom layer are PIB. In some embodiments, the middle layer is PEEK. In some embodiments, the seal comprises a thermoplastic olefin (e.g., AFFINITY™ EG 8185).

In some embodiments, the electrochemical cell is a coin cell and the seal is a circular ring. In some embodiments, the electrochemical cell comprises a disc-shaped solid-state electrolyte. In some embodiments, the electrochemical cell comprises a disc-shaped positive electrode. In some embodiments, the diameter of the disc-shaped solid-state electrolyte is at least 0.25 times as large as the diameter of the disc-shaped positive electrode. In some embodiments, the electrochemical cell is a prismatic cell and the seal has a shape selected from the group consisting of a square frame and a rectangular frame. In some embodiments, the width of the solid-state electrolyte is larger than the width of the positive electrode. In some embodiments, the solid-state electrolyte is selected from the group consisting of a lithium-stuffed garnet, a sulfide electrolyte doped with oxygen, a sulfide electrolyte comprising oxygen, a lithium aluminum titanium oxide, a lithium aluminum titanium phosphate, a lithium aluminum germanium phosphate, a lithium aluminum titanium oxy-phosphate, a lithium lanthanum titanium oxide perovskite, a lithium lanthanum tantalum oxide perovskite, a lithium lanthanum titanium oxide perovskite, an antiperovskite, a LISICON, a LI—S—O—N, lithium aluminum silicon oxide, a Thio-LISICON, a lithium-substituted NASICON, a LIPON, or a combination, mixture, or multilayer thereof.

In some embodiments, the solid-state electrolyte comprises a lithium lanthanum titanium oxide characterized by the empirical formula, Li₃ₓLa_{2/3-x}TiO₃, wherein x is a rational number from 0 to ⅔. In some embodiments, the solid-state electrolyte comprises a lithium lanthanum titanium oxide characterized by the empirical formula, Li₃ₓLa_{2/3-x}TiⱼTaₖO₃, wherein x is a rational number from 0 to ⅔, and wherein subscripts j+k=1. In some embodiments, the solid-state electrolyte comprises a lithium lanthanum titanium oxide characterized by a perovskite crystal structure. In some embodiments, the solid-state electrolyte comprises an antiperovskite characterized by the empirical formula, Li₃OX wherein X is Cl, Br, or combinations thereof. In some embodiments, the solid-state electrolyte comprises a LISICON characterized by the empirical formula, Li(Me′ₓ,Me″_{y})(PO₄) wherein Me′ and Me″ are selected from Si, Ge, Sn or combinations thereof; and wherein 0≤x≤1; wherein 0≤y≤1, and wherein x+y=1. In some embodiments, the solid-state electrolyte comprises a thio-LISICON characterized by the empirical formula, Li_{3.25}Ge_{0.25}P_{0.75}S₄. In some embodiments, the solid-state electrolyte comprises a thio-LISICON characterized by the empirical formula, Li₄₋ₓM₁₋ₓPₓS₄ or Li₁₀MP₂S₂₃, wherein M is selected from Si, Ge, Sn, or combinations thereof and wherein 0≤x≤1. In some embodiments, the solid-state electrolyte comprises a lithium aluminum titanium phosphate characterized by the empirical formula, Li₁₊ₓAlₓTi₂₋ₓ(PO₄), wherein 0≤x≤2. In some embodiments, the solid-state electrolyte comprises a lithium aluminum germanium phosphate characterized by the empirical formula, Li_{1.5}Al_{0.5}Ge_{1.5}(PO₄).

In some embodiments, the solid-state electrolyte comprises a LI-S-O-N characterized by the empirical formula, LiₓS_{y}O_{z}N, wherein x, y, z, and w, are a rational number from 0.01 to 1. In some embodiments, the solid-state electrolyte comprises a material characterized by the empirical formula LiₓLa₃Zr₂Oₕ+yAl₂O₃, wherein 3≤x≤8, 0≤y≤1, and 6≤h≤15; and wherein subscripts x and h, and coefficient y is selected so that the electrolyte separator is charge neutral. In some embodiments, the solid-state electrolyte is doped with Ga, Nb, Ta, or combinations thereof. In some embodiments, the seal is substantially as set forth in any one of FIG. 1A, 1B, 2, 3, 4A, 4B, 5, 6, 7, 8, 9, 10A, 10B, or 11B. In some embodiments, the thickness of the seal matches the thickness of positive electrode containing the electrolyte. In some embodiments, the positive electrode comprises a gel electrolyte. In some embodiments, the liquid electrolyte or gel electrolyte comprises: a lithium salt selected from the group consisting of LiPF₆, LiBOB, LiTFSi, LiBF₄, LiClO₄, LiAsF₆, LiFSI, LiI, and a combination thereof; and a solvent selected from the group consisting of ethylene carbonate (EC), diethylene carbonate, diethyl carbonate, dimethyl carbonate (DMC), ethyl-methyl carbonate (EMC), tetrahydrofuran (THF), γ-Butyrolactone (GBL), fluoroethylene carbonate (FEC), fluoromethyl ethylene carbonate (FMEC), trifluoroethyl methyl carbonate (F-EMC), fluorinated 3-(1,1,2,2-tetrafluoroethoxy)-1,1,2,2-tetrafluoropropane/1,1,2,2-Tetrafluoro-3-(1,1,2,2-tetrafluoroethoxy)propane (F-EPE), fluorinated cyclic carbonate (F-AEC), propylene carbonate (PC), dioxolane, acetonitrile (ACN), succinonitrile, adiponitrile, hexanedinitrile, pentanedinitrile, sulfolane, acetophenone, isophorone, benzonitrile, dimethyl sulfate, dimethyl sulfoxide (DMSO) ethyl acetate, methyl butyrate, dimethyl ether (DME), diethyl ether, propylene carbonate, dioxolane, glutaronitrile, gamma butyl-lactone, and combinations thereof.

In some embodiments, the liquid electrolyte or gel electrolyte comprises a polymer selected from the group consisting of polyacrylonitrile (PAN), polypropylene, polyethylene oxide (PEO), polymethyl methacrylate (PMMA), polyvinyl chloride (PVC), polyvinyl pyrrolidone (PVP), polyethylene oxide poly(allyl glycidyl ether) PEO-AGE, polyethylene oxide 2-methoxyethoxy)ethyl glycidyl ether (PEO-MEEGE), polyethylene oxide 2-methoxyethoxy)ethyl glycidyl poly(allyl glycidyl ether) (PEO-MEEGE-AGE), polysiloxane, polyvinylidene fluoride (PVDF), polyvinylidene fluoride hexafluoropropylene (PVDF-HFP), rubbers such as ethylene propylene (EPR), nitrile rubber (NPR), styrene-butadiene-rubber (SBR), polybutadiene polymer, polybutadiene rubber (PB), polyisobutadiene rubber (PIB), polyisoprene rubber (PI), polychloroprene rubber (CR), acrylonitrile-butadiene rubber (NBR), polyethyl acrylate (PEA), polyethylene (e.g., low density linear polyethylene), and combinations thereof. In some embodiments, the polymer is polyacrylonitrile (PAN) or polyvinylidene fluoride hexafluoropropylene (PVDF-HFP). In some embodiments, the polymer is selected from the group consisting of PAN, PVDF-HFP, PVDF-HFP and PAN, PMMA, PVC, PVP, PEO, and combinations thereof. In some embodiments, the liquid electrolyte or gel electrolyte comprises: a solvent selected from the group consisting of ethylene carbonate (EC), propylene carbonate (PC), dimethyl carbonate (DMC), methylene carbonate, and combinations thereof; a polymer selected from the group consisting of PVDF-HFP, PAN, and combinations thereof; and a lithium salt selected from the group consisting of LiPF₆, LiBOB, LFTSi, and combinations thereof. In some embodiments, the lithium salt is selected from LiPF₆, LiBOB, LFTSi, and combinations thereof.

In some embodiments, the lithium salt is LiPF₆ at a concentration of 0.5 M to 2M. In some embodiments, the lithium salt is LiTFSI at a concentration of 0.5 M to 2M In some embodiments, the lithium is present at a concentration from 0.01 M to 10 M. In some embodiments, the solvent is a 1:1 w/w mixture of EC:PC. In some embodiments, the positive electrode comprises a lithium intercalation material, a lithium conversion material, or both a lithium intercalation material and a lithium conversion material. In some embodiments, the intercalation material is selected from the group consisting of a nickel manganese cobalt oxide (NMC), a nickel cobalt aluminum oxide (NCA), Li(NiCoAl)O₂, a lithium cobalt oxide (LCO), a lithium manganese cobalt oxide (LMCO), a lithium nickel manganese cobalt oxide (LMNCO), a lithium nickel manganese oxide (LNMO), Li(NiCoMn)O₂, LiMn₂O₄, LiCoO₂, and LiMn₂₋ₐNiₐO₄, wherein a is from 0 to 2, or LiMPO₄, wherein M is Fe, Ni, Co, or Mn. In some embodiments, the lithium conversion material is selected from the group consisting of FeF₂, NiF₂, FeOₓF₃₋₂ₓ, FeF₃, MnF₃, CoF₃, CuF₂ materials, alloys thereof, and combinations thereof. In some embodiments, the electrochemical cell is pressurized. In some embodiments, the electrochemical cell further comprises: a polyether ether ketone (PEEK) ring surrounding the positive electrode, the solid-state electrolyte and the Li metal negative electrode.

In some embodiments, the diameter of the solid-state electrolyte is greater than the diameter of the lithium metal negative electrode. In some embodiments, diameter of the solid-state electrolyte is greater than the diameter of the positive electrode. In some embodiments, width or diameter of the solid-state electrolyte is greater than either of the diameter of the lithium metal negative electrode or of the positive electrode. In some embodiments, width or diameter of the solid-state electrolyte is greater than the width or the diameter of the lithium metal negative electrode. In some embodiments, width or diameter of the solid-state electrolyte is greater than the width or the diameter of the positive electrode. In some embodiments, width or diameter of the solid-state electrolyte is greater than both the width or the diameter of the lithium metal negative electrode and the width or the diameter of the positive electrode. In some embodiments, the solid-state electrolyte has raised edges. In some embodiments, the solid-state electrolyte has coated edges. In some embodiments, the coated edges comprise a coating selected from parylene, polypropylene, polyethylene, alumina, Al₂O₃, ZrO₂, TiO₂, SiO₂, a binary oxide, La₂Zr₂O₇, a lithium carbonate species, or a glass, wherein the glass is selected from SiO₂—B₂O₃, or Al₂O₃. In some embodiments, the solid-state electrolyte has tapered edges.

In an aspect, the present disclosure provides a battery comprising at least one electrochemical cell disclosed herein. In some embodiments, an electrochemical cell disclosed herein has a seal, wherein the seal has a hardness of 30-150 durometer.

In an aspect, the present disclosure provides a device comprising a battery disclosed herein. In an aspect, the present disclosure provides a device comprising an electrochemical cell disclosed herein.

In an aspect, the present disclosure provides a method of making an electrochemical cell, comprising: providing a positive electrode current collector on a substrate; applying a seal material on the current collector; wherein the current collector is part of an electrochemical stack, wherein the electrochemical stack comprises: a solid-state electrolyte; a positive electrode comprising a liquid electrolyte or a gel electrolyte; and a positive electrode current collector; wherein the seal material is impermeable to the liquid electrolyte or the gel electrolyte that bonds to the positive electrode current collector and to the solid-state electrolyte; enclosing the cell stack within a pressure ring; and applying at least 3 pounds per square inch (PSI) to the electrochemical cell. In some embodiments, the application of the seal material is after assembly of the electrochemical stack. In some embodiments, the application of the seal material is via a spray. In some embodiments, the application of the seal material is via a coating process.

In an aspect, the present disclosure provides a method of making an electrochemical cell, comprising: providing a positive electrode current collector on a substrate; casting a seal material on the current collector; wherein the current collector is part of an electrochemical stack, wherein the electrochemical stack comprises: a solid-state electrolyte; a positive electrode comprising a liquid electrolyte or a gel electrolyte; wherein the seal material is impermeable to the liquid electrolyte or the gel electrolyte that bonds to the positive electrode current collector and to the solid-state electrolyte; enclosing the cell stack within a pressure ring; and applying at least 3 pounds per square inch (PSI) to the electrochemical cell. In some embodiments, the application of the seal material is after assembly of the electrochemical stack. In some embodiments, the application of the seal material is via a spray. In some embodiments, the application of the seal material is via a coating process. In some examples, the electrochemical stack further comprises a positive electrode current collector. In some examples, the electrochemical stack further comprises a negative electrode current collector. In some examples, the electrochemical stack further comprises a negative electrode. In some examples, the electrochemical stack further comprises a lithium-metal negative electrode.

In some embodiments, the application of the seal material is via injection into a mold. In some embodiments, the application of the seal material via injection into a mold is done at a pressure lower than atmospheric pressure. In some embodiments, the seal material is in contact with the solid-state electrolyte. In some embodiments, the seal material is selected from the group consisting of polyisobutylene (PIB), polyether ether ketone (PEEK), polypropylene, a polyolefin, and combinations thereof. In some embodiments, the seal material is selected from the group consisting of polyisobutylene (PIB), polyether ether ketone (PEEK), and combinations thereof. In some embodiments, the pressure ring comprises polyether ether ketone (PEEK). In some embodiments, the method further comprises heating the substrate to at least 50° C.

In an aspect, the present disclosure provides a method of making an electrochemical cell, comprising: providing a positive electrode current collector on a substrate; applying a seal material on the positive electrode current collector: providing a pressure ring; providing an electrochemical stack on the seal material and within the pressure ring, wherein the electrochemical stack comprises: a solid-state electrolyte; a positive electrode comprising a liquid electrolyte or a gel electrolyte; wherein the seal material is impermeable to the liquid electrolyte or the gel electrolyte that bonds to the positive electrode current collector and to the solid-state electrolyte; and applying at least 3 pounds per square inch (PSI) to the electrochemical cell. In some embodiments, the pressure ring comprises polyether ether ketone (PEEK). In some examples, the electrochemical stack further comprises a positive electrode current collector. In some examples, the electrochemical stack further comprises a negative electrode current collector. In some examples, the electrochemical stack further comprises a negative electrode. In some examples, the electrochemical stack further comprises a lithium-metal negative electrode.

### BRIEF DESCRIPTIONS OF THE DRAWINGS

FIGS. 1A and 1B show cross-sections of an embodiment of an electrochemical cell disclosed herein.

FIG. 2 shows a cross-section of an embodiment of an electrochemical cell disclosed herein.

FIG. 3 shows a cross-section of an embodiment of an electrochemical cell disclosed herein.

FIGS. 4A and 4B show cross-sections of an embodiment of an electrochemical cell disclosed herein.

FIG. 5 shows a cross-section of an embodiment of an electrochemical cell disclosed herein.

FIG. 6 shows a cross-section of an embodiment of an electrochemical cell disclosed herein.

FIG. 7 shows an illustration of an embodiment of an electrochemical cell disclosed herein.

FIG. 8 shows an illustration of an embodiment of an electrochemical cell disclosed herein.

FIG. 9 is a plot comparing the change in area-specific resistance (ASR) for the electrochemical cells described in Example 2.

FIG. 10A and FIG. 10B shows a process for making an example electrochemical cell (FIG. 10A) and also an example electrochemical cell (FIG. 10B).

FIG. 11A and FIG. 11B shows a performance comparison plot (FIG. 11A) of area-specific resistance (ASR) as a function of charge-discharge cycle and also two cell configurations (FIG. 11B).

FIG. 12 shows a flow chart describing the process for making an example electrochemical cell.

### DETAILED DESCRIPTION

### I. General

The present disclosure sets forth solid-state lithium (Li) ion-conducting electrolytes and electrochemical cells including these electrolytes. The electrochemical cells include a seal impermeable to a liquid electrolyte that is bonded to the solid-state Li ion-conducting electrolyte in a manner that effectively isolates and protects a Li metal negative electrode from exposure to either, or both, a liquid electrolyte or a gel electrolyte used as a catholyte in the positive electrode. In some examples, the electrochemical cells include a series of electrochemical stacks. In certain examples, each electrochemical stack includes, or shares, any one of a positive electrode with a liquid electrolyte or gel electrolyte, a solid-state electrolyte, and a Li metal negative electrode. In some of these examples, the electrochemical stacks share a Li metal negative electrode by stacking the electrochemical stacks in a parallel manner. In some examples, each stack includes a seal impermeable to a liquid electrolyte that is bonded to the solid-state Li ion-conducting electrolyte in a manner that effectively isolates and protects a Li metal negative electrode from exposure to either, or both, a liquid electrolyte or a gel electrolyte.

Set forth herein are electrochemical cells that include positive electrodes having active materials (e.g., NMC) and a liquid electrolyte in the positive electrode. The electrochemical cells also have a solid-state electrolyte separator. A seal contains the liquid electrolyte in the positive electrode by sealing around the perimeter of the positive electrode. In some examples, the seal prevents the liquid electrolyte from migrating or creeping around the solid-state electrolyte separator and reacting with the negative electrode.

### II. Definitions

If a definition provided in any material incorporated by reference herein conflicts with a definition provided herein, the definition provided herein controls.

As used herein, the term “about,” when qualifying a number, e.g., about 15% w/w, refers to the number qualified and optionally the numbers included in a range about that qualified number that includes ±10% of the number. For example, about 15 w/w includes 15% w/w as well as 13.5% w/w, 14% w/w, 14.5% w/w, 15.5% w/w, 16% w/w, or 16.5% w/w. For example, “about 75° C.,” includes 75° C. as well 68° C., 69° C., 70° C., 71° C., 72° C., 73° C., 74° C., 75° C., 76° C., 77° C., 78° C., 79° C., 80° C., 81° C., 82° C., or 83° C.

As used herein, the phrase “at least one member selected from the group” and “selected from the group consisting of” includes a single member from the group, more than one member from the group, or a combination of members from the group. At least one member selected from the group consisting of A, B, and C includes, for example, A, only, B, only, or C, only, as well as A and B as well as A and C as well as B and C as well as A, B, and C or any combination of A, B, and C.

As used herein the phrase “active electrode material,” or “active material,” refers to a material that is suitable for use as a Li rechargeable battery and which undergoes a mostly reversible chemical reaction during the charging and discharging cycles. For examples, and “active cathode material,” includes a metal fluoride that converts to a metal and lithium fluoride during the discharge cycle of a Li rechargeable battery.

As used herein, the phrase “active anode material” refers to an anode material that is suitable for use in a Li rechargeable battery that includes an active cathode material as defined above. In some examples, the active material is Lithium metal. In some of the processes set forth herein, the sintering temperatures are high enough to melt the Lithium metal used as the active anode material.

As used herein, the phrase “thickness” refers to the distance, or median measured distance, between the top and bottom faces of a layer in an electrochemical cell.

As used herein, the phrase “solid-state catholyte,” or the term “catholyte” refers to an electrolyte that is intimately mixed with, or surrounded by, a cathode (i.e., positive electrode) active material (e.g., a metal fluoride optionally including lithium).

As used herein, the term “electrolyte,” refers to an ionically conductive and electrically insulating material and a material that allows ions, e.g., Li⁺, to migrate or conduct therethrough but which does not allow electrons to conduct therethrough. Electrolytes are useful for electrically insulating the positive and negative electrodes of a rechargeable battery while allowing for the conduction of ions, e.g., Li⁺, through the electrolyte. Electrolytes are useful for electrically isolating the cathode and anodes of a secondary battery while allowing ions, e.g., Li⁺, to transmit through the electrolyte. Solid electrolytes, in particular, rely on ion hopping through rigid structures. Solid electrolytes may be also referred to as fast ion conductors or super-ionic conductors. Solid electrolytes may be also used for electrically insulating the positive and negative electrodes of a cell while allowing for the conduction of ions, e.g., Li⁺, through the electrolyte. In this case, a solid electrolyte layer may be also referred to as a solid electrolyte separator or solid-state electrolyte separator.

As used herein, the term “catholyte” refers to a Li ion conductor that is intimately mixed with, or that surrounds and contacts, or that contacts the positive electrode active materials and provides an ionic pathway for Li⁺ to and from the active materials. Solid-state catholytes suitable with the embodiments described herein include, but are not limited to, catholytes having the acronyms name LPS, LXPS, LXPSO, where X is Si, Ge, Sn, As, Al, LATS, borohydrides such as LiBH₄—LiX where X is F, Cl, Br, and/or I that may be optionally doped with compounds such as LiNH₂, or also Li-stuffed garnets, or combinations thereof, and the like. Catholytes may also be liquid, gel, semi-liquid, semi-solid, polymer, and/or solid polymer ion conductors known in the art. In some examples, the catholyte includes a gel set forth herein. In some examples, the gel electrolyte includes any electrolyte set forth herein, including a nitrile, dinitrile, organic sulfur-including solvent, or combination thereof set forth herein.

As used herein, the phrase “solid-state separator” or “solid-state electrolyte” refers to a solid that conducts lithium ions with at least 10⁴ times higher conductivity than the electron conductivity, Li⁺ ion-conducting separators that are solids at room temperature and include at least 50 vol % ceramic material. Examples include lithium-stuffed garnet, LBHI(N), LPSX, LiPON, and LiI. LBHI(N) is a composition including Li—B—H, a halide (I, Br, Cl, and/or F) and optionally N. LPSX is a composition including Li—P—S, and a halide (I, Br, Cl, and/or F), and that may contain other dopants. LiPON is a composition including Li—P—O—N.

As used herein, the phrase “Li⁺ ion-conducting separator” refers to an electrolyte which conducts Li⁺ ions, is substantially insulating to electrons (e.g., the lithium ion conductivity is at least 10³ times, and often 10⁶ times, greater than the electron conductivity), and which acts as a physical barrier or spacer between the positive and negative electrodes in an electrochemical cell.

As used herein, the terms “cathode” and “anode” refer to the electrodes of a battery. The cathode and anode are often referred to in the relevant field as the positive electrode and negative electrode, respectively. During a charge cycle in a Li-secondary battery, Li ions leave the cathode and move through an electrolyte, to the anode. During a charge cycle, electrons leave the cathode and move through an external circuit to the anode. During a discharge cycle in a Li-secondary battery, Li ions migrate towards the cathode through an electrolyte and from the anode. During a discharge cycle, electrons leave the anode and move through an external circuit to the cathode.

As used herein, the phrase “positive electrode” refers to the electrode in a secondary battery towards which positive ions, e.g., Li⁺, conduct during discharge of the battery. As used herein, the phrase “negative electrode” refers to the electrode in a secondary battery from where positive ions, e.g., Li⁺, conduct during discharge of the battery. In a battery comprised of a Li-metal electrode and a conversion chemistry electrode (i.e., active material; e.g., NiFx), the electrode having the conversion chemistry materials is referred to as the positive electrode. In some common usages, cathode is used in place of positive electrode, and anode is used in place of negative electrode. When a Li-secondary battery is charged, Li ions conduct from the positive electrode (e.g., NiFX) towards the negative electrode (Li-metal). When a Li-secondary battery is discharged, Li ions conduct towards the positive electrode (e.g., NiFX; i.e., cathode) and from the negative electrode (e.g., Li-metal; i.e., anode).

As used herein, the phrase “negative electrode” refers to the electrode in a secondary battery from where positive ions, e.g., Li^{t}, flow or move during discharge of the battery. In a battery comprised of a Li-metal electrode and a conversion chemistry, intercalation chemistry, or combination conversion/intercalation chemistry-including electrode (i.e., cathode active material; e.g., NiFₓ, NCA, LiNiₓMn_{y}Co_{z}O₂ [NMC] or LiNiₓAl_{y}Co_{z}O₂[NCA], wherein x+y+z=1), the electrode having the conversion chemistry, intercalation chemistry, or combination conversion/intercalation chemistry material is referred to as the positive electrode. In some common usages, cathode is used in place of positive electrode, and anode is used in place of negative electrode. When a Li-secondary battery is charged, Li ions move from the positive electrode (e.g., NiF_{X}, NMC, NCA) towards the negative electrode (e.g., Li-metal). When a Li-secondary battery is discharged, Li ions move towards the positive electrode and from the negative electrode.

As used herein, the phrase “inorganic solid-state electrolyte” is used interchangeably with the phrase “solid separator” refers to a material which does not include carbon and which conducts atomic ions (e.g., Li^{t}) but does not conduct electrons. An inorganic solid-state electrolyte is a solid material suitable for electrically isolating the positive and negative electrodes of a lithium secondary battery while also providing a conduction pathway for lithium ions. Example inorganic solid-state electrolytes include oxide electrolytes and sulfide electrolytes, which are further defined below. Non-limiting example sulfide electrolytes are found, for example, in U.S. Pat. No. 9,172,114, which issued Oct. 27, 2015. Non-limiting example oxide electrolytes are found, for example, in US Patent Application Publication No. 2015-0200420 A1, which published Jul. 16, 2015. In some examples, the inorganic solid-state electrolyte also includes a polymer.

Examples solid state electrolytes are found, for example, in International PCT Patent Application Nos. PCT/US2014/059575 and PCT/US2014/059578, GARNET MATERIALS FOR LI SECONDARY BATTERIES AND METHODS OF MAKING AND USING GARNET MATERIALS, filed Oct. 7, 2014, which published as WO 2015/054320 and WO 2015/076944, respectively, both of which are incorporated by reference herein in their entirety for all purposes.

In some examples, the electrolytes herein may include, or be layered with, or be laminated to, or contact a sulfide electrolyte. As used here, the phrase “sulfide electrolyte,” includes, but is not limited to, electrolytes referred to herein as LSS, LTS, LXPS, or LXPSO, where X is Si, Ge, Sn, As, Al, LATS. In these acronyms (LSS, LTS, LXPS, or LXPSO), S refers to the element S, Si, or combinations thereof, and T refers to the element Sn. “Sulfide electrolyte” may also include LiₐP_{b}S_{c}X_{d}, LiₐB_{b}S_{c}X_{d}, LiₐSn_{b}S_{c}X_{d} or LiₐSi_{b}S_{c}X_{d} where X═F, Cl, Br, I, and 10%≤a≤50%, 10%≤b≤44%, 24%≤c≤70%, 0≤d≤18% and may further include oxygen in small amounts. For example, oxygen may be present as a dopant or in an amount less than 10 percent by weight. For example, oxygen may be present as a dopant or in an amount less than 5 percent by weight. Sulfide electrolytes include inorganic materials containing S which conduct ions (e.g., Li′) and which are suitable for electrically insulating the positive and negative electrodes of an electrochemical cell (e.g., secondary battery). Exemplary sulfide based electrolytes include, but are not limited to, those electrolytes set forth in International PCT Patent Application No. PCT/US14/38283, SOLID STATE CATHOLYTE OR ELECTROLYTE FOR BATTERY USING LiAMPBSc (M=SI, GE, AND/OR SN), filed May 15, 2014, and published as WO 2014/186634, on Nov. 20, 2014, which is incorporated by reference herein in its entirety; also, U.S. Pat. No. 8,697,292 to Kanno, et. al., the contents of which are incorporated by reference in their entirety.

As used herein, the phrase “sulfide electrolyte” refers to a solid-state electrolyte that comprises lithium and sulfur. Particular sulfide electrolytes include Li₂S—P₂S₅, Li₂S—P₂S₅—SiS₂, Li₂S—P₂S₅—GeS₂, Li₂S—P₂S₅—SnS₂, Li₂S—P₂S₅—SnS₂—SiS₂, Li₂S—GeS₂—Ga₂S₃, and the like. A sulfide electrolyte may be described as LiₐM_{b}M′_{c}M“_{ci}SₑO_{f}Xᵢ where X is F, Cl, Br, and/or I, M, M′, and M” are metal cations. Any sulfide electrolyte may further comprise oxygen, selenium or a halogen (F, Cl, Br, and/or I).

As used herein, the phrase “current collector” refers to a component or layer in a secondary battery through which electrons conduct, to or from an electrode in order to complete an external circuit, and which are in direct contact with the electrode to or from which the electrons conduct. In some examples, the current collector is a metal (e.g., Al, Cu, or Ni, steel, alloys thereof, or combinations thereof) layer, which is laminated to a positive or negative electrode. During charging and discharging, electrons conduct in the opposite direction to the flow of Li ions and pass through the current collector when entering or exiting an electrode.

As used herein, the phrase “directly contacts” refers to the juxtaposition of two materials such that the two materials contact each other sufficiently to conduct either an ion or electron current between, or through, the two materials. As used herein, direct contact refers to two materials in contact with each other and which do not have any materials positioned between the two materials which are in direct contact.

As used herein, the phrases “electrochemical cell” or “battery cell” shall, unless specified to the contrary, mean a single cell including a positive electrode and a negative electrode, which have ionic communication between the two using an electrolyte. In some embodiments, a battery or module includes multiple positive electrodes and/or multiple negative electrodes enclosed in one container, i.e., stacks of electrochemical cells. A symmetric cell unless specified to the contrary is a cell having two Li metal anodes separated by a solid-state electrolyte.

As used herein, the phrase “electrochemical stack,” refers to one or more units which each include at least a negative electrode (e.g., Li, LiC₆), a positive electrode (e.g., Li-nickel-manganese-oxide or FeF₃, optionally combined with a solid state electrolyte or a gel electrolyte and/or catholyte), and a solid electrolyte (e.g., lithium-stuffed garnet electrolyte set forth herein) between and in contact with the positive and negative electrodes. An electrochemical includes one or more units, which each include at least a negative electrode, a positive electrode, and a solid electrolyte between and in contact with the positive and negative electrodes. In some examples, between the solid electrolyte and the positive electrode, there is an additional layer comprising a gel electrolyte. An electrochemical stack may include one of these aforementioned units. An electrochemical stack may include several of these aforementioned units arranged in electrical communication (e.g., serial or parallel electrical connection). In some examples, when the electrochemical stack includes several units, the units are layered or laminated together in a column. In some examples, when the electrochemical stack includes several units, the units are layered or laminated together in an array. In some examples, when the electrochemical stack includes several units, the stacks are arranged such that one negative electrode is shared with two or more positive electrodes. Alternatively, in some examples, when the electrochemical stack includes several units, the stacks are arranged such that one positive electrode is shared with two or more negative electrodes. Unless specified otherwise, an electrochemical stack includes one positive electrode, one solid electrolyte, and one negative electrode, and optionally includes a gel electrolyte layer between the positive electrode and the solid electrolyte.

As used herein the phrase, “effectively isolates and protects a Li metal negative electrode from exposure to either, or both, a liquid electrolyte or a gel electrolyte,” refers to reducing the contact between a liquid and/or a gel electrolyte and lithium metal negative electrode below a threshold. The threshold may be defined as when the lateral electronic conductivity of a lithium metal negative electrode reduces to less than 80% of its initial value.

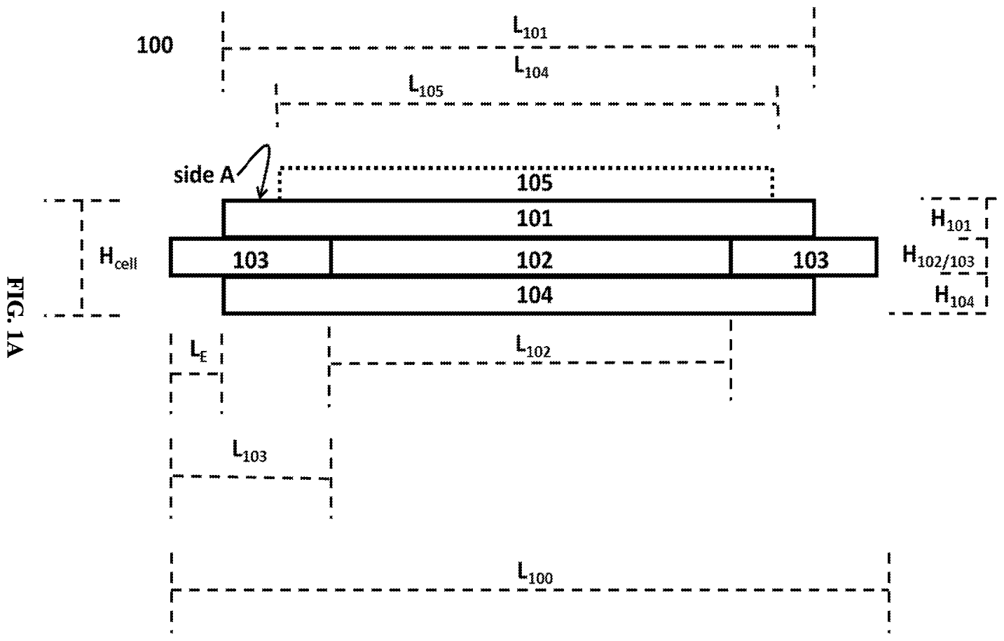

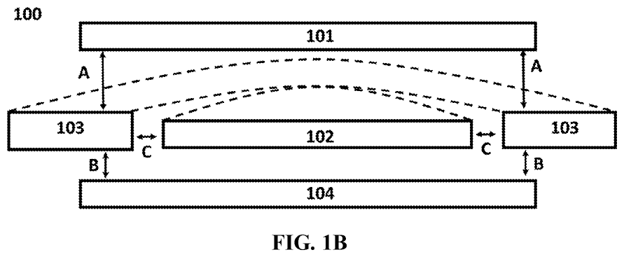

As used herein the phrase “face seal,” refers to a seal that at least bonds to the face of a current collector, e.g., positive electrode current collector. The face seal may also bond to the face of a solid-state electrolyte. Non-limiting examples of face seals are set forth herein in FIGS. 1A, 1B, 2, and 3.

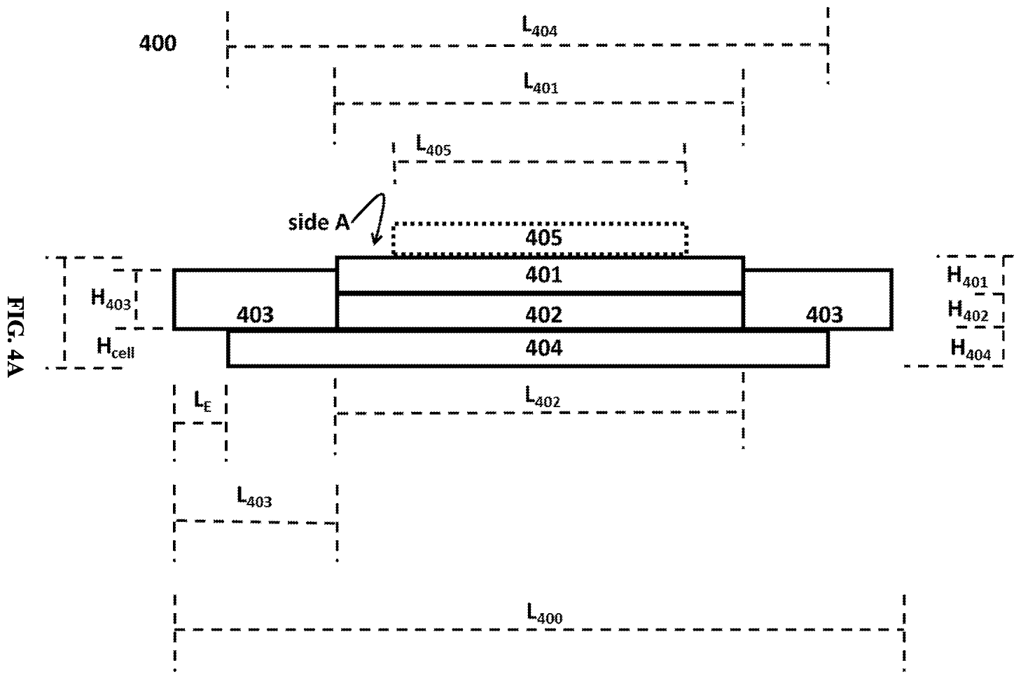

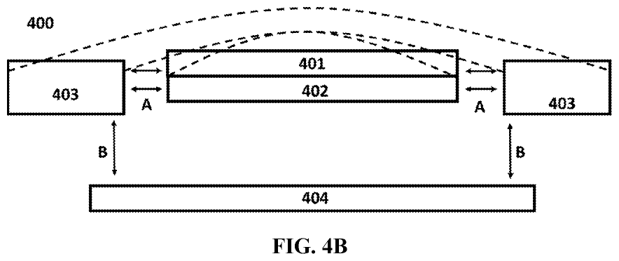

As used herein the phrase “perimeter seal,” refers to a seal that at least bonds to the side-edge of the solid-state electrolyte in an electrochemical cell. The perimeter seal may also bond to the side-edge of the positive electrode or to a catholyte reservoir in the positive electrode. The perimeter seal may also bond to the face of the positive electrode current collector. Non-limiting example perimeter seals are set forth herein in FIGS. 4A, 4B, 5, and 6.

As used herein, the phrase, “face of the positive electrode current collector,” refers to a surface of highest surface area of a flat plate, foil, conductive tab, or other similar current collector, which is facing and in contact with the positive electrode.

As used herein, the phrase, “face of the solid-state electrolyte,” refers to a surface of highest surface area of solid-state electrolyte. In the electrochemical coin-cell and pouch-cell devices set forth herein, one face of the solid-state electrolyte faces and contacts the positive electrode. Another face of the solid-state electrolyte contacts the negative electrode.

As used herein, the phrase “lithium-stuffed garnet” refers to oxides that are characterized by a crystal structure related to a garnet crystal structure. Lithium-stuffed garnets include compounds having the formula Li_{A}La_{B}M′_{c}M″_{D}Zr_{E}O_{F}, or Li_{A}La_{B}M′_{C}M“-_{D}Nb_{E}O_{F}, wherein 4<A<8.5, 1.5<B<4, 0≤C≤2, 0≤D≤2; 0≤E≤2.5, 10≤F≤13, and M′ and M” are each, independently in each instance selected from Al, Mo, W, Nb, Ga, Sb, Ca, Ba, Sr, Ce, Hf, Rb, and Ta; or LiₐLa_{b}Zr_{c}Al_{d}Me″ₑO_{f}, wherein 5<a<7.7; 2<b<4; 0<c≤2.5; 0≤d<2; 0≤e<2, 10<f<13 and Me″ is a metal selected from Nb, V, W, Mo, Ta, Ga, and Sb. Garnets, as used herein, also include those garnets described above that are doped with Al or Al₂O₃. Also, garnets as used herein include, but are not limited to, LiₓLa₃Zr₂O₁₂+yAl₂O₃. As used herein, garnet does not include YAG-garnets (i.e., yttrium aluminum garnets, or, e.g., Y₃Al₅O₁₂). As used herein, garnet does not include silicate-based garnets such as pyrope, almandine, spessartine, grossular, hessonite, or cinnamon-stone, tsavorite, uvarovite and andradite and the solid solutions pyrope-almandine-spessarite and uvarovite-grossular-andradite. Garnets herein do not include nesosilicates having the general formula X₃Y₂(SiO₄)₃ wherein X is Ca, Mg, Fe, and, or, Mn; and Y is Al, Fe, and, or, Cr.

As used herein, the phrase “lithium-stuffed garnet” refers to oxides that are characterized by a crystal structure related to a garnet crystal structure. U.S. Patent Application Publication No. U.S. 2015/0099190, which published Apr. 9, 2015 and was filed Oct. 7, 2014 as Ser. No. 14/509,029, is incorporated by reference herein in its entirety. This application describes Li-stuffed garnet solid-state electrolytes used in solid-state lithium rechargeable batteries. These Li-stuffed garnets generally having a composition according to Li_{A}La_{B}M′_{C}M″_{D}Zr_{E}O_{F}, Li_{A}La_{B}M′_{C}M“_{D}Ta_{E}O_{F}, or Li_{A}La_{B}M′_{C}M″_{D}Nb_{E}O_{F}, wherein 4<A<8.5, 1.5<B<4, 0≤C≤2, 0≤D≤2; 0≤E<2.5, 10<F<13, and M′ and M″ are each, independently in each instance selected from Ga, Al, Mo, W, Nb, Sb, Ca, Ba, Sr, Ce, Hf, Rb, and Ta, or LiₐLa_{b}Zr_{c}Al_{d}Me″ₑO_{f}, wherein 5<a<8.5; 2<b<4; 0<c≤2.5; 0≤d<2; 0≤e<2, and 10<f<13 and Me” is a metal selected from Ga, Nb, Ta, V, W, Mo, and Sb and as otherwise described in U.S. Patent Application Publication No. U.S. 2015/0099190. As used herein, lithium-stuffed garnets, and garnets, generally, include, but are not limited to, Li_{7.0}La₃(Zrₜ₁+Nbₜ₂+Taₜ₃)O₁₂+0.35Al₂O₃; wherein (t1+t2+t3=2) so that the La:(Zr/Nb/Ta) ratio is 3:2. Also, garnets used herein include, but are not limited to, LiₓLa₃Zr₂O_{F}+yAl₂O₃, wherein x ranges from 5.5 to 9; and y ranges from 0.05 to 1. In these examples, subscripts x, y, and F are selected so that the garnet is charge neutral. In some examples x is 7 and y is 1.0. In some examples, x is 5 and y is 1.0. In some examples, xis 6 and y is 1.0. In some examples, x is 8 and y is 1.0. In some examples, x is 9 and y is 1.0. In some examples x is 7 and y is 0.35. In some examples, x is 5 and y is 0.35. In some examples, x is 6 and y is 0.35. In some examples, x is 8 and y is 0.35. In some examples, x is 9 and y is 0.35. In some examples x is 7 and y is 0.7. In some examples, x is 5 and y is 0.7. In some examples, x is 6 and y is 0.7. In some examples, x is 8 and y is 0.7. In some examples, x is 9 and y is 0.7. In some examples x is 7 and y is 0.75. In some examples, x is 5 and y is 0.75. In some examples, x is 6 and y is 0.75. In some examples, x is 8 and y is 0.75. In some examples, x is 9 and y is 0.75. In some examples x is 7 and y is 0.8. In some examples, x is 5 and y is 0.8. In some examples, x is 6 and y is 0.8. In some examples, x is 8 and y is 0.8. In some examples, x is 9 and y is 0.8. In some examples x is 7 and y is 0.5. In some examples, x is 5 and y is 0.5. In some examples, x is 6 and y is 0.5. In some examples, x is 8 and y is 0.5. In some examples, x is 9 and y is 0.5. In some examples x is 7 and y is 0.4. In some examples, x is 5 and y is 0.4. In some examples, x is 6 and y is 0.4. In some examples, x is 8 and y is 0.4. In some examples, x is 9 and y is 0.4. In some examples x is 7 and y is 0.3. In some examples, x is 5 and y is 0.3. In some examples, x is 6 and y is 0.3. In some examples, x is 8 and y is 0.3. In some examples, x is 9 and y is 0.3. In some examples x is 7 and y is 0.22. In some examples, x is 5 and y is 0.22. In some examples, x is 6 and y is 0.22. In some examples, x is 8 and y is 0.22. In some examples, x is 9 and y is 0.22. Also, garnets as used herein include, but are not limited to, LiₓLa₃Zr₂O₁₂+yAl₂O₃. In one embodiment, the Li-stuffed garnet herein has a composition of Li₇Li₃Zr₂O₁₂. In another embodiment, the Li-stuffed garnet herein has a composition of Li₇Li₃Zr₂O₁₂.Al₂O₃. In yet another embodiment, the Li-stuffed garnet herein has a composition of Li₇Li₃Zr₂O₁₂.0.22Al₂O₃. In yet another embodiment, the Li-stuffed garnet herein has a composition of Li₇Li₃Zr₂O₁₂.0.35Al₂O₃. In certain other embodiments, the Li-stuffed garnet herein has a composition of Li₇Li₃Zr₂O₁₂.0.5Al₂O₃. In another embodiment, the Li-stuffed garnet herein has a composition of Li₇Li₃Zr₂O₁₂.0.75Al₂O₃.

As used herein the phrase, “side-edge of the solid-state electrolyte” refers to the edge of the solid state electrolyte that is approximately at a 90° angle from the face.

As used herein the term, “thermoplastic olefin,” refers to blends of a thermoplastic, an elastomer or a rubber, and optionally a filler. Thermoplastics include, but are not limited to, polypropylene, polyethylene, and block copolymers of polypropylene and/or polyethylene. Fillers include, but are not limited to, talc, fiberglass, carbon fiber, wollastonite, and ceramics. Elastomers include, but are not limited to, ethylene propylene rubber (EPR), EPDM (EP-diene rubber), ethylene-octene (EO), ethylbenzene (EB), and styrene ethylene butadiene styrene (SEBS).

As used herein, the phrase “liquid electrolyte”, unless specified otherwise, refers to a Li⁺ conducting liquid electrolyte suitable for use in a lithium ion or lithium metal electrochemical cell or battery. A liquid electrolyte comprises at least one solvent and at least one Li-salt and provides a lithium conductivity of at least 10⁻⁵ S/cm at room temperature. A liquid electrolyte will often comprise more than one solvent. A liquid electrolyte may further comprise additives to improve stability. A liquid electrolyte is a liquid at room temperature (−22° C.) and atmospheric pressure (i.e., 1 atm or 101,325 Pascals).

As used herein, the phrase “gel” refers to a material that has a storage modulus that exceeds the loss modulus as measured by rheometry. A gel may be a polymer swollen or infiltrated by a liquid, or a two-phase material with a porous polymer with pores occupied by liquid. A gel does not appreciably flow in response to gravity over short times (minutes). Examples include, but are not limited to, a PVDF-HFP with electrolyte solvent and salt, and PAN with electrolyte solvent and salt.

As used herein, the phrases “gel electrolyte” unless specified otherwise, refers to a suitable Li⁺ ion conducting gel-based electrolyte, for example, those set forth in U.S. Pat. No. 5,296,318, entitled RECHARGEABLE LITHIUM INTERCALATION BATTERY WITH HYBRID POLYMERIC ELECTROLYTE, the entire contents of which are herein incorporated by reference in its entirety for all purposes. A gel electrolyte has a lithium ion conductivity of greater than 10⁻⁵S/cm at room temperature, a lithium transference number between 0.05-0.95, and a storage modulus greater than the loss modulus at some temperature. A gel electrolyte may comprise a polymer matrix, a solvent that gels the polymer, and a lithium containing salt that is at least partly dissociated into Li⁺ ions and anions. Alternately, a gel electrolyte may comprise a porous polymer matrix, a solvent that fills the pores, and a lithium containing salt that is at least partly dissociated into Li⁺ ions and anions where the pores have one length scale less than 10 μm.

As used herein, the term, “impermeable,” refers to the inability for a liquid electrolyte, gel electrolyte, or component thereof to substantially penetrate through that which is impermeable for the cycle life of the electrochemical cell. Herein, cycle life refers to the number of cycles used a given application. For example, if a battery is rated for 10,000 cycles, then the term impermeable means that the liquid electrolyte, gel electrolyte, or component thereof will not substantially penetrate through that which is impermeable for at least 10,000 cycles. Unless specified otherwise, a battery herein is assumed to have a 10,000 cycle life rating. As used herein, the term “substantially penetrate” means penetrate to a degree that impacts performance or is detectible by an elemental analysis such as x-ray photoelectron spectroscopy (XPS), energy dispersive x-ray spectroscopy (EDS), and x-ray fluorescence (XRF) spectroscopy and the like. An impact on performance includes a capacity fade of more than 10% of the battery's rated capacity at a fixed C rate. If a product of a reaction between the liquid electrolyte or the gel electrolyte and a battery component other than the cathode is detected by XPS, EDS, or XRF, the seal around the cathode which should prevent such a reaction is said to be substantially penetrated by the liquid electrolyte or the gel electrolyte. XPS detection is the default method for making this determination absent an explicit recitation to perform EDS or XRF.

In some examples, as used herein, the term “impermeable” also means that the seal transmits less than 1 g of electrolyte through 1 cm² of the seal per year. In some embodiments, an impermeable seal may transmit less than 0.5 g of electrolyte through 1 cm² of the seal per year. In some embodiments, an impermeable seal may transmit less than 0.1 g of electrolyte through 1 cm² of the seal per year. In some embodiments, an impermeable seal may transmit less than 1 g of electrolyte through 1 cm² of the seal per month. In some embodiments, an impermeable seal may transmit less than 1 g of electrolyte through 1 cm² of the seal per day.

As used herein, “SLOPS” includes, unless otherwise specified, a 60:40 molar ratio of Li₂S:SiS₂ with 0.1-10 mol. % Li₃PO₄. In some examples, “SLOPS” includes Li₁₀Si₄Si₃ (50:50 Li₂S:SiS₂) with 0.1-10 mol. % Li₃PO₄. In some examples, “SLOPS” includes Li₂₆Si₇S₂₇ (65:35 Li₂S:SiS₂) with 0.1-10 mol. % Li₃PO₄. In some examples, “SLOPS” includes Li₄SiS₄ (67:33 Li₂S:SiS₂) with 0.1-5 mol. % Li₃PO₄. In some examples, “SLOPS” includes Li₁₄Si₃S₁₃ (70:30 Li₂S:SiS₂) with 0.1-5 mol. % Li₃PO₄. In some examples, “SLOPS” is characterized by the formula (1-x)(60:40 Li₂S:SiS₂)*(x)(Li₃PO₄), wherein x is from 0.01 to 0.99. As used herein, “LBS-POX” refers to an electrolyte composition of Li₂S:B₂S₃:Li₃PO₄:LiX where X is a halogen (X═F, Cl, Br, I). The composition can include Li₃BS₃ or Li₅B₇S₁₃ doped with 0-30% lithium halide such as LiI and/or 0-10% Li₃PO₄.

As used here, “LBS” refers to an electrolyte material characterized by the formula LiₐB_{b}S_{c} and may include oxygen and/or a lithium halide (LiF, LiCl, LiBr, LiI) at 0-40 mol %.

As used here, “LPSO” refers to an electrolyte material characterized by the formula LiₓP_{y}S_{z}O_{w} where 0.33≤x≤0.67, 0.07≤y≤0.2, 0.4≤z≤0.55, 0≤w≤0.15. Also, LPSO refers to LPS, as defined above, that includes an oxygen content of from 0.01 to 10 atomic %. In some examples, the oxygen content is 1 atomic %. In other examples, the oxygen content is 2 atomic %. In some other examples, the oxygen content is 3 atomic %. In some examples, the oxygen content is 4 atomic %. In other examples, the oxygen content is 5 atomic %. In some other examples, the oxygen content is 6 atomic %. In some examples, the oxygen content is 7 atomic %. In other examples, the oxygen content is 8 atomic %. In some other examples, the oxygen content is 9 atomic %. In some examples, the oxygen content is 10 atomic %.

As used herein, the term “LBHI” or “LiBHI” refers to a lithium conducting electrolyte comprising Li, B, H, and I. More generally, it is understood to include aLiBH₄+bLiX where X═Cl, Br, and/or I and where a:b=7:1, 6:1, 5:1, 4:1, 3:1, 2:1, or within the range a/b=2-4. LBHI may further include nitrogen in the form of aLiBH₄+bLiX+cLiNH₂ where (a+c)/b=2-4 and c/a=0-10.

As used herein, the term “LPSI” refers to a lithium conducting electrolyte comprising Li, P, S, and I. More generally, it is understood to include aLi₂S+bP₂S_{y}+cLiX where X═Cl, Br, and/or I and where y=3-5 and where a/b=2.5-4.5 and where (a+b)/c=0.5-15.

As used herein, the term “LIRAP” refers to a lithium rich antiperovskite and is used synonymously with “LOC” or “Li₃OCl”. The composition of LIRAP is aLi₂O+bLiX+cLiOH+dAl₂O₃ where X═Cl, Br, and/or I, a/b=0.7-9, c/a=0.01-1, d/a=0.001-0.1.

As used herein, “LSS” refers to lithium silicon sulfide which can be described as Li₂S—SiS₂, Li—SiS₂, Li—S—Si, and/or a catholyte consisting essentially of Li, S, and Si. LSS refers to an electrolyte material characterized by the formula LiₓSi_{y}S_{z} where 0.33≤x≤0.5, 0.1≤y≤0.2, 0.4≤z≤0.55, and it may include up to 10 atomic % oxygen. LSS also refers to an electrolyte material comprising Li, Si, and S. In some examples, LSS is a mixture of Li₂S and SiS₂. In some examples, the molar ratio of Li₂S:SiS₂ is 90:10, 85:15, 80:20, 75:25, 70:30, 2:1, 65:35, 60:40, 55:45, or 50:50. LSS may be doped with compounds such as LiₓPO_{y}, LiₓBO_{y}, Li₄SiO₄, Li₃MO₄, Li₃MO₃, PSₓ, and/or lithium halides such as, but not limited to, LiI, LiCl, LiF, or LiBr, wherein 0<x≤5 and 0<y≤5.

As used herein, “LTS” refers to a lithium tin sulfide compound which can be described as Li₂S—SnS₂, Li₂S—SnS, Li—S—Sn, and/or a catholyte consisting essentially of Li, S, and Sn. The composition may be LiₓSn_{y}S_{z} where 0.25≤x≤0.65, 0.05≤y≤0.2, and 0.25≤z≤0.65. In some examples, LTS is a mixture of Li₂S and SnS₂ in the molar ratio of 80:20, 75:25, 70:30, 2:1, or 1:1. LTS may include up to 10 atomic % oxygen. LTS may be doped with Bi, Sb, As, P, B, Al, Ge, Ga, and/or In. As used herein, “LATS” refers to LTS, as used above, and further comprising Arsenic (As).

As used herein, “LXPS” refers to a material characterized by the formula LiₐMP_{b}S_{c}, where M is Si, Ge, Sn, and/or Al, and where 2≤a≤8, 0.5≤b≤2.5, 4≤c≤12. “LSPS” refers to an electrolyte material characterized by the formula LₐSiP_{b}S_{c}, where 2≤a≤8, 0.5≤b≤2.5, 4≤c≤12. LSPS refers to an electrolyte material characterized by the formula LₐSiP_{b}S_{c}, wherein, where 2≤a≤8, 0.5≤b≤2.5, 4≤c≤12. Exemplary LXPS materials are found, for example, in International Patent Application No. PCT/US14/38283, SOLID STATE CATHOLYTE OR ELECTROLYTE FOR BATTERY USING LiAMPBSc (M=SI, GE, AND/OR SN), filed May 15, 2014, and published as WO 2014/186634, on Nov. 20, 2014, which is incorporated by reference herein in its entirety. Exemplary LXPS materials are found, for example, in U.S. patent application Ser. No. 14/618,979, filed Feb. 10, 2015, and published as Patent Application Publication No. 2015/0171465, on Jun. 18, 2015, which is incorporated by reference herein in its entirety. When M is Sn and Si—both are present—the LXPS material is referred to as LSTPS. As used herein, “LSTPSO” refers to LSTPS that is doped with, or has, O present. In some examples, “LSTPSO” is a LSTPS material with an oxygen content between 0.01 and 10 atomic %. “LSPS” refers to an electrolyte material having Li, Si, P, and S chemical constituents. As used herein “LSTPS” refers to an electrolyte material having Li, Si, P, Sn, and S chemical constituents. As used herein, “LSPSO” refers to LSPS that is doped with, or has, O present. In some examples, “LSPSO” is a LSPS material with an oxygen content between 0.01 and 10 atomic %. As used herein, “LATP,” refers to an electrolyte material having Li, As, Sn, and P chemical constituents. As used herein “LAGP” refers to an electrolyte material having Li, As, Ge, and P chemical constituents. As used herein, “LXPSO” refers to a catholyte material characterized by the formula LiₐMP_{b}S_{c}O_{d}, where M is Si, Ge, Sn, and/or Al, and where 2≤a≤8, 0.5≤b≤2.5, 4≤c≤12, d<3. LXPSO refers to LXPS, as defined above, and having oxygen doping at from 0.1 to about 10 atomic %. LPSO refers to LPS, as defined above, and having oxygen doping at from 0.1 to about 10 atomic %.

As used herein, “LPS” refers to an electrolyte having Li, P, and S chemical constituents. As used herein, “LPSO” refers to LPS that is doped with or has 0 present. In some examples, “LPSO” is a LPS material with an oxygen content between 0.01 and 10 atomic %. LPS refers to an electrolyte material that can be characterized by the formula LiₓP_{y}S_{z} where 0.33≤x≤0.67, 0.07≤y≤0.2 and 0.4≤z≤0.55. LPS also refers to an electrolyte characterized by a product formed from a mixture of Li₂S:P₂S₅ wherein the molar ratio is 10:1, 9:1, 8:1, 7:1, 6:1 5:1, 4:1, 3:1, 7:3, 2:1, or 1:1. LPS also refers to an electrolyte characterized by a product formed from a mixture of Li₂S:P₂S₅ wherein the reactant or precursor amount of Li₂S is 95 atomic % and P₂S₅ is 5 atomic %. LPS also refers to an electrolyte characterized by a product formed from a mixture of Li₂S:P₂S₅ wherein the reactant or precursor amount of Li₂S is 90 atomic % and P₂S₅ is 10 atomic %. LPS also refers to an electrolyte characterized by a product formed from a mixture of Li₂S:P₂S₅ wherein the reactant or precursor amount of Li₂S is 85 atomic % and P₂S₅ is 15 atomic %. LPS also refers to an electrolyte characterized by a product formed from a mixture of Li₂S:P₂S₅ wherein the reactant or precursor amount of Li₂S is 80 atomic % and P₂S₅ is 20 atomic %. LPS also refers to an electrolyte characterized by a product formed from a mixture of Li₂S:P₂S₅ wherein the reactant or precursor amount of Li₂S is 75 atomic % and P₂S₅ is 25 atomic %. LPS also refers to an electrolyte characterized by a product formed from a mixture of Li₂S:P₂S₅ wherein the reactant or precursor amount of Li₂S is 70 atomic % and P₂S₅ is 30 atomic %. LPS also refers to an electrolyte characterized by a product formed from a mixture of Li₂S:P₂S₅ wherein the reactant or precursor amount of Li₂S is 65 atomic % and P₂S₅ is 35 atomic %. LPS also refers to an electrolyte characterized by a product formed from a mixture of Li₂S:P₂S₅ wherein the reactant or precursor amount of Li₂S is 60 atomic % and P₂S₅ is 40 atomic %.

As used herein, the term “rational number” refers to any number which can be expressed as the quotient or fraction (e.g., p/q) of two integers (e.g., p and q), with the denominator (e.g., q) not equal to zero. Example rational numbers include, but are not limited to, 1, 1.1, 1.52, 2, 2.5, 3, 3.12, and 7.

As used herein the term “making” refers to the process or method of forming or causing to form the object that is made. For example, making an energy storage electrode includes the process, process operations, process steps, or method of causing the electrode of an energy storage device to be formed. The end result of the operations constituting the making of the energy storage electrode is the production of a material that is functional as an electrode.

As used herein, the phrase “providing” refers to the provision of, generation or, presentation of, or delivery of that which is provided.

As used herein, the phrase “garnet-type electrolyte” refers to an electrolyte that includes a garnet or lithium-stuffed garnet material described herein as the ionic conductor.

As used herein, the phrase “subscripts and molar coefficients in the empirical formulas are based on the quantities of raw materials initially batched to make the described examples” means the subscripts, (e.g., 7, 3, 2, 12 in Li₇La₃Zr₂O₁₂ and the coefficient 0.35 in 0.35Al₂O₃) refer to the respective elemental ratios in the chemical precursors (e.g., LiOH, La₂O₃, ZrO₂, Al₂O₃) used to prepare a given material, (e.g., Li₇La₃Zr₂O₁₂.0.35Al₂O₃). As used here, the phrase “characterized by the formula” refers to a molar ratio of constituent atoms either as batched during the process for making that characterized material or as empirically determined. Subscripts herein refer to the molar ratios as batches unless specified otherwise to the contrary.

As used herein, the term “solvent” refers to a liquid that is suitable for dissolving or solvating a component or material described herein. For example, a solvent includes a liquid, e.g., nitrile or dinitrile solvent, which is suitable for dissolving a component, e.g., the salt, used in the electrolyte.

As used herein, the phrase “nitrile” or “nitrile solvent” refers to a hydrocarbon substituted by a cyano group, or a solvent which includes a cyano (i.e., —C≡N) substituent bonded to the solvent. Nitrile solvents may include dinitrile solvents.

Some exemplary nitrile and dinitrile solvents include, but are not limited to, adiponitrile (hexanedinitrile), acetonitrile, benzonitrile, butanedinitrile (succinonitrile), butyronitrile, decanenitrile, ethoxyacetonitrile, fluoroacetonitrile, glutaronitrile, hexanenitrile, heptanenitrile, heptanedinitrile, iso-butyronitrile, malononitrile (propanedinitrile or rnalonodinitnie), methoxyacetonitrile, nitroacetonitrile, nonanenitrile, nonanedinitrile, octanedinitrile (suberodinitrile), octanenitrile, propanenitrile, pentanenitrile, pentanedinitrile, sebaconitrile (decanedinitrile), succinonitrile, and combinations thereof.

As used herein, the phrase “organic sulfur-including solvent” refers to a solvent selected from ethyl methyl sulfone, dimethyl sulfone, sulfolane, allyl methyl sulfone, butadiene sulfone, butyl sulfone, methyl methanesulfonate, and dimethyl sulfite.

As used herein, the term “LiBOB” refers to lithium bis(oxalato)borate.

As used herein, the term “LiBETI” refers to lithium bis(perfluoroethanesulfonyl)imide.

As used herein, the term “LiFSi” refers to lithium bis(fluorosulfonyl)imide.

As used herein, the term “LiTFSi” refer to lithium bis-trifluoromethanesulfonimide.

As used herein, voltage is set forth with respect to lithium (i.e., V vs. Li) metal unless stated otherwise.

As used herein, the term “LiBHI” refers to a combination of LiBH₄ and LiX, wherein X is Br, Cl, I, or a combination thereof.

As used herein, the term “LiBNHI” refers to a combination of LiBH₄, LiNH₂, and LiX, wherein X is Br, Cl, I, or combinations thereof.

As used herein, the term “LiBHCl” refers to a combination of LiBH₄ and LiCl.

As used herein, the term “LiBNHCl” refers to a combination of LiBH₄, LiNH₂, and LiCl.

As used herein, the term “LiBHBr” refers to a combination of LiBH₄ and LiBr.

As used herein, the term “LiBNHBr” refers to a combination of LiBH₄, LiNH₂, and LiBr.

As used herein, the term “PAN” refers to poly(acrylonitrile).

As used herein, the term “LiPON” refers to solid state electrolyte comprising lithium, phosphorus, oxygen and nitrogen and is referred to in the art as lithium phosphorus oxy-nitride. LiPON can be characterized by the formula LiₓPO_{y}N_{z} in which x=2y+3z−5.

As used herein, the term “LiSON” refers to refers to solid state electrolyte comprising lithium, sulfur, oxygen and nitrogen and is referred to in the art as lithium sulfur oxy-nitride. LiSON can be characterized by the formula LiₓSO_{y}N_{z} in which x=2y+3z−2.

As used herein, the term “lithium salt” refers to a lithium-containing compound that is a solid at room temperature that at least partially dissociates when immersed in a solvent such as EMC. Lithium salts may include but are not limited to LiPF₆, LiBOB, LiTFSi, LiFSI, LiAsF₆, LiClO₄, LiI, LiBETI, and LiBF₄.

As used herein, the term “carbonate solvent” refers to a class of solvents containing a carbonate group C(═O)(O—)₂. Carbonate solvents include but are not limited to ethylene carbonate, dimethyl carbonate, propylene carbonate, diethyl carbonate, ethyl methyl carbonate, dimethyl ethylene carbonate, isobutylene carbonate, nitroethyl carbonate, monofluoroethylene carbonate, fluoromethyl ethylene carbonate, 1,2-butylene carbonate, methyl propyl carbonate, and isopropyl methyl carbonate.

As used herein, area-specific resistance (ASR) is measured by electrochemical cycling (e. g., electrical impedance spectroscopy) using Arbin or Biologic instruments unless otherwise specified to the contrary.

As used herein, ionic conductivity is measured by electrical impedance spectroscopy methods known in the art.

### III. Electrolytes

a. Solid-State Electrolytes

A variety of solid-state electrolytes can be used with the electrochemical cells and devices disclosed herein.

Certain solid-state electrolytes compatible with Li metal negative electrodes are known, e.g., International PCT Patent Application No. PCT/US2014/059578, entitled GARNET MATERIALS FOR LI SECONDARY BATTERIES, filed Oct. 7, 2014, or in International PCT Patent Application No. PCT/US2014/059575, entitled GARNET MATERIALS FOR LI SECONDARY BATTERIES, also filed Oct. 7, 2014, the contents of each of which are herein incorporated by reference in their entirety for all purposes.

Other solid-state electrolytes include, but are not limited to those electrolytes in International Patent Application Publication No. PCT/US2014/038283, filed May 16, 2014, and titled SOLID STATE CATHOLYTE OR ELECTROLYTE FOR BATTERY USING LIAMPBSc (M=Si, Ge, AND/OR Sn), which is incorporated by reference herein in its entirety

b. Gel Electrolytes

Certain gel electrolytes compatible with solid-state electrolytes and positive electrodes are known, e.g., WO/2017/197406 entitled “SOLID ELECTROLYTE SEPARATOR BONDING AGENT” (PCT/US2017/032749 filed May 15, 2017), and US-2017-0331092-A1 entitled “SOLID ELECTROLYTE SEPARATOR BONDING AGENT” (U.S. application Ser. No. 15/595,755 filed May 15, 2017), the entire contents of both of which are herein incorporated by reference in its entirety for all purposes.

c. Liquid Electrolytes

Liquid electrolytes include, but are not limited to those liquid electrolytes set forth in “Conductivity of electrolytes for rechargeable lithium batteries” Journal Power Sources 35 (1991) 59-82 by J. T. Dudley et. al.; “Nonaqueous liquid electrolytes for lithium-based rechargeable batteries” Chem. Rev. 104 (2004) 4303-4417 by K. Xu; and “Electrolytes and interphases in Li-ion batteries and beyond” Chem. Rev. 114 (2014) 11503-11618 by K. Xu. The entire contents of each of these publications is incorporated by reference in their entirety for all purposes.

### IV. Electrochemical Stacks

In some examples, set forth herein is an electrochemical stack, including a solid-state electrolyte; a positive electrode including a liquid electrolyte or a gel electrolyte; a positive electrode current collector; and a seal impermeable to the liquid electrolyte or the gel electrolyte that bonds to the positive electrode current collector and to the solid-state electrolyte.

In some examples, set forth herein is an electrochemical stack, including a solid-state electrolyte; a positive electrode including a liquid electrolyte; a positive electrode current collector; and a seal impermeable to the liquid electrolyte that bonds to the positive electrode current collector and to the solid-state electrolyte. In some examples, a seal may be impermeable, wherein the permeation rate is lower than about 1×10⁻⁵ mol/(cm·hr·Pa), 1×10⁻¹⁰ mol/(cm·hr·Pa), 1×10⁻¹¹ mol/(cm·hr·Pa), 1×10⁻¹² mol/(cm·hr·Pa), 1×10⁻¹³ mol/(cm·hr·Pa), 1×10⁻¹⁴ mol/(cm·hr·Pa), 1×10⁻¹⁵ mol/(cm·hr·Pa), or lower.

In some examples, set forth herein is an electrochemical stack, including a solid-state electrolyte; a positive electrode including a gel electrolyte; a positive electrode current collector; and a seal impermeable to the gel electrolyte that bonds to the positive electrode current collector and to the solid-state electrolyte.

In some examples, the seal contains the liquid electrolyte or the gel electrolyte in the positive electrode.

In some examples, the seal contains the liquid electrolyte in the positive electrode.

In some examples, the seal contains the gel electrolyte in the positive electrode.

In some examples, the solid-state electrolyte is impermeable to the liquid electrolyte or the gel electrolyte.

In some examples, the solid-state electrolyte is impermeable to the liquid electrolyte.

In some examples, the solid-state electrolyte is impermeable to the gel electrolyte.

In some examples, the seal bonds to a face of the positive electrode current collector.

In some examples, the seal bonds to a face of the solid-state electrolyte.

In some examples, the seal bonds to a side-edge of the solid-state electrolyte.

In some examples, the seal bonds to a face of the solid-state electrolyte and a side-edge of the solid-state electrolyte.

In some examples, including any of the foregoing, the electrochemical stack may further include a lithium (Li) metal negative electrode.

In some examples, including any of the foregoing, the electrochemical stack may further include a negative electrode current collector.

In some examples, including any of the foregoing, the electrochemical stack is in a container and the seal is not bonded to the container.

In some examples, including any of the foregoing, the electrochemical stack the container includes conductive tab leads.

In some examples, including any of the foregoing, the diameter of the solid-state electrolyte is greater than the diameter of the lithium metal negative electrode.

In some examples, including any of the foregoing, the diameter of the solid-state electrolyte is greater than the diameter of the positive electrode.

In some examples, including any of the foregoing, the width or diameter of the solid-state electrolyte is greater than either of the diameter of the lithium metal negative electrode or of the positive electrode.

In some examples, including any of the foregoing, the diameter of the solid-state electrolyte is greater than either of the diameter of the lithium metal negative electrode or of the positive electrode. In some examples, including any of the foregoing, the width of the solid-state electrolyte is greater than either of the diameter of the lithium metal negative electrode or of the positive electrode.

In some examples, including any of the foregoing, the width or diameter of the solid-state electrolyte is greater than the width or diameter of the lithium metal negative electrode.

In some examples, including any of the foregoing, the diameter of the solid-state electrolyte is greater than the width or diameter of the lithium metal negative electrode.

In some examples, including any of the foregoing, the diameter of the solid-state electrolyte is greater than the width or diameter of the lithium metal negative electrode.

In some examples, including any of the foregoing, the width or diameter of the solid-state electrolyte is greater than the width or diameter of the positive electrode.

In some examples, including any of the foregoing, the width of the solid-state electrolyte is greater than the width or diameter of the positive electrode.

In some examples, including any of the foregoing, the diameter of the solid-state electrolyte is greater than the width or diameter of the positive electrode.

In some examples, including any of the foregoing, the solid-state electrolyte has raised edges.

In some examples, including any of the foregoing, the solid-state electrolyte has coated edges. In some of these examples, the coated edges include a coating selected from parylene, polypropylene (PP), polyethylene, alumina, Al₂O₃, ZrO₂, TiO₂, SiO₂, a binary oxide, La₂Zr₂O₇, a lithium carbonate species, or a glass, wherein the glass is selected from SiO₂—B₂O₃, or Al₂O₃. In some examples, including any of the foregoing, the solid-state electrolyte has edges with a different composition than bulk, where the composition differs by at least 10% in any element. For example, if the bulk of the electrolyte consists of Li₃PS₄, the edge may be Li₃PS₄F_{0.1}, or the edge may be Li_{2.7}PS₄.

In some examples, including any of the foregoing, the solid-state electrolyte has tapered edges.

Also included is an electrochemical cell including at least one or more electrochemical stacks set forth herein.

### V. Electrochemical Cells

In some examples, set forth herein is an electrochemical cell, which includes a (1) container, (2) at least one electrochemical stack in the container, in which the electrochemical stack includes at least: (a) a solid-state electrolyte; (b) a positive electrode including a liquid electrolyte or a gel electrolyte; and (c) a positive electrode current collector; and (3) a seal impermeable to the liquid electrolyte or the gel electrolyte that bonds to the positive electrode current collector and to the solid-state electrolyte. The seal is not bonded to the container. The seal contains the liquid electrolyte or the gel electrolyte in the positive electrode.

In some examples, including any of the foregoing, the electrochemical cell includes a lithium (Li) metal negative electrode.

In some examples, including any of the foregoing, the electrochemical cell includes a negative electrode current collector.

In some examples, including any of the foregoing, the electrochemical cell includes a negative electrode current collector and Li metal between and in contact with the solid-state electrolyte and the negative electrode current collector.

In some examples, including any of the foregoing, the solid-state electrolyte is impermeable to the liquid electrolyte or the gel electrolyte.

In some examples, including any of the foregoing, the seal bonds to a face of the positive electrode current collector.

In some examples, including any of the foregoing, the seal bonds to a face of the solid-state electrolyte.

In some examples, including any of the foregoing, the seal bonds to a side-edge of the solid-state electrolyte.

In some examples, including any of the foregoing, the seal bonds to a face of the solid-state electrolyte and a side-edge of the solid-state electrolyte.

In some examples, including any of the foregoing, the seal is made of a single material. In other embodiments, the seal includes more than a single type of material.

In some examples, including any of the foregoing, the seal is made of polypropylene.

In some examples, including any of the foregoing, the seal is made of a multilayer.

In some examples, including any of the foregoing, the seal includes a top layer, a bottom layer, and a middle layer. In some of these examples, the top layer is thinner than the middle layer. In some of these examples, the bottom layer is thinner than the middle layer. In some of these examples, both the top layer and the bottom layer are each, individually, thinner than the middle layer.

In some examples, including any of the foregoing, the seal or seal material includes a material selected from the group consisting of polyisobutylene (PIB), polyether ether ketone (PEEK), polypropylene (PP), a polyolefin, and combinations thereof.

In some embodiments, the seal or seal material is selected from a member of one of the following polymer classes. These polymer classes are suitable for sealing applications in the presence of a liquid (e.g., polar) Li-conducting electrolyte. One class includes rubbery polymers (elastomers). Some example members of rubbery polymers (elastomers) include, but are not limited to, polyisobutadiene (PIB), ethylene-propylene rubber (EPM), ethylene propylene diene rubber (EPDM), and perfluoroelastomers (FFKMs). Another class includes glassy/crystalline (thermoplastic) polymers. Some example members of glass/crystalline (thermoplastic) polymers include, but are not limited to, fluorinated ethylene propylene (FEP), polytetrafluoroethylene (PTFE), and Ultra-high molecular-weight polyethylene (UHWPE). Another class includes copolymers. Example members of copolymers include, but are not limited to, poly(styrene-butadiene-styrene) (SBS), poly(styrene-isoprene-styrene) (SIS), and polyvinylidene difluoride-co-fluoroolefin (PVDF-co-FEP). In some embodiments, the seal or seal material is polyisobutadiene (PIB). In some embodiments, the seal or seal material is ethylene-propylene rubber (EPM). In some embodiments, the seal or seal material is ethylene propylene diene rubber (EPDM). In some embodiments, the seal or seal material is perfluoroelastomers (FFKMs). In some embodiments, the seal or seal material is fluorinated ethylene propylene (FEP). In some embodiments, the seal or seal material is polytetrafluoroethylene (PTFE). In some embodiments, the seal or seal material is ultra-high molecular-weight polyethylene (UHWPE). In some embodiments, the seal or seal material is poly(styrene-butadiene-styrene) (SBS). In some embodiments, the seal or seal material is poly(styrene-isoprene-styrene) (SIS). In some embodiments, the seal or seal material is polyvinylidene difluoride-co-fluoroolefin (PVDF-co-FEP).

In some examples, including any of the foregoing, the top layer and bottom layer of the seal are the same material.

In some examples, including any of the foregoing, the middle layer of the seal is a different material than the top layer or bottom layer.

In some examples, including any of the foregoing, the top layer and the bottom layer of the seal are PIB.

In some examples, including any of the foregoing, the middle layer is PEEK.

In some examples, including any of the foregoing, the seal includes a plastomer (e.g., AFFINITY™ EG 8185). Herein, plastomer is used interchangeably with thermoplastic olefin.

In some examples, including any of the foregoing, the electrochemical cell is a coin cell and the seal is a circular ring.

In some examples, including any of the foregoing, the electrochemical cell includes a disc-shaped solid-state electrolyte.

In some examples, including any of the foregoing, the electrochemical cell includes a disc-shaped positive electrode.

In some examples, including any of the foregoing, the disc-shaped solid-state electrolyte is at least 0.25 times as large as the diameter of the disc-shaped positive electrode.

In some examples, including any of the foregoing, the electrochemical cell is a prismatic cell and the seal is a shape selected from the group consisting of a square frame (e.g., square-shaped ring) and a rectangular frame (e. g., rectangular-shaped ring).

In some examples, including any of the foregoing, the width of the solid-state electrolyte is larger than the width of the positive electrode.

In some examples, including any of the foregoing, the solid-state electrolyte is selected from the group consisting of a lithium-stuffed garnet, a sulfide electrolyte doped with oxygen, a sulfide electrolyte including oxygen, a lithium aluminum titanium oxide, a lithium aluminum titanium phosphate, a lithium aluminum germanium phosphate, a lithium aluminum titanium oxy-phosphate, a lithium lanthanum titanium oxide perovskite, a lithium lanthanum tantalum oxide perovskite, a lithium lanthanum titanium oxide perovskite, an antiperovskite, a LISICON, a LI-S—O—N, lithium aluminum silicon oxide, a Thio-LISICON, a lithium-substituted NASICON, a LIPON, or a combination, mixture, or multilayer thereof.

In some examples, including any of the foregoing, the solid-state electrolyte includes a lithium lanthanum titanium oxide characterized by the empirical formula, Li₃ₓLa_{2/3-x}TiO₃, wherein x is a rational number from 0 to ⅔.

In some examples, including any of the foregoing, the solid-state electrolyte includes a lithium lanthanum titanium oxide characterized by the empirical formula, Li₃ₓLa_{2/3-x}TiⱼTaₖO₃, wherein x is a rational number from 0 to ⅔, and wherein subscripts j+k=1.

In some examples, including any of the foregoing, the solid-state electrolyte includes a lithium lanthanum titanium oxide characterized by a perovskite crystal structure.

In some examples, including any of the foregoing, the solid-state electrolyte includes an antiperovskite characterized by the empirical formula, Li₃OX wherein X is Cl, Br, or combinations thereof.

In some examples, including any of the foregoing, the solid-state electrolyte includes a LISICON characterized by the empirical formula, Li(Me′ₓ,Me″_{y})(PO₄) wherein Me′ and Me″ are selected from Si, Ge, Sn or combinations thereof and wherein 0≤x≤1; wherein 0≤y≤1, and wherein x+y=1.

In some examples, including any of the foregoing, the solid-state electrolyte includes a thio-LISICON characterized by the empirical formula, Li_{3.25}Ge_{0.25}P_{0.75}S₄.

In some examples, including any of the foregoing, the solid-state electrolyte includes a thio-LISICON characterized by the empirical formula, Li₄₋ₓM₁₋ₓPₓS₄ or Li₁₀MP₂S₁₂, wherein M is selected from Si, Ge, Sn, or combinations thereof; and wherein 0≤x≤1.

In some examples, including any of the foregoing, the solid-state electrolyte includes a lithium aluminum titanium phosphate characterized by the empirical formula, Li₁₊ₓAlₓTi₂₋ₓ(PO₄), wherein 0≤x≤2.

In some examples, including any of the foregoing, the solid-state electrolyte includes a lithium aluminum germanium phosphate characterized by the empirical formula, Li_{1.5}Al_{0.5}Ge_{1.5}(PO₄).

In some examples, including any of the foregoing, the solid-state electrolyte includes a LI-S—O—N characterized by the empirical formula, LiₓS_{y}O_{z}N_{w}, wherein x, y, z, and w, are a rational number from 0.01 to 1.

In some examples, including any of the foregoing, the solid-state electrolyte includes a material characterized by the empirical formula LiₓLa₃Zr₂Oₕ+yAl₂O₃, wherein 3≤x≤8, 0≤y≤1, and 6≤h≤15; and wherein subscripts x and h, and coefficient y is selected so that the electrolyte separator is charge neutral. In some of these examples, solid-state electrolyte is doped with Ga, Nb, or Ta.

In some examples, including any of the foregoing, the seal is substantially as set forth in any one of FIG. 1A, 1B, 2, 3, 4A, 4B, 5, 6, or 7.

In some examples, including any of the foregoing, the thickness of the seal matches the thickness of positive electrode containing the electrolyte.

In some examples, including any of the foregoing, the positive electrode includes a gel electrolyte.

In some examples, including any of the foregoing, the liquid electrolyte or gel electrolyte includes: (1) a lithium salt selected from the group consisting of LiPF₆, LiBOB, LiTFSi, LiBF₄, LiClO₄, LiAsF₆, LiFSI, LiI, and a combination thereof and (2) a solvent selected from the group consisting of ethylene carbonate (EC), diethylene carbonate, diethyl carbonate, dimethyl carbonate (DMC), ethyl-methyl carbonate (EMC), tetrahydrofuran (THF), γ-Butyrolactone (GBL), fluoroethylene carbonate (FEC), fluoromethyl ethylene carbonate (FMEC), trifluoroethyl methyl carbonate (F-EMC), fluorinated 3-(1,1,2,2-tetrafluoroethoxy)-1,1,2,2-tetrafluoropropane/1,1,2,2-Tetrafluoro-3-(1,1,2,2-tetrafluoroethoxy)propane (F-EPE), fluorinated cyclic carbonate (F-AEC), propylene carbonate (PC), dioxolane, acetonitrile (ACN), succinonitrile, adiponitrile, hexanedinitrile, pentanedinitrile, acetophenone, isophorone, benzonitrile, dimethyl sulfate, sulfolane, dimethyl sulfoxide (DMSO) ethyl acetate, methyl butyrate, methyl propionate, dimethyl ether (DME), diethyl ether, propylene carbonate, dioxolane, glutaronitrile, gamma butyl-lactone, and combinations thereof.

In some examples, including any of the foregoing, the liquid electrolyte or gel electrolyte includes a polymer selected from the group consisting of polyacrylonitrile (PAN), polypropylene, polyethylene oxide (PEO), polymethyl methacrylate (PMMA), polyvinyl chloride (PVC), polyvinyl pyrrolidone (PVP), polyethylene oxide poly(allyl glycidyl ether) PEO-AGE, polyethylene oxide 2-methoxyethoxy)ethyl glycidyl ether (PEO-MEEGE), polyethylene oxide 2-methoxyethoxy)ethyl glycidyl poly(allyl glycidyl ether) (PEO-MEEGE-AGE), polysiloxane, polyvinylidene fluoride (PVDF), polyvinylidene fluoride hexafluoropropylene (PVDF-HFP), rubbers such as ethylene propylene (EPR), nitrile rubber (NPR), styrene-butadiene-rubber (SBR), polybutadiene polymer, polybutadiene rubber (PB), polyisobutadiene rubber (PIB), polyisoprene rubber (PI), polychloroprene rubber (CR), acrylonitrile-butadiene rubber (NBR), polyethyl acrylate (PEA), polyvinylidene fluoride (PVDF), polyethylene (e.g., low density linear polyethylene), and combinations thereof.

In some examples, including any of the foregoing, the polymer is polyacrylonitrile (PAN) or polyvinylidene fluoride hexafluoropropylene (PVDF-HFP).

In some examples, including any of the foregoing, the polymer is selected from the group consisting of PAN, PVDF-HFP, PVDF-HFP and PAN, PMMA, PVC, PVP, PEO, and combinations thereof.

In some examples, including any of the foregoing, the liquid electrolyte or gel electrolyte includes: (1) a solvent selected from the group consisting of ethylene carbonate (EC), propylene carbonate (PC), dimethyl carbonate (DMC), methylene carbonate, and combinations thereof; and (2) a polymer selected from the group consisting of PVDF-HFP, PAN, and combinations thereof; and (3) a lithium salt selected from the group consisting of LiPF₆, LiBOB, LFTSi, and combinations thereof.

In some examples, including any of the foregoing, the lithium salt is selected from LiPF₆, LiBOB, LFTSi, and combinations thereof.

In some examples, including any of the foregoing, the lithium salt is LiPF₆ at a concentration of 0.5 M to 2M.

In some examples, including any of the foregoing, the lithium salt is LiTFSI at a concentration of 0.5 M to 2M.

In some examples, including any of the foregoing, the lithium is present at a concentration from 0.01 M to 10 M.

In some examples, including any of the foregoing, the solvent is a 1:1 w/w mixture of EC:PC.

In some examples, including any of the foregoing, the positive electrode includes a lithium intercalation material, a lithium conversion material, or both a lithium intercalation material and a lithium conversion material.

In some examples, including any of the foregoing, the intercalation material is selected from the group consisting of a nickel manganese cobalt oxide (NMC), a nickel cobalt aluminum oxide (NCA), Li(NiCoAl)O₂, a lithium cobalt oxide (LCO), a lithium manganese cobalt oxide (LMCO), a lithium nickel manganese cobalt oxide (LMNCO), a lithium nickel manganese oxide (LNMO), Li(NiCoMn)O₂, LiMn₂O₄, LiCoO₂, and LiMn₂₋ₐNiₐO₄, wherein a is from 0 to 2, or LiMPO₄, wherein M is Fe, Ni, Co, or Mn.

In some examples, including any of the foregoing, the lithium conversion material is selected from the group consisting of FeF₂, NiF₂, FeOₓF₃₋₂ₓ, wherein subscript x is from 0 to 3/2, FeF₃, MnF₃, CoF₃, CuF₂ materials, alloys thereof, and combinations thereof.

In some examples, including any of the foregoing, the electrochemical cell is pressurized.

In some examples, including any of the foregoing, the electrochemical cell further includes a polyether ether ketone (PEEK) ring surrounding the positive electrode, the solid-state electrolyte and the Li metal negative electrode. In some examples, including any of the foregoing, the electrochemical cell further includes a polyether ether ketone (PEEK) frame surrounding some part of the positive electrode, the solid-state electrolyte and/or the Li metal negative electrode.

In some examples, including any of the foregoing, the width or diameter of the solid-state electrolyte is greater than the width or diameter of the lithium metal negative electrode.

In some examples, including any of the foregoing, the width of the solid-state electrolyte is greater than the width of the lithium metal negative electrode.

In some examples, including any of the foregoing, the diameter of the solid-state electrolyte is greater than the diameter of the lithium metal negative electrode.

In some examples, including any of the foregoing, the width or diameter of the solid-state electrolyte is greater than the width or diameter of the positive electrode.

In some examples, including any of the foregoing, the width of the solid-state electrolyte is greater than the width of the positive electrode.

In some examples, including any of the foregoing, the diameter of the solid-state electrolyte is greater than the diameter of the positive electrode.

In some examples, including any of the foregoing, the width or diameter of the solid-state electrolyte is greater than either of the width or diameter of the lithium metal negative electrode or of the positive electrode.

In some examples, including any of the foregoing, the width of the solid-state electrolyte is greater than either of the width of the lithium metal negative electrode or the width of the positive electrode.

In some examples, including any of the foregoing, the diameter of the solid-state electrolyte is greater than either of the diameter of the lithium metal negative electrode or the diameter of the positive electrode.

In some examples, including any of the foregoing, the diameter of the solid-state electrolyte is greater than the diameter of the lithium metal negative electrode.

In some examples, including any of the foregoing, the diameter of the solid-state electrolyte is greater than the diameter of the positive electrode.

In some examples, including any of the foregoing, the diameter of the solid-state electrolyte is greater than either of the diameter of the lithium metal negative electrode or of the positive electrode.

In some examples, including any of the foregoing, the width or diameter of the solid-state electrolyte is greater than the width or diameter of the lithium metal negative electrode.

In some examples, including any of the foregoing, the width of the solid-state electrolyte is greater than the width of the lithium metal negative electrode.

In some examples, including any of the foregoing, the diameter of the solid-state electrolyte is greater than the diameter of the lithium metal negative electrode.

In some examples, including any of the foregoing, the width or diameter of the solid-state electrolyte is greater than the width or diameter of the positive electrode.

In some examples, including any of the foregoing, the width or diameter of the solid-state electrolyte is greater than both the width or diameter of the lithium metal negative electrode and positive electrode.

In some examples, including any of the foregoing, the width of the solid-state electrolyte is greater than both the width of the lithium metal negative electrode and the width of the positive electrode.

In some examples, including any of the foregoing, the diameter of the solid-state electrolyte is greater than both the diameter of the lithium metal negative electrode and the diameter of the positive electrode.

In some examples, including any of the foregoing, the solid-state electrolyte has raised edges.

In some examples, including any of the foregoing, the solid-state electrolyte has coated edges.

In some examples, including any of the foregoing, the coated edges include a coating selected from parylene, polypropylene, polyethylene, alumina, Al₂O₃, ZrO₂, TiO₂, SiO₂, a binary oxide, La₂Zr₂O₇, a lithium carbonate species, or a glass, wherein the glass is selected from SiO₂—B₂O₃, or Al₂O₃.

In some examples, including any of the foregoing, the solid-state electrolyte has tapered edges.

Also set forth herein is a battery which includes at least one electrochemical cell set forth herein.

Also set forth herein is a device, which includes a battery set forth herein or an electrochemical cell set forth herein.

In one embodiment, set for herein is an electrochemical cell comprising:
a positive electrode current collector;
a positive electrode comprising a liquid electrolyte;
a bilayer solid-state electrolyte having a first layer comprising a sulfide and a second layer comprising a lithium phosphorus sulfur halide;
a negative electrode current collector; and
a seal impermeable to the liquid electrolyte, which seals the interface between the positive electrode current collector and the positive electrode; and which seals the interface between the positive electrode and the first layer of the bilayer solid-state electrolyte;
wherein the first layer is in direct contact with the positive electrode. In some examples, the first layer comprising a sulfide and the second layer comprising the lithium phosphorus sulfur halide are in direct contact with each other. In some examples, the lithium phosphorus sulfur halide is a lithium phosphorus sulfur iodide.

In some embodiments of the electrochemical cell, the sulfide in the first layer is a lithium silicon sulfide, LTS, LXPS, or LXPSO.

In some embodiments of the electrochemical cell, the sulfide in the first layer is a lithium silicon sulfide.

In some embodiments, including any of the foregoing embodiments, the second layer is in contact with the negative electrode current collector when the electrochemical cell is fully discharged or is in contact with a layer of lithium on the negative electrode current collector when the electrochemical cell is at least partially charged.

In some embodiments, including any of the foregoing embodiments, the electrochemical cell comprises a layer of lithium in direct contact with and between the bilayer solid-state electrolyte and the negative electrode current collector.

In some embodiments, including any of the foregoing embodiments, the second layer is in direct contact with the layer of lithium.

In some embodiments, including any of the foregoing embodiments, the solid-state electrolyte is impermeable to the liquid electrolyte.

In some embodiments, including any of the foregoing embodiments, the electrochemical cell comprises a negative metal electrode; wherein the second layer is in direct contact with the negative metal electrode.

In some embodiments, including any of the foregoing embodiments, the negative metal electrode is a lithium (Li) metal negative electrode.

In some embodiments, including any of the foregoing embodiments, the seal does not contact the second layer of the bilayer electrolyte.

In some embodiments, including any of the foregoing embodiments, the seal impermeable to the liquid electrolyte seals the interface between the first and second layers of the bilayer electrolyte.

In some embodiments, including any of the foregoing embodiments, the seal is made of a single material.

In some embodiments, including any of the foregoing embodiments, the seal is made of multi-layers of materials.

In some embodiments, including any of the foregoing embodiments, the height of the seal from the positive electrode current collector to where the seal terminates on the bilayer solid-state electrolyte is about 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40 μm. In some examples, the height of the seal from the positive electrode current collector to where the seal terminates on the bilayer solid-state electrolyte is about 0.1 μm. In some examples, the height of the seal from the positive electrode current collector to where the seal terminates on the bilayer solid-state electrolyte is about 0.2 μm. In some examples, the height of the seal from the positive electrode current collector to where the seal terminates on the bilayer solid-state electrolyte is about 0.3 μm. In some examples, the height of the seal from the positive electrode current collector to where the seal terminates on the bilayer solid-state electrolyte is about 0.4 μm. In some examples, the height of the seal from the positive electrode current collector to where the seal terminates on the bilayer solid-state electrolyte is about 0.5 μm. In some examples, the height of the seal from the positive electrode current collector to where the seal terminates on the bilayer solid-state electrolyte is about 0.6 μm. In some examples, the height of the seal from the positive electrode current collector to where the seal terminates on the bilayer solid-state electrolyte is about 0.7 μm. In some examples, the height of the seal from the positive electrode current collector to where the seal terminates on the bilayer solid-state electrolyte is about 0.8 μm. In some examples, the height of the seal from the positive electrode current collector to where the seal terminates on the bilayer solid-state electrolyte is about 0.9 μm. In some examples, the height of the seal from the positive electrode current collector to where the seal terminates on the bilayer solid-state electrolyte is about 1 In some examples, the height of the seal from the positive electrode current collector to where the seal terminates on the bilayer solid-state electrolyte is about 2 μm. In some examples, the height of the seal from the positive electrode current collector to where the seal terminates on the bilayer solid-state electrolyte is about 3 μm. In some examples, the height of the seal from the positive electrode current collector to where the seal terminates on the bilayer solid-state electrolyte is about 4 μm. In some examples, the height of the seal from the positive electrode current collector to where the seal terminates on the bilayer solid-state electrolyte is about 5 In some examples, the height of the seal from the positive electrode current collector to where the seal terminates on the bilayer solid-state electrolyte is about 6 μm. In some examples, the height of the seal from the positive electrode current collector to where the seal terminates on the bilayer solid-state electrolyte is about 7 μm. In some examples, the height of the seal from the positive electrode current collector to where the seal terminates on the bilayer solid-state electrolyte is about 8 μm. In some examples, the height of the seal from the positive electrode current collector to where the seal terminates on the bilayer solid-state electrolyte is about 9 μm. In some examples, the height of the seal from the positive electrode current collector to where the seal terminates on the bilayer solid-state electrolyte is about 10 μm. In some examples, the height of the seal from the positive electrode current collector to where the seal terminates on the bilayer solid-state electrolyte is about 11 μm. In some examples, the height of the seal from the positive electrode current collector to where the seal terminates on the bilayer solid-state electrolyte is about 12 μm. In some examples, the height of the seal from the positive electrode current collector to where the seal terminates on the bilayer solid-state electrolyte is about 13 μm. In some examples, the height of the seal from the positive electrode current collector to where the seal terminates on the bilayer solid-state electrolyte is about 14 μm. In some examples, the height of the seal from the positive electrode current collector to where the seal terminates on the bilayer solid-state electrolyte is about 15 μm. In some examples, the height of the seal from the positive electrode current collector to where the seal terminates on the bilayer solid-state electrolyte is about 16 μm. In some examples, the height of the seal from the positive electrode current collector to where the seal terminates on the bilayer solid-state electrolyte is about 17 μm. In some examples, the height of the seal from the positive electrode current collector to where the seal terminates on the bilayer solid-state electrolyte is about 18 μm. In some examples, the height of the seal from the positive electrode current collector to where the seal terminates on the bilayer solid-state electrolyte is about 19 μm. In some examples, the height of the seal from the positive electrode current collector to where the seal terminates on the bilayer solid-state electrolyte is about 20 μm. In some examples, the height of the seal from the positive electrode current collector to where the seal terminates on the bilayer solid-state electrolyte is about 21 μm. In some examples, the height of the seal from the positive electrode current collector to where the seal terminates on the bilayer solid-state electrolyte is about 22 μm. In some examples, the height of the seal from the positive electrode current collector to where the seal terminates on the bilayer solid-state electrolyte is about 23 μm. In some examples, the height of the seal from the positive electrode current collector to where the seal terminates on the bilayer solid-state electrolyte is about 24 μm. In some examples, the height of the seal from the positive electrode current collector to where the seal terminates on the bilayer solid-state electrolyte is about 25 μm. In some examples, the height of the seal from the positive electrode current collector to where the seal terminates on the bilayer solid-state electrolyte is about 26 μm. In some examples, the height of the seal from the positive electrode current collector to where the seal terminates on the bilayer solid-state electrolyte is about 27 μm. In some examples, the height of the seal from the positive electrode current collector to where the seal terminates on the bilayer solid-state electrolyte is about 28 μm. In some examples, the height of the seal from the positive electrode current collector to where the seal terminates on the bilayer solid-state electrolyte is about 29 μm. In some examples, the height of the seal from the positive electrode current collector to where the seal terminates on the bilayer solid-state electrolyte is about 30 In some examples, the height of the seal from the positive electrode current collector to where the seal terminates on the bilayer solid-state electrolyte is about 31 μm. In some examples, the height of the seal from the positive electrode current collector to where the seal terminates on the bilayer solid-state electrolyte is about 32 μm. In some examples, the height of the seal from the positive electrode current collector to where the seal terminates on the bilayer solid-state electrolyte is about 33 μm. In some examples, the height of the seal from the positive electrode current collector to where the seal terminates on the bilayer solid-state electrolyte is about 34 μm. In some examples, the height of the seal from the positive electrode current collector to where the seal terminates on the bilayer solid-state electrolyte is about 35 In some examples, the height of the seal from the positive electrode current collector to where the seal terminates on the bilayer solid-state electrolyte is about 36 μm. In some examples, the height of the seal from the positive electrode current collector to where the seal terminates on the bilayer solid-state electrolyte is about 37 μm. In some examples, the height of the seal from the positive electrode current collector to where the seal terminates on the bilayer solid-state electrolyte is about 38 μm. In some examples, the height of the seal from the positive electrode current collector to where the seal terminates on the bilayer solid-state electrolyte is about 39 μm. In some examples, the height of the seal from the positive electrode current collector to where the seal terminates on the bilayer solid-state electrolyte is about 40 μm.

In some embodiments, the height of the seal is about 0.1 to 40 μm, 0.1 to 30 μm, 0.1 to 20 μm, 0.1 to 10 μm, 0.1 to 1 μm, 0.1 to 0.9 μm, 0.1 to 0.8 μm, 0.1 to 0.7 0.1 to 1 μm, 0.1 to 0.6 μm, 0.1 to 0.5 μm, 0.1 to 0.4 μm, 0.1 to 0.3 μm, or 0.1 to 0.2 μm. In some embodiments, the height of the seal is about 1 to 40 μm, about 1 to 30 μm, about 1 to 20 μm, 1 to 10 μm, 1 to 9 μm, 1 to 8 μm, 1 to 7 μm, 1 to 6 μm, 1 to 5 μm, 1 to 4 μm, 1 to 3 μm, or 1 to 2 μm. In some embodiments, the height of the seal is about 10 to 40 μm, 10 to 30 μm, 10 to 20 μm, 10 to 19 μm, 10 to 18 μm, 10 to 17 μm, 10 to 16 μm, 10 to 15 μm, 10 to 14 μm, 10 to 13 μm, 10 to 12 μm, or 10 to 11 μm. In some embodiments, the height of the seal is about 20 to 40 μm, 20 to 30 μm, 20 to 28 μm, 20 to 26 μm, 20 to 26 μm, 20 to 24 μm, or 20 to 22 μm. In some embodiments, the height of the seal is about 30 to 40 μm or 30 to 35 μm.

In some embodiments, including any of the foregoing embodiments, the seal has a wall thickness of about 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40 μm. In some examples, the seal has a wall thickness that is about 0.1 μm. In some examples, the seal has a wall thickness that is about 0.2 μm. In some examples, the seal has a wall thickness that is about 0.3 μm. In some examples, the seal has a wall thickness that is about 0.4 μm. In some examples, the seal has a wall thickness that is about 0.5 μm. In some examples, the seal has a wall thickness that is about 0.6 μm. In some examples, the seal has a wall thickness that is about 0.7 μm. In some examples, the seal has a wall thickness that is about 0.8 μm. In some examples, the seal has a wall thickness that is about 0.9 μm. In some examples, the seal has a wall thickness that is about 1 μm. In some examples, the seal has a wall thickness that is about 2 μm. In some examples, the seal has a wall thickness that is about 3 μm. In some examples, the seal has a wall thickness that is about 4 μm. In some examples, the seal has a wall thickness that is about 5 μm. In some examples, the seal has a wall thickness that is about 6 μm. In some examples, the seal has a wall thickness that is about 7 μm. In some examples, the seal has a wall thickness that is about 8 μm. In some examples, the seal has a wall thickness that is about 9 μm. In some examples, the seal has a wall thickness that is about 10 μm. In some examples, the seal has a wall thickness that is about 11 μm. In some examples, the seal has a wall thickness that is about 12 μm. In some examples, the seal has a wall thickness that is about 13 μm. In some examples, the seal has a wall thickness that is about 14 μm. In some examples, the seal has a wall thickness that is about 15 μm. In some examples, the seal has a wall thickness that is about 16 μm. In some examples, the seal has a wall thickness that is about 17 μm. In some examples, the seal has a wall thickness that is about 18 μm. In some examples, the seal has a wall thickness that is about 19 μm. In some examples, the seal has a wall thickness that is about 20 μm. In some examples, the seal has a wall thickness that is about 21 μm. In some examples, the seal has a wall thickness that is about 22 μm. In some examples, the seal has a wall thickness that is about 23 μm. In some examples, the seal has a wall thickness that is about 24 μm. In some examples, the seal has a wall thickness that is about 25 μm. In some examples, the seal has a wall thickness that is about 26 μm. In some examples, the seal has a wall thickness that is about 27 μm. In some examples, the seal has a wall thickness that is about 28 μm. In some examples, the seal has a wall thickness that is about 29 μm. In some examples, the seal has a wall thickness that is about 30 μm. In some examples, the seal has a wall thickness that is about 31 μm. In some examples, the seal has a wall thickness that is about 32 μm. In some examples, the seal has a wall thickness that is about 33 μm. In some examples, the seal has a wall thickness that is about 34 μm. In some examples, the seal has a wall thickness that is about 35 μm. In some examples, the seal has a wall thickness that is about 36 μm. In some examples, the seal has a wall thickness that is about 37 μm. In some examples, the seal has a wall thickness that is about 38 μm. In some examples, the seal has a wall thickness that is about 39 μm. In some examples, the seal has a wall thickness that is about 40 μm.

In some embodiments, including any of the foregoing embodiments, the seal has a wall thickness of about 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40 mm. In some examples, the seal has a wall thickness that is about 0.1 mm. In some examples, the seal has a wall thickness that is about 0.2 mm. In some examples, the seal has a wall thickness that is about 0.3 mm. In some examples, the seal has a wall thickness that is about 0.4 mm. In some examples, the seal has a wall thickness that is about 0.5 mm. In some examples, the seal has a wall thickness that is about 0.6 mm. In some examples, the seal has a wall thickness that is about 0.7 mm. In some examples, the seal has a wall thickness that is about 0.8 mm. In some examples, the seal has a wall thickness that is about 0.9 mm. In some examples, the seal has a wall thickness that is about 1 mm. In some examples, the seal has a wall thickness that is about 2 mm. In some examples, the seal has a wall thickness that is about 3 mm. In some examples, the seal has a wall thickness that is about 4 mm. In some examples, the seal has a wall thickness that is about 5 mm. In some examples, the seal has a wall thickness that is about 6 mm. In some examples, the seal has a wall thickness that is about 7 mm. In some examples, the seal has a wall thickness that is about 8 mm. In some examples, the seal has a wall thickness that is about 9 mm. In some examples, the seal has a wall thickness that is about 10 mm. In some examples, the seal has a wall thickness that is about 11 mm. In some examples, the seal has a wall thickness that is about 12 mm. In some examples, the seal has a wall thickness that is about 13 mm. In some examples, the seal has a wall thickness that is about 14 mm. In some examples, the seal has a wall thickness that is about 15 mm. In some examples, the seal has a wall thickness that is about 16 mm. In some examples, the seal has a wall thickness that is about 17 mm. In some examples, the seal has a wall thickness that is about 18 mm. In some examples, the seal has a wall thickness that is about 19 mm. In some examples, the seal has a wall thickness that is about 20 mm. In some examples, the seal has a wall thickness that is about 21 mm. In some examples, the seal has a wall thickness that is about 22 mm. In some examples, the seal has a wall thickness that is about 23 mm. In some examples, the seal has a wall thickness that is about 24 mm. In some examples, the seal has a wall thickness that is about 25 mm. In some examples, the seal has a wall thickness that is about 26 mm. In some examples, the seal has a wall thickness that is about 27 mm. In some examples, the seal has a wall thickness that is about 28 mm. In some examples, the seal has a wall thickness that is about 29 mm. In some examples, the seal has a wall thickness that is about 30 mm. In some examples, the seal has a wall thickness that is about 31 mm. In some examples, the seal has a wall thickness that is about 32 mm. In some examples, the seal has a wall thickness that is about 33 mm. In some examples, the seal has a wall thickness that is about 34 mm. In some examples, the seal has a wall thickness that is about 35 mm. In some examples, the seal has a wall thickness that is about 36 mm. In some examples, the seal has a wall thickness that is about 37 mm. In some examples, the seal has a wall thickness that is about 38 mm. In some examples, the seal has a wall thickness that is about 39 mm. In some examples, the seal has a wall thickness that is about 40 mm.

In some embodiments, the seal has a wall thickness of about 0.1 to 40 μm, 0.1 to 30 μm, 0.1 to 20 μm, 0.1 to 10 μm, 0.1 to 1 μm, 0.1 to 0.9 μm, 0.1 to 0.8 μm, 0.1 to 0.7 μm, 0.1 to 1 μm, 0.1 to 0.6 μm, 0.1 to 0.5 μm, 0.1 to 0.4 μm, 0.1 to 0.3 μm, or 0.1 to 0.2 μm. In some embodiments, the seal has a wall thickness of about 1 to 40 μm, about 1 to 30 μm, about 1 to 20 μm, 1 to 10 μm, 1 to 9 μm, 1 to 8 μm, 1 to 7 μm, 1 to 6 μm, 1 to 5 μm, 1 to 4 μm, 1 to 3 μm, or 1 to 2 μm. In some embodiments, the seal has a wall thickness of about 10 to 40 μm, 10 to 30 μm, 10 to 20 μm, 10 to 19 μm, 10 to 18 μm, 10 to 17 μm, 10 to 16 μm, 10 to 15 μm, 10 to 14 μm, 10 to 13 μm, 10 to 12 μm, or 10 to 11 μm. In some embodiments, the seal has a wall thickness of about 20 to 40 μm, 20 to 30 μm, 20 to 28 μm, 20 to 26 μm, 20 to 26 μm, 20 to 24 μm, or 20 to 22 μm. In some embodiments, the seal has a wall thickness of about 30 to 40 μm or 30 to 35 μm.

In some embodiments, including any of the foregoing embodiments, the seal comprises a material selected from the group consisting of polyisobutylene (PIB), polypropylene, polyether ether ketone (PEEK), polypropylene, a polyolefin, and combinations thereof. In some embodiments, the seal comprises polyisobutylene (PIB). In some embodiments, the seal comprises polypropylene. In some embodiments, the seal comprises polyether ether ketone (PEEK). In some embodiments, the seal comprises polypropylene. In some embodiments, the seal comprises a polyolefin.

In some embodiments, including any of the foregoing embodiments, the seal comprises a plastomer.

In some embodiments, the seal or seal material is selected from a member of one of the following polymer classes. These polymer classes are suitable for sealing applications in the presence of a liquid (e.g., polar) Li-conducting electrolyte. One class includes rubbery polymers (elastomers). Some example members of rubbery polymers (elastomers) include, but are not limited to, polyisobutadiene (PIB), ethylene-propylene rubber (EPM), ethylene propylene diene rubber (EPDM), and perfluoroelastomers (FFKMs). Another class includes glassy/crystalline (thermoplastic) polymers. Some example members of glass/crystalline (thermoplastic) polymers include, but are not limited to, fluorinated ethylene propylene (FEP), polytetrafluoroethylene (PTFE), and Ultra-high molecular-weight polyethylene (UHWPE). Another class includes copolymers. Example members of copolymers include, but are not limited to, poly(styrene-butadiene-styrene) (SBS), poly(styrene-isoprene-styrene) (SIS), and polyvinylidene difluoride-co-fluoroolefin (PVDF-co-FEP). In some embodiments, the seal or seal material is polyisobutadiene (PIB). In some embodiments, the seal or seal material is ethylene-propylene rubber (EPM). In some embodiments, the seal or seal material is ethylene propylene diene rubber (EPDM). In some embodiments, the seal or seal material is perfluoroelastomers (FFKMs). In some embodiments, the seal or seal material is fluorinated ethylene propylene (FEP). In some embodiments, the seal or seal material is polytetrafluoroethylene (PTFE). In some embodiments, the seal or seal material is ultra-high molecular-weight polyethylene (UHWPE). In some embodiments, the seal or seal material is poly(styrene-butadiene-styrene) (SBS). In some embodiments, the seal or seal material is poly(styrene-isoprene-styrene) (SIS). In some embodiments, the seal or seal material is polyvinylidene difluoride-co-fluoroolefin (PVDF-co-FEP).

In some embodiments, including any of the foregoing embodiments, the seal is bonded to the side of the positive electrode.

In some embodiments, including any of the foregoing embodiments, the liquid electrolyte is sealed within the positive electrode.

In some embodiments, including any of the foregoing embodiments, the electrochemical cell is a coin cell and the seal is a circular ring. In some embodiments, the electrochemical cell comprises a disc-shaped solid state electrolyte and a disc-shaped positive electrode, and wherein the diameter of the disc-shaped solid state electrolyte is at least 0.25 times larger than the diameter of the disc-shaped positive electrode.

In some embodiments, the diameter of the disc-shaped solid state electrolyte is 0.3, 0.4, 0.5, 0.6, 0.7, 0.8, or 0.9 times larger than the diameter of the disc-shaped positive electrode.

In some embodiments, including any of the foregoing embodiments, the electrochemical cell is a prismatic cell and the seal is a shape selected from the group consisting of a frame, such as a square frame or a rectangular frame. In some embodiments, the width of the solid-state electrolyte is larger than the width of the positive electrode. In some embodiments, the width of the solid-state electrolyte is at least 1.1 times larger than the width of the positive electrode. In some embodiments, the length of the solid-state electrolyte is larger than the length of the positive electrode. In some embodiments, the length of the solid-state electrolyte is 0.1 mm larger than the length of the positive electrode.

In some embodiments, the width of the solid-state electrolyte is at least 0.2, 0.3, 0.4, 05, 0.6, 0.7, 0.8, or 0.9 times larger than the width of the positive electrode.

In some embodiments, including any of the foregoing embodiments, the liquid electrolyte is a gel electrolyte.

In some embodiments, including any of the foregoing embodiments, the liquid electrolyte comprises a lithium salt, a polymer, and a solvent. Examples of liquid electrolyte are described in U.S. Pat. No. 5,296,318 entitled “Rechargeable lithium intercalation battery with hybrid polymeric electrolyte,” WO/2017/197406 entitled “SOLID ELECTROLYTE SEPARATOR BONDING AGENT” (PCT/US2017/032749 filed May 15, 2017), and US-2017-0331092-A1 entitled “SOLID ELECTROLYTE SEPARATOR BONDING AGENT” (U.S. application Ser. No. 15/595,755 filed May 15, 2017), the disclosures of which are incorporated by reference herein for purpose.

In some embodiments, the lithium salt is selected from the group consisting of LiPF₆, LiBOB, LiBETI, LiTFSi, LiBF₄, LiClO₄, LiAsF₆, LiFSI, LiI, and a combination thereof. In some embodiments, the lithium salt is LiPF₆. In some embodiments, the lithium salt is LiBOB. In some embodiments, the lithium salt is LiBETI. In some embodiments, the lithium salt is LiTFSi. In some embodiments, the lithium salt is LiBF₄. In some embodiments, the lithium salt is LiClO₄. In some embodiments, the lithium salt is LiAsF₆. In some embodiments, the lithium salt is LiFSI. In some embodiments, the lithium salt is LiI.

In some embodiments, the polymer is selected from the group consisting of polyacrylonitrile (PAN), polypropylene, polyethylene oxide (PEO), polymethyl methacrylate (PMMA), polyvinyl chloride (PVC), polyvinyl pyrrolidone (PVP), polyethylene oxide poly(allyl glycidyl ether) PEO-AGE, polyethylene oxide 2-methoxyethoxy)ethyl glycidyl ether (PEO-MEEGE), polyethylene oxide 2-methoxyethoxy)ethyl glycidyl poly(allyl glycidyl ether) (PEO-MEEGE-AGE), polysiloxane, polyvinylidene fluoride (PVDF), polyvinylidene fluoride hexafluoropropylene (PVDF-HFP), ethylene propylene (EPR), nitrile rubber (NPR), styrene-butadiene-rubber (SBR), polybutadiene polymer, polybutadiene rubber (PB), polyisobutadiene rubber (PIB), polyisoprene rubber (PI), polychloroprene rubber (CR), acrylonitrile-butadiene rubber (NBR), polyethyl acrylate (PEA), polyvinylidene fluoride (PVDF), and polyethylene.

In some embodiments, the polymer is polyacrylonitrile (PAN). In some embodiments, the polymer is polypropylene. In some embodiments, the polymer is polyethylene oxide (PEO). In some embodiments, the polymer is polymethyl methacrylate (PMMA). In some embodiments, the polymer is polyvinyl chloride (PVC). In some embodiments, the polymer is polyvinyl pyrrolidone (PVP). In some embodiments, the polymer is polyethylene oxide poly(allyl glycidyl ether) (PEO-AGE). In some embodiments, the polymer is polyethylene oxide 2-methoxyethoxy)ethyl glycidyl ether (PEO-MEEGE). In some embodiments, the polymer is polyethylene oxide 2-methoxyethoxy)ethyl glycidyl poly(allyl glycidyl ether) (PEO-MEEGE-AGE). In some embodiments, the polymer is polysiloxane. In some embodiments, the polymer is polyvinylidene fluoride (PVDF). In some embodiments, the polymer is polyvinylidene fluoride hexafluoropropylene (PVDF-HFP). In some embodiments, the polymer is ethylene propylene (EPR), nitrile rubber (NPR). In some embodiments, the polymer is styrene-butadiene-rubber (SBR). In some embodiments, the polymer is polybutadiene polymer. In some embodiments, the polymer is polybutadiene rubber (PB). In some embodiments, the polymer is polyisobutadiene rubber (PIB). In some embodiments, the polymer is polyisoprene rubber (PI). In some embodiments, the polymer is polychloroprene rubber (CR). In some embodiments, the polymer is acrylonitrile-butadiene rubber (NBR). In some embodiments, the polymer is polyethyl acrylate (PEA). In some embodiments, the polymer is polyvinylidene fluoride (PVDF). In some embodiments, the polymer is polyethylene.

In some embodiments, the solvent is selected from the group consisting of ethylene carbonate (EC), diethylene carbonate or diethyl carbonate (DC), dimethyl carbonate (DMC), ethyl-methyl carbonate (EMC), tetrahydrofuran (THF), γ-Butyrolactone (GBL), fluoroethylene carbonate (FEC), sulfolane, fluoromethyl ethylene carbonate (FMEC), trifluoroethyl methyl carbonate (F-EMC), fluorinated 3-(1,1,2,2-tetrafluoroethoxy)-1,1,2,2-tetrafluoropropane (F-EPE), fluorinated cyclic carbonate (F-AEC), propylene carbonate (PC), dioxolane, acetonitrile (ACN), acetophenone, isophorone, benzonitrile, dimethyl sulfate, prop-1-ene-1,3-sultone (PES), dimethyl sulfoxide (DMSO), ethyl-methyl carbonate, ethyl acetate, methyl butyrate, dimethyl ether (DME), diethyl ether, propylene carbonate, dioxolane, glutaronitrile, gamma butyl-lactone, nitrile solvent is selected from adiponitrile, acetonitrile, benzonitrile, butanedinitrile, butyronitrile, decanenitrile, ethoxyacetonitrile, fluoroacetonitrile, glutaronitrile, hexanenitrile, heptanenitrile, heptanedinitrile, iso-butyronitrile, malononitrile, methoxyacetonitrile, nitroacetonitrile, nonanenitrile, nonanedinitrile, octanedinitrile, octanenitrile, propanenitrile, pentanenitrile, pentanedinitrile, sebaconitrile, succinonitrile, and combinations thereof.

In some embodiments, the solvent is ethylene carbonate (EC). In some embodiments, the solvent is diethylene carbonate or diethyl carbonate (DC). In some embodiments, the solvent is dimethyl carbonate (DMC). In some embodiments, the solvent is ethyl-methyl carbonate (EMC). In some embodiments, the solvent is tetrahydrofuran (THF). In some embodiments, the solvent is γ-Butyrolactone (GBL). In some embodiments, the solvent is fluoroethylene carbonate (FEC). In some embodiments, the solvent is sulfolane. In some embodiments, the solvent is fluoromethyl ethylene carbonate (FMEC). In some embodiments, the solvent is trifluoroethyl methyl carbonate (F-EMC). In some embodiments, the solvent is fluorinated 3-(1,1,2,2-tetrafluoroethoxy)-1,1,2,2-tetrafluoropropane (F-EPE). In some embodiments, the solvent is fluorinated cyclic carbonate (F-AEC). In some embodiments, the solvent is propylene carbonate (PC). In some embodiments, the solvent is dioxolane. In some embodiments, the solvent is acetonitrile (ACN), acetophenone. In some embodiments, the solvent is isophorone. In some embodiments, the solvent is benzonitrile. In some embodiments, the solvent is dimethyl sulfate. In some embodiments, the solvent is prop-1-ene-1,3-sultone (PES). In some embodiments, the solvent is dimethyl sulfoxide (DMSO). In some embodiments, the solvent is ethyl-methyl carbonate. In some embodiments, the solvent is ethyl acetate. In some embodiments, the solvent is methyl butyrate. In some embodiments, the solvent is dimethyl ether (DME). In some embodiments, the solvent is diethyl ether. In some embodiments, the solvent is propylene carbonate, dioxolane. In some embodiments, the solvent is glutaronitrile. In some embodiments, the solvent is gamma butyl-lactone. In some embodiments, the solvent is a nitrile solvent is selected from adiponitrile, acetonitrile, benzonitrile, butanedinitrile, butyronitrile, decanenitrile, ethoxyacetonitrile, fluoroacetonitrile, glutaronitrile, hexanenitrile, heptanenitrile, heptanedinitrile, iso-butyronitrile, malononitrile, methoxyacetonitrile, nitroacetonitrile, nonanenitrile, nonanedinitrile, octanedinitrile, octanenitrile, propanenitrile, pentanenitrile, pentanedinitrile, sebaconitrile, succinonitrile, and combinations thereof.

In some embodiments, including any of the foregoing embodiments, the positive electrode comprises a liquid electrolyte which comprises:
a solvent selected from the group consisting of ethylene carbonate (EC), propylene carbonate (PC), dimethyl carbonate (DMC), methylene carbonate, and combinations thereof
a polymer selected from the group consisting of PVDF-HFP and PAN; and
a lithium salt selected from the group consisting of LiPF₆, LiBOB, and LiTFSi.

In some embodiments, including any of the foregoing embodiments, the positive electrode comprises a liquid electrolyte which comprises:
a lithium salt selected from the group consisting of LiPF₆, LiBOB, LiTFSi, LiBF₄, LiClO₄, LiAsF₆, LiFSI, LiI, and a combination thereof and
a solvent selected from the group consisting of ethylene carbonate (EC), diethylene carbonate, diethyl carbonate, dimethyl carbonate (DMC), ethyl-methyl carbonate (EMC), tetrahydrofuran (THF), γ-Butyrolactone (GBL), fluoroethylene carbonate (FEC), sulfolane, fluoromethyl ethylene carbonate (FMEC), trifluoroethyl methyl carbonate (F-EMC), fluorinated 3-(1,1,2,2-tetrafluoroethoxy)-1,1,2,2-tetrafluoropropane/1,1,2,2-Tetrafluoro-3-(1,1,2,2-tetrafluoroethoxy)propane (F-EPE), fluorinated cyclic carbonate (F-AEC), propylene carbonate (PC), dioxolane, acetonitrile (ACN), succinonitrile, adiponitrile, hexanedinitrile, pentanedinitrile, acetophenone, isophorone, benzonitrile, dimethyl sulfate, dimethyl sulfoxide (DMSO), ethyl acetate, methyl butyrate, dimethyl ether (DME), diethyl ether, propylene carbonate, dioxolane, glutaronitrile, gamma butyl-lactone, and combinations thereof.

In some embodiments, including any of the foregoing embodiments, the positive electrode further comprises a polymer selected from the group consisting of polyacrylonitrile (PAN), polypropylene, polyethylene oxide (PEO), polymethyl methacrylate (PMMA), polyvinyl chloride (PVC), polyvinyl pyrrolidone (PVP), polyethylene oxide poly(allyl glycidyl ether) PEO-AGE, polyethylene oxide 2-methoxyethoxy)ethyl glycidyl ether (PEO-MEEGE), polyethylene oxide 2-methoxyethoxy)ethyl glycidyl poly(allyl glycidyl ether) (PEO-MEEGE-AGE), polysiloxane, polyvinylidene fluoride (PVDF), polyvinylidene fluoride hexafluoropropylene (PVDF-HFP), rubbers, ethylene propylene (EPR), nitrile rubber (NPR), styrene-butadiene-rubber (SBR), polybutadiene polymer, polybutadiene rubber (PB), polyisobutadiene rubber (PIB), polyisoprene rubber (PI), polychloroprene rubber (CR), acrylonitrile-butadiene rubber (NBR), polyethyl acrylate (PEA), polyethylene (e.g., low density linear polyethylene), and combinations thereof. In some embodiments, the polymer is polyacrylonitrile (PAN) or polyvinylidene fluoride hexafluoropropylene (PVDF-HFP).

In some embodiments, including any of the foregoing embodiments, the lithium salt is selected from LiPF₆, LiBOB, LiTFSi, and combinations thereof.

In some embodiments, including any of the foregoing embodiments, the lithium salt is LiPF₆ at a concentration of 0.5 M to 2M.

In some embodiments, including any of the foregoing embodiments, the lithium salt is LiTFSI at a concentration of 0.5 M to 2M

In some embodiments, including any of the foregoing embodiments, the lithium is present at a concentration from 0.01 M to 10 M.

In some embodiments, including any of the foregoing embodiments, the solvent is a 1:1 w/w mixture of EC:PC.

In some embodiments, including any of the foregoing embodiments, the positive electrode comprises a lithium intercalation material, a lithium conversion material, or both a lithium intercalation material and a lithium conversion material. In some embodiments, the intercalation material is selected from the group consisting of a nickel manganese cobalt oxide (NMC), a nickel cobalt aluminum oxide (NCA), Li(NiCoAl)O₂, a lithium cobalt oxide (LCO), a lithium manganese cobalt oxide (LMCO), a lithium nickel manganese cobalt oxide (LMNCO), a lithium nickel manganese oxide (LNMO), Li(NiCoMn)O₂, LiMn₂O₄, LiCoO₂, and LiMn₂₋ₐNiₐO₄, wherein a is from 0 to 2, or LiMPO₄, wherein M is Fe, Ni, Co, or Mn. In some embodiments, the lithium conversion material is selected from the group consisting of FeF₂, NiF₂, FeOₓF₃₋₂ₓ, FeF₃, MnF₃, CoF₃, CuF₂ materials, alloys thereof, and combinations thereof.

In some embodiments, including any of the foregoing embodiments, the first or second layer of the bilayer solid-state electrolyte further comprises a member selected from the group consisting of tin (Sn), germanium (Ge), arsenic (As), silicon (Si), chlorine (CO, bromine (Br), and a combination thereof. In some embodiments, the first layer of the bilayer solid-state electrolyte further comprises a member selected from the group consisting of tin (Sn), germanium (Ge), arsenic (As), silicon (Si), chlorine (Cl), bromine (Br), and a combination thereof.

In some embodiments, including any of the foregoing embodiments, the sulfide in the first layer is selected from the group consisting of xLi₂S:y.SiS₂, wherein x and y are each independently a number from 0 to 1, and wherein x+y=1, LSS, LGPS, LSTPS, and LSPS.

In some embodiments, including any of the foregoing embodiments, the second layer is selected from the group consisting of LPSX, wherein X═I, Br, Cl, or F, and LPSX has the formula:aLi₂S:bP₂S 5:cLiX wherein 30≤a≤60, 10≤b≤40, 10≤c≤50.

In some embodiments, including any of the foregoing embodiments, the solid-state separator is rectangular shaped.

In some embodiments, including any of the foregoing embodiments, the solid-state separator is disc-shaped.

In some embodiments, including any of the foregoing embodiments, the positive electrode is rectangular shaped.

In some embodiments, including any of the foregoing embodiments, the positive electrode is disc-shaped.

In some embodiments, including any of the foregoing embodiments, the geometric surface area of the positive electrode and the geometric surface area solid-state separator are substantially the same.

In some embodiments, including any of the foregoing embodiments, one edge of the positive electrode layer is about 10 cm in length.

In some embodiments, including any of the foregoing embodiments, one edge of the solid-state separator layer is about 10 cm in length.

In some embodiments, including any of the foregoing embodiments, the thickness of the positive electrode layer is about 100

In some embodiments, including any of the foregoing embodiments, the thickness of the positive electrode layer is about 10 μm to about 500 μm. In some embodiments, the thickness of the positive electrode layer is about 10 μm to about 400 μm, about 10 μm to about 300 μm, about 10 μm to about 200 about 20 μm to about 200 μm, about 30 μm to about 200 μm, about 40 μm to about 200 about 50 μm to about 200 μm, about 60 μm to about 200 μm, about 70 μm to about 200 about 80 μm to about 200 μm, about 90 μm to about 200 μm, about 20 μm to about 150 about 30 μm to about 150 μm, about 40 μm to about 200 μm, about 50 μm to about 150 about 60 μm to about 150 μm, about 70 μm to about 150 μm, about 80 μm to about 150 about or 90 μm to about 150 μm.

In some embodiments, including any of the foregoing embodiments, the thickness of the solid-state separator layer is about 10 μm to about 200 μm.

In some embodiments, including any of the foregoing embodiments, the thickness of the solid-state separator layer is about 20 μm.

In some embodiments, the thickness of the solid-state separator layer is about 10 μm to about 100 μm, 10 μm to about 90 μm, 10 μm to about 80 μm, 10 μm to about 70 μm, 10 μm to about 60 μm, 10 μm to about 50, 10 μm to about 40 urn, or 10 μm to about 30

a

In some embodiments, including any of the foregoing embodiments, the thickness of the positive electrode current collector or negative electrode current collector is about 5 μm to about 200 μm.

In some embodiments, including any of the foregoing embodiments, the thickness of the positive electrode current collector or negative electrode current collector is about 10 μm.

In some embodiments, including any of the foregoing embodiments, the thickness of the positive electrode current collector or negative electrode current collector is about 5 μm to about 100 μm, about 5 μm to about 90 μm, about 5 μm to about 80 μm, about 5 μm to about 70 μm, about 5 μm to about 60 μm, about 5 μm to about 50 μm, about 5 μm to about 40 μm, about 5 μm to about 30 μm, about 5 μm to about 20 μm.

In some embodiments, including any of the foregoing embodiments, diameter, length or width of the solid-state electrolyte is greater than the diameter, length or width of the lithium metal negative electrode.

In some embodiments, including any of the foregoing embodiments, diameter, length or width of the solid-state electrolyte is greater than the diameter, length or width of the positive electrode.

In some embodiments, including any of the foregoing embodiments, diameter, length or width of the solid-state electrolyte is greater than the diameter, length or width of the negative electrode.

In some embodiments, including any of the foregoing embodiments, the solid-state electrolyte has raised edges.

In some embodiments, including any of the foregoing embodiments, the solid-state electrolyte has tapered edges.

In some embodiments, including any of the foregoing embodiments, the solid-state electrolyte has coated edges. In some embodiments, the coated edges comprise a coating selected from parylene, polypropylene, polyethylene, alumina, Al₂O₃, ZrO₂, TiO₂, SiO₂, a binary oxide, La₂Zr₂O₇, a lithium carbonate species, and a glass, wherein the glass is selected from SiO₂—B₂O₃, or Al₂O₃. In some embodiments, the coating is parylene. In some embodiments, the coating is polypropylene. In some embodiments, the coating is polyethylene. In some embodiments, the coating is alumina. In some embodiments, the coating is Al₂O₃. In some embodiments, the coating is ZrO₂. In some embodiments, the coating is TiO₂. In some embodiments, the coating is SiO₂. In some embodiments, the coating is a binary oxide. In some embodiments, the coating is La₂Zr₂O₇. In some embodiments, the coating is a lithium carbonate species. In some embodiments, the coating is a glass.

In some embodiments, including any of the foregoing embodiments, the positive or negative electrode current collector is made of a material selected from the group consisting of carbon (C)-coated nickel (Ni), nickel (Ni), copper (Cu), aluminum (Al), stainless steel, Palladium (Pd), and Platinum (Pt). In some embodiments, the material is carbon (C)-coated nickel (Ni). In some embodiments, the material is nickel (Ni). In some embodiments, the material is copper (Cu). In some embodiments, the material is aluminum (Al). In some embodiments, the material is stainless steel. In some embodiments, the material is Palladium (Pd). In some embodiments, the material is Platinum (Pt).

In some embodiments, including any of the foregoing embodiments, the positive electrode current collector is an Al metal current collector.

In some embodiments, including any of the foregoing embodiments, the positive electrode current collector is a C-coated Ni metal current collector.

In another embodiment, set forth herein is a rechargeable battery comprising any of the electrochemical cells set forth herein.

In another embodiment, set forth herein is an electric vehicle comprising the rechargeable battery set forth herein.

In another embodiment, set forth herein is a process for making an electrochemical cell, comprising:
providing a bilayer solid-state electrolyte having a first layer comprising a sulfide and a second layer comprising a lithium phosphorus sulfur halide on a substrate;
   wherein the second layer is in direct contact with the substrate;
providing a first seal around and in contact with the bilayer solid-state electrolyte;
   wherein the seal covers the edges of the solid-state electrolyte;
providing a positive electrode comprising a liquid electrolyte on top of the solid-state electrolyte;
pressing the positive electrode comprising a liquid electrolyte onto the solid-state electrolyte and first seal;
applying a second seal around the first seal; and
applying at least 3 pounds per square inch (PSI) to the electrochemical cell.

In some examples, including any of the foregoing, the halide is iodide.

In some examples, including any of the foregoing, the lithium phosphorus sulfur halide is lithium phosphorus sulfur iodide.

In another embodiment, set forth herein is a process for making an electrochemical cell, comprising:
providing a bilayer solid-state electrolyte having a first layer comprising a sulfide and a second layer comprising a lithium phosphorus sulfur iodide on a substrate;
   wherein the second layer is in direct contact with the substrate;
providing a first seal around and in contact with the bilayer solid-state electrolyte;
   wherein the seal covers the edges of the solid-state electrolyte;
providing a positive electrode comprising a liquid electrolyte on top of the solid-state electrolyte;
pressing the positive electrode comprising a liquid electrolyte onto the solid-state electrolyte and first seal;
applying a second seal around the first seal; and
applying at least 3 pounds per square inch (PSI) to the electrochemical cell.

In some embodiments of the process, the sulfide in the first layer is a lithium silicon sulfide.

In some embodiments, the substrate is heated to at least 50° C.

In some embodiments, including any of the foregoing embodiments, prior to providing a positive electrode comprising a liquid electrolyte on top of the solid-state electrolyte, the process comprises providing a gel electrolyte on top of the solid-state electrolyte.

In some embodiments, including any of the foregoing embodiments, the first seal is made of PIB.

In some embodiments, including any of the foregoing embodiments, the second seal is made of polyether ether ketone (PEEK).

In some embodiments, including any of the foregoing embodiments, the substrate is a negative electrode current collector.

In some embodiments, including any of the foregoing embodiments, the first layer is in direct contact with the positive electrode.

In some embodiments, including any of the foregoing embodiments, applying a seal, comprising flowing the second seal.

In some embodiments, including any of the foregoing embodiments, the seal material is impermeable to the liquid electrolyte and seals the interface between the positive electrode current collector and the positive electrode and the interface between the positive electrode and the first layer of the bilayer solid-state electrolyte.

In some embodiments, a cell, such as an electrochemical cell, may comprise one or more seal materials. In some embodiments, a cell comprises at least one seal material. In some embodiments, a cell comprises at least two seal materials. In some cases, a cell comprises at least two different seal materials.

### VI. Electrochemical Cells & Seal Architectures

In some examples, set forth herein is a half-cell.

In some examples, set forth herein is a full-cell.

In some examples, set forth herein is a symmetric-cell.

In some examples, the electrochemical cell is substantially as shown in FIG. 1A.

FIG. 1A is not drawn to scale. In FIG. 1A, electrochemical cell 100 is illustrated in a cross-sectional view. Electrochemical cell 100 includes a solid-state electrolyte, 101, which is positioned on top of a positive electrode, 102, which is positioned on top of a positive electrode current collector, 104. The solid-state electrolyte may include any solid-state electrolytes set forth herein. In some non-limiting examples, the solid-state electrolyte, 101, has a thickness (i.e., height in the electrochemical stack) from about 1 μm to about 150 μm. In some of these examples, the solid-state electrolyte, 101, has a lateral dimension (i.e., length or width for a square or rectangular shaped form factor) from about 1 cm to about 30 cm. The positive electrode may include any positive electrode active materials set forth herein. In the positive electrode, 102, is either a liquid electrolyte or a gel electrolyte, or both. In some non-limiting embodiments, the positive electrode, 102, has a thickness from about 20 μm to about 250 μm. In some of these examples, the positive electrode, 102, has a lateral dimension (i.e., length or width for a square or rectangular shaped form factor) from about 1 cm to about 30 cm. Forming a seal between the current collector, 104, and the solid-state electrolyte, 101, is a face seal, 103. In some non-limiting embodiments, the face seal, 103, has a thickness from about 20 μm to about 250 μm. In some of these examples, the face seal, 103, has a lateral dimension (i.e., length or width for a square or rectangular shaped form factor) from about 0.5 mm to about 50 mm. Face seal, 103, bonds to the face of current collector, 104, and bonds to the face of the solid-state electrolyte, 101. In some non-limiting embodiments, the current collector, 104, has a thickness from about 2 μm to about 25 μm. In some of these examples, the current collector, 104, has a lateral dimension (i.e., length or width for a square or rectangular shaped form factor) from about 1 cm to about 35 cm. The seal may also contact side-edge of positive electrode, 102. The seal, 103, is selected from a circular-shaped seal, a ring-shaped seal, a rectangular-shaped seal or a square-shaped seal, depending on the actual form factor of the electrochemical cell, 100. In some non-limiting embodiments, the electrochemical cell, 100, has a thickness from about 1 cm to about 35 μm. In a coin-cell format, the seal, 103, is a circular-shaped seal or ring-shaped seal. In a pouch-cell format, the seal, 103, is a rectangular-shaped seal or square-shaped seal. Seal, 103, seals the liquid electrolyte or gel electrolyte, or both, in the positive electrode, 102. Solid-state electrolyte, 101, is impermeable to the liquid electrolyte or gel electrolyte, or both, in the positive electrode. In the electrochemical cell, 100, the liquid electrolyte or gel electrolyte, or both, in the positive electrode is prevented from contacting the side of solid-electrolyte, 101, indicated by side A, which is opposite from the side of solid-electrolyte, 101 contacting the positive electrode, 102. In some examples, side A, has a layer of Li metal on it.

In some examples, electrochemical cell, 100, can be a full-cell, which includes a negative electrode, 105, and a negative electrode current collector (not shown). In some examples, the negative electrode, 105, is a lithium metal negative electrode. As the full-cell charges and discharges, the thickness and cross-sectional length of the negative electrode, 105, will vary. In some non-limiting embodiments, the negative electrode, 105, has a thickness from about 0.001 μm to about 25 μm. When the negative electrode, 105, is a lithium metal negative electrode, the thickness changes expands and contracts as the electrochemical cell, 100, charges and discharges. In some of these examples, the negative electrode, 105, has a lateral dimension (i.e., length or width for a square or rectangular shaped form factor or width for a square or rectangular shaped form factor) from about 1 cm to about 30 cm.

The cross-sectional length of electrochemical cell, 100, is shown as L₁₀₀.

The cross-sectional length of solid-state electrolyte, 101, is shown as L₁₀₁. In a coin-cell format, L₁₀₁ is the diameter of a circular-shaped seal or ring-shaped solid-state electrolyte. In a pouch-cell format, L₁₀₁ is the length or width of a rectangular-shaped seal or square-shaped solid-state electrolyte.

The cross-sectional length of positive electrode, 102, is shown as L₁₀₂. In a coin-cell format, L₁₀₂ is the diameter of a circular-shaped seal or ring-shaped seal. In a pouch-cell format, L₁₀₁ is the length or width of a rectangular-shaped seal or square-shaped seal.

The cross-sectional width of seal, 103, is shown as L₁₀₃. In a coin-cell format, L₁₀₃ is the width of a circular-shaped seal or ring-shaped seal. In a pouch-cell format, L₁₀₃ is the length or width of a rectangular-shaped seal or square-shaped seal. The width is not to be confused with the diameter of the seal, 103, in a coin-cell format. For example, when a coin-cell format is employed, the diameter of seal, 103, is the sum of the length of the positive electrode, L₁₀₂, plus the width of seal, L₁₀₃.

In certain examples, the length of the solid-state electrolyte, 101, is greater than the length of the negative electrode, 105. In certain examples, the length of the negative electrode, 105, is greater than the length of positive electrode, 102. In certain examples, the length of the solid-state electrolyte, 101, is greater than both the length of the negative electrode, 105, and greater than the length of positive electrode, 102.

The cross-sectional length of positive electrode current collector, 104, is shown as L₁₀₄.

The cross-sectional thickness of electrochemical cell, 100, is shown as H_{cell}. The cross-sectional thickness of solid-state electrolyte, 101, is shown as H₁₀₁. The cross-sectional thickness of positive electrode, 102, is shown as H_{102/103}. The cross-sectional thickness of seal, 103, is shown as H_{102/103}. The cross-sectional thickness of positive electrode current collector, 104, is shown as H₁₀₄.

In some examples, seal, 103, extends beyond the edge of the solid-state electrolyte, 101, and/or the positive electrode current collector, 104, by an overlapping length indicated by L_{E}. In some examples, this amount of overlapping length, L_{E}, is 1, 2, 3, 4, 5, 6, 7, 8, 9, or 10 μm. In some examples, this amount of overlapping length, L_{E}, is 10, 20, 30, 40, 50, 60, 70, 80, 90, or 100 μm. In some examples, this amount of overlapping length, L_{E}, is 0.1, 0.2, 0.3, 0.4, 0.5, 0.6, 0.7, 0.8, 0.9, or 1.0 cm. In some examples, this amount of overlapping length, L_{E}, is from about 50 μm to 1 cm.

In some examples, L₁₀₁ is approximately equal to L₁₀₄. In the face seal format shown in FIG. 1A, H₁₀₂ is approximately equal to H₁₀₃.

In some examples, the diameter of the solid-state electrolyte, L₁₀₁, is greater than the diameter of the negative electrode (e.g., Li metal), L₁₀₅. In some examples, the diameter of the solid-state electrolyte, L₁₀₁, is greater than the diameter of the negative electrode (e.g., Li metal), L₁₀₅, by 1 μm, 2 μm, 3 μm, 4 μm, 5 μm, μm, 6 μm, 7 μm, 8 μm, 9 μm, 10 μm, 11 μm, 12 μm, 13 μm, 14 μm, 15 μm, 16 μm, 17 μm, 18 μm, 19 μm, 20 μm, 21 μm, 22 μm, 23 μm, 24 μm, 25 μm, 26 μm, 27 μm, 28 μm, 29 μm, 30 μm, 31 μm, 32 nm, 33 μm, 34 μm, 35 μm, 36 μm, 37 μm, 38 μm, 39 μm, 40 μm, 41 μm, 42 μm, 43 μm, 44 nm, 45 μm, 46 μm, 47 μm, 48 μm, 49 μm, 50 μm, 51 μm, 52 μm, 53 μm, 54 μm, 55 μm, 56 nm, 57 μm, 58 μm, 59 μm, 60 μm, 61 μm, 62 μm, 63 μm, 64 μm, 65 μm, 66 μm, 67 μm, 68 nm, 69 μm, 70 μm, 71 μm, 72 μm, 73 μm, 74 μm, 75 μm, 76 μm, 77 μm, 78 μm, 79 μm, 80 nm, 81 μm, 82 μm, 83 μm, 84 μm, 85 μm, 86 μm, 87 μm, 88 μm, 89 μm, 90 μm, 91 μm, 92 nm, 93 μm, 94 μm, 95 μm, 96 μm, 97 μm, 98 μm, 99 μm, or 100 μm. In some examples, the diameter of the solid-state electrolyte, L₁₀₁, is greater than the diameter of the negative electrode (e.g., Li metal), L₁₀₅, by 100 nm, 200 nm, 300 nm, 400 nm, 500 nm, 600 nm, 700 nm, 800 μm, 900 μm, or 1000 μm. In some examples, the diameter of the solid-state electrolyte, L₁₀₁, is greater than the diameter of the negative electrode (e.g., Li metal), L₁₀₅, by 0.1 mm, 0.2 mm, 0.3 mm, 0.4 mm, 0.5 mm, 0.6 mm, 0.7 mm, 0.8 mm, 0.9 mm, or 1.0 mm. In some examples, the diameter of the solid-state electrolyte, L₁₀₁, is greater than the diameter of the negative electrode (e.g., Li metal), L₁₀₅, by 0.1 cm, 0.2 cm, 0.3 cm, 0.4 cm, 0.5 cm, 0.6 cm, 0.7 cm, 0.8 cm, 0.9 cm, or 1.0 cm.

In some examples, the diameter of the solid-state electrolyte, L₁₀₁, is greater than the diameter of the positive electrode, L₁₀₂. In some examples, the diameter of the solid-state electrolyte, L₁₀₁, is greater than the diameter of the positive electrode, Liu, by 1 μm, 2 μm, 3 μm, 4 μm, 5 μm, 6 μm, 7 μm, 8 μm, 9 μm, 10 μm, 11 μm, 12 μm, 13 μm, 14 μm, 15 μm, 16 nm, 17 μm, 18 μm, 19 μm, 20 μm, 21 nm, 22 μm, 23 μm, 24 μm, 25 μm, 26 μm, 27 μm, 28 nm, 29 μm, 30 μm, 31 μm, 32 μm, 33 nm, 34 μm, 35 μm, 36 μm, 37 μm, 38 μm, 39 μm, 40 nm, 41 μm, 42 μm, 43 μm, 44 μm, 45 nm, 46 μm, 47 μm, 48 μm, 49 μm, 50 μm, 51 μm, 52 nm, 53 μm, 54 μm, 55 μm, 56 μm, 57 nm, 58 μm, 59 μm, 60 μm, 61 μm, 62 μm, 63 μm, 64 nm, 65 μm, 66 μm, 67 μm, 68 μm, 69 nm, 70 μm, 71 μm, 72 μm, 73 μm, 74 μm, 75 μm, 76 nm, 77 μm, 78 μm, 79 μm, 80 μm, 81 nm, 82 μm, 83 μm, 84 μm, 85 μm, 86 μm, 87 μm, 88 nm, 89 μm, 90 μm, 91 μm, 92 μm, 93 nm, 94 μm, 95 μm, 96 μm, 97 μm, 98 μm, 99 μm, or 100 μm. In some examples, the diameter of the solid-state electrolyte, L₁₀₁, is greater than the diameter of the positive electrode, L₁₀₂, by 100 μm, 200 μm, 300 μm, 400 μm, 500 μm, 600 μm, 700 μm, 800 μm, 900 μm, or 1000 nm. In some examples, the diameter of the solid-state electrolyte, L₁₀₁, is greater than the diameter of the positive electrode, L₁₀₂, by 0.1 mm, 0.2 mm, 0.3 mm, 0.4 mm, 0.5 mm, 0.6 mm, 0.7 mm, 0.8 mm, 0.9 mm, or 1.0 mm. In some examples, the diameter of the solid-state electrolyte, L₁₀₁, is greater than the diameter of the positive electrode, L₁₀₂, by 0.1 cm, 0.2 cm, 0.3 cm, 0.4 cm, 0.5 cm, 0.6 cm, 0.7 cm, 0.8 cm, 0.9 cm, 1.0 cm, 1.1 cm, 1.2 cm, 1.3 cm, 1.4 cm, 1.5 cm, 1.6 cm, 1.7 cm, 1.8 cm, 1.9 cm, or 2.0 cm. In some examples, the diameter of the solid-state electrolyte, L₁₀₁, is greater than the diameter of the negative electrode, L₁₀₅.

In some examples, the diameter of the solid-state electrolyte, L₁₀₁, is greater than either the diameter of the negative electrode, L₁₀₅, or the diameter of the positive electrode, Liu.

In some examples, the rectangular or square width of the solid-state electrolyte, L₁₀₁, is greater than either the rectangular width or square width of the negative electrode, L₁₀₅, or of the positive electrode, L₁₀₂.

In some examples, the rectangular or square width of the solid-state electrolyte, L₁₀₁, is greater than the rectangular width or square width of the negative electrode, L₁₀₅.

In some examples, the rectangular or square width of the solid-state electrolyte, L₁₀₁, is greater than the rectangular width or square width of the positive electrode, Liu

In some examples, L₁₀₁ is greater than L₁₀₂.

In some examples, L₁₀₁ is greater than L₁₀₅.

In some examples, L₁₀₁ is greater than both L₁₀₂ or L₁₀₅.

In some examples, the electrochemical cell is substantially as shown in FIG. 1B.

FIG. 1B is not drawn to scale. In FIG. 1B electrochemical cell 100 is illustrated in a cross-sectional view. Electrochemical cell, 100, includes a solid-state electrolyte, 101, which is positioned on top of a positive electrode, 102, which is positioned on top of a positive electrode current collector, 104. In FIG. 1B, these elements, 101, 102, 103, and 104, are shown as spaced apart so that double-sided arrows A, B, and C can indicate the points of contact between seal, 103, and elements, 101, 102, and 104. Forming a seal between the current collector, 104, and the solid-state electrolyte, 101, is a face seal, 103. The face of 103 bonds with the face of 101, the faces of which are indicated by the double-sided arrow, A. The face of 103 bonds with the face of 104, the faces of which are indicated by the double-sided arrow, B. The face seal also encloses the liquid electrolyte or gel electrolyte in the positive electrode, 102, and may form a bond from the side-edge of the seal, 103, to the side-edge of the positive electrode, 102. The side-edges are indicated by double-sided arrow, C.

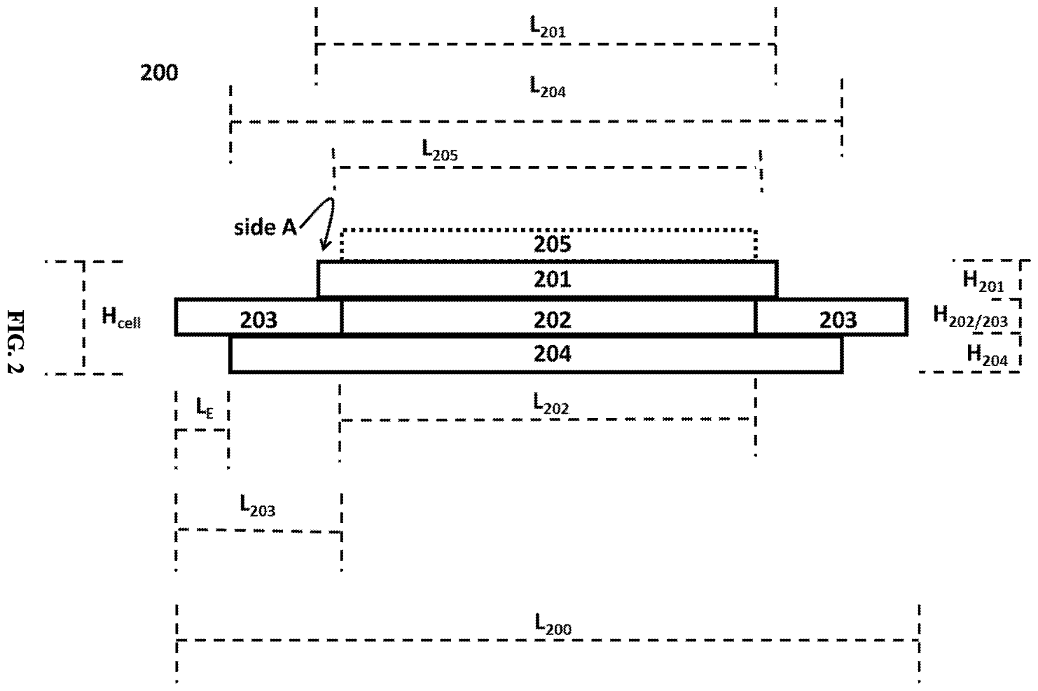

In some examples, the electrochemical cell is substantially as shown in FIG. 2.

FIG. 2 is not drawn to scale. In FIG. 2, electrochemical cell 200 is illustrated in a cross-sectional view. Electrochemical cell 200 includes a solid-state electrolyte, 201, which is positioned on top of a positive electrode, 202, which is positioned on top of a positive electrode current collector, 204. The solid-state electrolyte may include any solid-state electrolytes set forth herein. In some non-limiting examples, the solid-state electrolyte, 201, has a thickness (i.e., height in the electrochemical stack) from about 1 μm to about 150 μm. In some of these examples, the solid-state electrolyte, 201, has a lateral dimension (i.e., length or width for a square or rectangular shaped form factor) from about 1 cm to about 30 cm. The positive electrode may include any positive electrode active materials set forth herein. In the positive electrode, 202, is either a liquid electrolyte or a gel electrolyte, or both. In some non-limiting embodiments, the positive electrode, 202, has a thickness from about 20 μm to about 250 μm. In some of these examples, the positive electrode, 202, has a lateral dimension (i.e., length or width for a square or rectangular shaped form factor) from about 1 cm to about 30 cm. Forming a seal between the current collector, 204, and the solid-state electrolyte, 201, is a face seal, 203. In some non-limiting embodiments, the face seal, 203, has a thickness from about 20 μm to about 250 μm. In some of these examples, the face seal, 203, has a lateral dimension (i.e., length or width for a square or rectangular shaped form factor) from about 0.5 mm to about 50 mm. Face seal, 203, bonds to the face of current collector, 204, and bonds to the face of the solid-state electrolyte, 201. In some non-limiting embodiments, the current collector, 204, has a thickness from about 2 μm to about 25 μm. In some of these examples, the current collector, 204, has a lateral dimension (i.e., length or width for a square or rectangular shaped form factor) from about 1 cm to about 35 cm. The seal may also contact side-edge of positive electrode, 202. The seal, 203, is selected from a circular-shaped seal, a ring-shaped seal, a rectangular-shaped seal or a square-shaped seal, depending on the actual form factor of the electrochemical cell, 200. In a coin-cell format, the seal, 203, is a circular-shaped seal or ring-shaped seal. In a pouch-cell format, the seal, 203, is a rectangular-shaped seal or square-shaped seal. Seal, 203, seals the liquid electrolyte or gel electrolyte, or both, in the positive electrode, 202. Solid-state electrolyte, 201, is impermeable to the liquid electrolyte or gel electrolyte, or both, in the positive electrode. In the electrochemical cell, 200, the liquid electrolyte or gel electrolyte, or both, in the positive electrode is prevented from contacting the side of solid-electrolyte, 201, indicated by side A, which is opposite from the side of solid-electrolyte, 201 contacting the positive electrode, 202. In some examples, side A, has a layer of Li metal on it. In some examples, electrochemical cell, 200, can be a full-cell, which includes a negative electrode, 205, and a negative electrode current collector (not shown). In some examples, the negative electrode, 205, is a lithium metal negative electrode. As the full-cell charges and discharges, the thickness and cross-sectional length of the negative electrode, 205, will vary. In some non-limiting embodiments, the negative electrode, 205, has a thickness from about 0.001 μm to about 25 μm.

The cross-sectional length of electrochemical cell, 200, is shown as L₂₀₀.

The cross-sectional length of solid-state electrolyte, 201, is shown as UN. In a coin-cell format, UN is the diameter of a circular-shaped seal or ring-shaped solid-state electrolyte. In a pouch-cell format, L₂₀₁ is the length or width of a rectangular-shaped seal or square-shaped solid-state electrolyte.

The cross-sectional length of positive electrode, 202, is shown as L₂₀₂. In a coin-cell format, L₂₀₂ is the diameter of a circular-shaped seal or ring-shaped seal. In a pouch-cell format, UN is the length or width of a rectangular-shaped seal or square-shaped seal.

The cross-sectional width of seal, 203, is shown as L₂₀₃. In a coin-cell format, L₂₀₃ is the width of a circular-shaped seal or ring-shaped seal. In a pouch-cell format, L₂₀₃ is the length or width of a rectangular-shaped seal or square-shaped seal. The width is not to be confused with the diameter of the seal, 203, in a coin-cell format. For example, when a coin-cell format is employed, the diameter of seal, 203, is the sum of the length of the positive electrode, L₂₀₂, plus the width of seal, L₂₀₃.

The cross-sectional length of positive electrode current collector, 204, is shown as L₂₀₄.

The cross-sectional thickness of electrochemical cell, 200, is shown as Mew The cross-sectional thickness of solid-state electrolyte, 201, is shown as H₂₀₁. The cross-sectional thickness of positive electrode, 202, is shown as H_{202/203}. The cross-sectional thickness of seal, 203, is shown as H_{202/203}. The cross-sectional thickness of positive electrode current collector, 204, is shown as H₂₀₄.

In some examples, seal, 203, extends beyond the edge of the positive electrode current collector, 204, by an overlapping length indicated by L_{E}. In some examples, this amount of overlapping length, L_{E}, is 1, 2, 3, 4, 5, 6, 7, 8, 9, or 10 μm. In some examples, this amount of overlapping length, L_{E}, is 10, 20, 30, 40, 50, 60, 70, 80, 90, or 100 μm. In some examples, this amount of overlapping length, L_{E}, is 0.1, 0.2, 0.3, 0.4, 0.5, 0.6, 0.7, 0.8, 0.9, or 1.0 cm. In some examples, this amount of overlapping length, L_{E}, is from about 50 μm to 1 cm.

In some examples, Lap is substantially smaller than L₂₀₄. In the face seal format shown in FIG. 2, H₂₀₂ is approximately equal to H₂₀₃. In some examples, Lap is smaller than L₂₀₄ by a factor of 1×, 2×, 3×, 4×, 5×, 6×, 7×, 8×, 9×, or 10×.

In some examples, the diameter of the solid-state electrolyte, Lap, is greater than the diameter of the negative electrode (e.g., Li metal), L₂₀₅. In some examples, the diameter of the solid-state electrolyte, L₁₀₁, is greater than the diameter of the negative electrode (e.g., Li metal), L₂₀₅, by 1 μm, 2 μm, 3 μm, 4 μm, 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, 20 μm, 21 μm, 22 μm, 23 μm, 24 μm, 25 μm, 26 μm, 27 μm, 28 μm, 29 μm, 30 μm, 31 μm, 32 μm, 33 μm, 34 μm, 35 μm, 36 μm, 37 μm, 38 μm, 39 μm, 40 μm, 41 μm, 42 μm, 43 μm, 44 μm, 45 μm, 46 μm, 47 μm, 48 μm, 49 μm, 50 μm, 51 μm, 52 μm, 53 μm, 54 μm, 55 μm, 56 μm, 57 μm, 58 μm, 59 μm, 60 μm, 61 μm, 62 μm, 63 μm, 64 μm, 65 μm, 66 μm, 67 μm, 68 μm, 69 μm, 70 μm, 71 μm, 72 μm, 73 μm, 74 μm, 75 μm, 76 μm, 77 μm, 78 μm, 79 μm, 80 μm, 81 μm, 82 μm, 83 μm, 84 μm, 85 μm, 86 μm, 87 μm, 88 μm, 89 μm, 90 μm, 91 μm, 92 μm, 93 μm, 94 μm, 95 μm, 96 μm, 97 μm, 98 μm, 99 μm, or 100 μm. In some examples, the diameter of the solid-state electrolyte, L₁₀₁, is greater than the diameter of the negative electrode (e.g., Li metal), L₂₀₅, by 100 μm, 200 μm, 300 μm, 400 μm, 500 μm, 600 μm, 700 μm, 800 μm, 900 μm, or 1000 μm. In some examples, the diameter of the solid-state electrolyte, L₁₀₁, is greater than the diameter of the negative electrode (e.g., Li metal), L₂₀₅, by 0.1 mm, 0.2 mm, 0.3 mm, 0.4 mm, 0.5 mm, 0.6 mm, 0.7 mm, 0.8 mm, 0.9 mm, or 1.0 mm. In some examples, the diameter of the solid-state electrolyte, L₁₀₁, is greater than the diameter of the negative electrode (e.g., Li metal), L₂₀₅, by 0.1 cm, 0.2 cm, 0.3 cm, 0.4 cm, 0.5 cm, 0.6 cm, 0.7 cm, 0.8 cm, 0.9 cm, or 1.0 cm.

In some examples, the diameter of the solid-state electrolyte, Lap, is greater than the diameter of the positive electrode, L₂₀₂. In some examples, the diameter of the solid-state electrolyte, Lap, is greater than the diameter of the positive electrode, L₂₀₂, by 1 μm, 2 μm, 3 μm, 4 μm, 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, 20 μm, 21 μm, 22 μm, 23 μm, 24 μm, 25 μm, 26 μm, 27 μm, 28 μm, 29 μm, 30 μm, 31 μm, 32 μm, 33 μm, 34 μm, 35 μm, 36 μm, 37 μm, 38 μm, 39 μm, 40 μm, 41 μm, 42 μm, 43 μm, 44 μm, 45 μm, 46 μm, 47 μm, 48 μm, 49 μm, 50 μm, 51 μm, 52 μm, 53 μm, 54 μm, 55 μm, 56 μm, 57 μm, 58 μm, 59 μm, 60 μm, 61 μm, 62 μm, 63 μm, 64 μm, 65 μm, 66 μm, 67 μm, 68 μm, 69 μm, 70 μm, 71 μm, 72 μm, 73 μm, 74 μm, 75 μm, 76 μm, 77 μm, 78 μm, 79 μm, 80 μm, 81 μm, 82 μm, 83 μm, 84 μm, 85 μm, 86 μm, 87 μm, 88 μm, 89 μm, 90 μm, 91 μm, 92 μm, 93 μm, 94 μm, 95 μm, 96 μm, 97 μm, 98 μm, 99 μm, or 100 μm. In some examples, the diameter of the solid-state electrolyte, L₂₀₁, is greater than the diameter of the positive electrode, L₂₀₂, by 100 μm, 200 μm, 300 μm, 400 μm, 500 μm, 600 μm, 700 μm, 800 μm, 900 μm, or 1000 μm. In some examples, the diameter of the solid-state electrolyte, L₂₀₁, is greater than the diameter of the positive electrode, L₂₀₂, by 0.1 mm, 0.2 mm, 0.3 mm, 0.4 mm, 0.5 mm, 0.6 mm, 0.7 mm, 0.8 mm, 0.9 mm, or 1.0 mm. In some examples, the diameter of the solid-state electrolyte, UN, is greater than the diameter of the positive electrode, L₂₀₂, by 0.1 cm, 0.2 cm, 0.3 cm, 0.4 cm, 0.5 cm, 0.6 cm, 0.7 cm, 0.8 cm, 0.9 cm, 1.0 cm, 1.1 cm, 1.2 cm, 1.3 cm, 1.4 cm, 1.5 cm, 1.6 cm, 1.7 cm, 1.8 cm, 1.9 cm, or 2.0 cm.

In some examples, the diameter of the solid-state electrolyte, UN, is greater than the diameter of the negative electrode, L₂₀₅. In some examples, the diameter of the solid-state electrolyte, L₂₀₁, is greater than the diameter of the negative electrode, L₂₀₅, by 1 μm, 2 μm, 3 μm, 4 μm, 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, 20 μm, 21 μm, 22 μm, 23 μm, 24 μm, 25 μm, 26 μm, 27 μm, 28 μm, 29 μm, 30 μm, 31 μm, 32 μm, 33 μm, 34 μm, 35 μm, 36 μm, 37 μm, 38 μm, 39 μm, 40 μm, 41 μm, 42 μm, 43 μm, 44 μm, 45 μm, 46 μm, 47 μm, 48 μm, 49 μm, 50 μm, 51 μm, 52 μm, 53 μm, 54 μm, 55 μm, 56 μm, 57 μm, 58 μm, 59 μm, 60 μm, 61 μm, 62 μm, 63 μm, 64 μm, 65 μm, 66 μm, 67 μm, 68 μm, 69 μm, 70 μm, 71 μm, 72 μm, 73 μm, 74 μm, 75 μm, 76 μm, 77 μm, 78 μm, 79 μm, 80 μm, 81 μm, 82 μm, 83 μm, 84 μm, 85 μm, 86 μm, 87 μm, 88 μm, 89 μm, 90 μm, 91 μm, 92 μm, 93 μm, 94 μm, 95 μm, 96 μm, 97 μm, 98 μm, 99 μm, or 100 μm. In some examples, the diameter of the solid-state electrolyte, UN, is greater than the diameter of the negative electrode, L₂₀₅ by 100 μm, 200 μm, 300 μm, 400 μm, 500 μm, 600 μm, 700 μm, 800 μm, 900 μm, or 1000 μm. In some examples, the diameter of the solid-state electrolyte, UN, is greater than the diameter of the positive electrode, L₂₀₂, by 0.1 mm, 0.2 mm, 0.3 mm, 0.4 mm, 0.5 mm, 0.6 mm, 0.7 mm, 0.8 mm, 0.9 mm, or 1.0 mm. In some examples, the diameter of the solid-state electrolyte, UN, is greater than the diameter of the negative electrode, L₂₀₅, by 0.1 cm, 0.2 cm, 0.3 cm, 0.4 cm, 0.5 cm, 0.6 cm, 0.7 cm, 0.8 cm, 0.9 cm, 1.0 cm, 1.1 cm, 1.2 cm, 1.3 cm, 1.4 cm, 1.5 cm, 1.6 cm, 1.7 cm, 1.8 cm, 1.9 cm, or 2.0 cm.

In some examples, the diameter of the solid-state electrolyte, L₂₀₁, is greater than either the diameter of the negative electrode, L₂₀₅, or the diameter of the positive electrode, L₂₀₂.

In some examples, the L₂₀₄ is larger than any one of L₂₀₁, L₂₀₂, or L₂₀₅

In some examples, the rectangular or square width of the solid-state electrolyte, UN, is greater than either the rectangular width or square width of the negative electrode, L₂₀₅, or of the positive electrode, L₂₀₂.

In some examples, the rectangular or square width of the solid-state electrolyte, UN, is greater than the rectangular width or square width of the negative electrode, L₂₀₅.

In some examples, the rectangular or square width of the solid-state electrolyte, UN, is greater than the rectangular width or square width of the positive electrode, L₂₀₂.

In some examples, UN is greater than L₂₀₂.

In some examples, UN is greater than L₂₀₅.

In some examples, UN is greater than both L₂₀₂ or L₂₀₅.

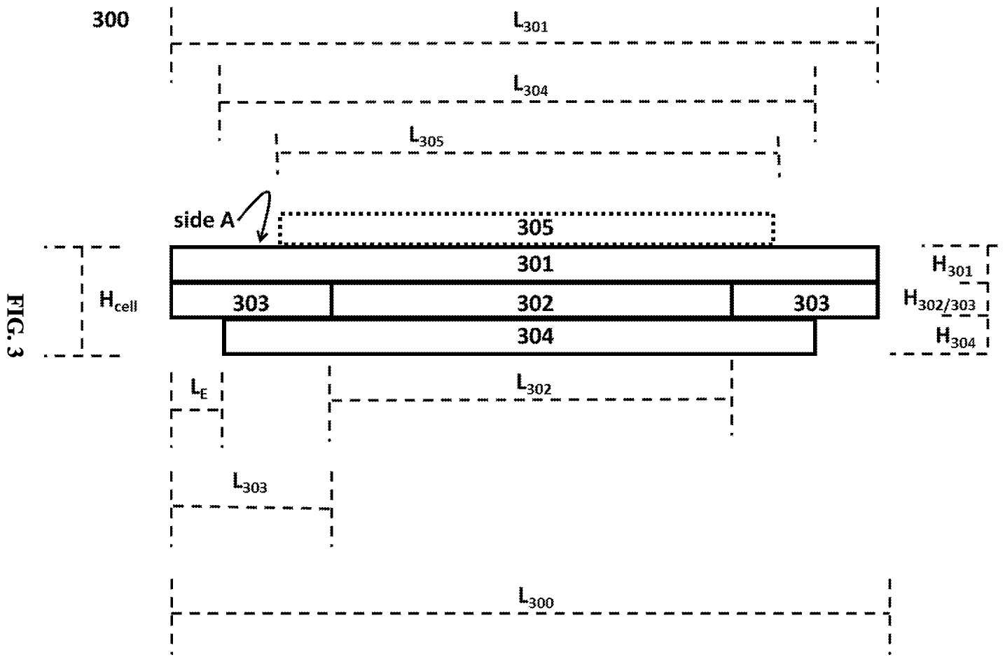

In some examples, the electrochemical cell is substantially as shown in FIG. 3.

FIG. 3 is not drawn to scale. In FIG. 3, electrochemical cell 300 is illustrated in a cross-sectional view. Electrochemical cell 300 includes a solid-state electrolyte, 301, which is positioned on top of a positive electrode, 302, which is positioned on top of a positive electrode current collector, 304. The solid-state electrolyte may include any solid-state electrolytes set forth herein. The positive electrode may include any positive electrode active materials set forth herein. In the positive electrode, 302, is either a liquid electrolyte or a gel electrolyte, or both. Forming a seal between the current collector, 304, and the solid-state electrolyte, 301, is a face seal, 303. Face seal, 303, bonds to the face of current collector, 304, and bonds to the face of the solid-state electrolyte, 301. The seal may also contact side-edge of positive electrode, 302. The seal, 303, is selected from a circular-shaped seal, a ring-shaped seal, a rectangular-shaped seal or a square-shaped seal, depending on the actual form factor of the electrochemical cell, 300. In a coin-cell format, the seal, 303, is a circular-shaped seal or ring-shaped seal. In a pouch-cell format, the seal, 303, is a rectangular-shaped seal or square-shaped seal. Seal, 303, seals the liquid electrolyte or gel electrolyte, or both, in the positive electrode, 302. Solid-state electrolyte, 301, is impermeable to the liquid electrolyte or gel electrolyte, or both, in the positive electrode. In the electrochemical cell, 300, the liquid electrolyte or gel electrolyte, or both, in the positive electrode is prevented from contacting the side of solid-electrolyte, 301, indicated by side A, which is opposite from the side of solid-electrolyte, 301 contacting the positive electrode, 302. In some examples, side A, has a layer of Li metal on it.

In some examples, electrochemical cell, 300, can be a full-cell, which includes a negative electrode, 305, and a negative electrode current collector (not shown). In some examples, the negative electrode, 305, is a lithium metal negative electrode. As the full-cell charges and discharges, the thickness and cross-sectional length of the negative electrode, 305, will vary.

The cross-sectional length of electrochemical cell, 300, is shown as L₃₀₀.

The cross-sectional length of solid-state electrolyte, 301, is shown as L₃₀₁. In a coin-cell format, L₃₀₁ is the diameter of a circular-shaped seal or ring-shaped solid-state electrolyte. In a pouch-cell format, L₃₀₁ is the length or width of a rectangular-shaped seal or square-shaped solid-state electrolyte.

The cross-sectional length of positive electrode, 302, is shown as L₃₀₂. In a coin-cell format, L₃₀₂ is the diameter of a circular-shaped seal or ring-shaped seal. In a pouch-cell format, L₃₀₁ is the length or width of a rectangular-shaped seal or square-shaped seal.

The cross-sectional width of seal, 303, is shown as L₃₀₃. In a coin-cell format, L₃₀₃ is the width of a circular-shaped seal or ring-shaped seal. In a pouch-cell format, L₃₀₃ is the length or width of a rectangular-shaped seal or square-shaped seal. The width is not to be confused with the diameter of the seal, 303, in a coin-cell format. For example, when a coin-cell format is employed, the diameter of seal, 303, is the sum of the length of the positive electrode, L₃₀₂, plus the width of seal, L₃₀₃.

The cross-sectional length of positive electrode current collector, 304, is shown as L₃₀₄.

The cross-sectional thickness of electrochemical cell, 300, is shown as H_{cell}. The cross-sectional thickness of solid-state electrolyte, 301, is shown as H₃₀₁. The cross-sectional thickness of positive electrode, 302, is shown as H_{302/303}. The cross-sectional thickness of seal, 303, is shown as H_{302/303}. The cross-sectional thickness of positive electrode current collector, 304, is shown as H₃₀₄.

In some examples, seal, 303, extends beyond the edge of the positive electrode current collector, 304, by an overlapping length indicated by L_{E}. In some examples, this amount of overlapping length, L_{E}, is 1, 2, 3, 4, 5, 6, 7, 8, 9, or 10 μm. In some examples, this amount of overlapping length, L_{E}, is 0 μm. In some examples, this amount of overlapping length, L_{E}, is as close to 0 μm as possible.

In some examples, L₃₀₁ is approximately the sum of L₃₀₂ and L₃₀₃. In this configuration, the length of the solid-state electrolyte, 301, is the length of the seal, 303, and positive electrode, 302.

In some examples, L₃₀₁ is substantially larger than L₃₀₄. In some examples, L₃₀₁ is larger than L₃₀₄ by a factor of 1×, 2×, 3×, 4×, 5×, 6×, 7×, 8×, 9×, or 10×. In the face seal format shown in FIG. 3, H₃₀₂ is approximately equal to H₃₀₃.

In some examples, the diameter of the solid-state electrolyte, L₃₀₁, is greater than the diameter of the negative electrode (e.g., Li metal), L₃₀₅. In some examples, the diameter of the solid-state electrolyte, L₃₀₁, is greater than the diameter of the negative electrode (e.g., Li metal), L₃₀₅, by 1 μm, 2 μm, 3 μm, 4 μm, 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, 20 μm, 21 μm, 22 μm, 23 μm, 24 μm, 25 μm, 26 μm, 27 μm, 28 μm, 29 μm, 30 μm, 31 μm, 32 μm, 33 μm, 34 μm, 35 μm, 36 μm, 37 μm, 38 μm, 39 μm, 40 μm, 41 μm, 42 μm, 43 μm, 44 μm, 45 μm, 46 μm, 47 μm, 48 μm, 49 μm, 50 μm, 51 μm, 52 μm, 53 μm, 54 μm, 55 μm, 56 μm, 57 μm, 58 μm, 59 μm, 60 μm, 61 μm, 62 μm, 63 μm, 64 μm, 65 μm, 66 μm, 67 μm, 68 μm, 69 μm, 70 μm, 71 μm, 72 μm, 73 μm, 74 μm, 75 μm, 76 μm, 77 μm, 78 μm, 79 μm, 80 μm, 81 μm, 82 μm, 83 μm, 84 μm, 85 μm, 86 μm, 87 μm, 88 μm, 89 μm, 90 μm, 91 μm, 92 μm, 93 μm, 94 μm, 95 μm, 96 μm, 97 μm, 98 μm, 99 μm, or 100 μm. In some examples, the diameter of the solid-state electrolyte, L₃₀₁, is greater than the diameter of the negative electrode (e.g., Li metal), L₃₀₅, by 100 μm, 200 μm, 300 μm, 400 μm, 500 μm, 600 μm, 700 μm, 800 μm, 900 μm, or 1000 μm. In some examples, the diameter of the solid-state electrolyte, L₃₀₁, is greater than the diameter of the positive electrode, L₂₀₂, by 0.1 mm, 0.2 mm, 0.3 mm, 0.4 mm, 0.5 mm, 0.6 mm, 0.7 mm, 0.8 mm, 0.9 mm, or 1.0 mm. In some examples, the diameter of the solid-state electrolyte, L₃₀₁, is greater than the diameter of the negative electrode (e.g., Li metal), L₃₀₅, by 0.1 cm, 0.2 cm, 0.3 cm, 0.4 cm, 0.5 cm, 0.6 cm, 0.7 cm, 0.8 cm, 0.9 cm, or 1.0 cm.

In some examples, the diameter of the solid-state electrolyte, L₃₀₁, is greater than the diameter of the positive electrode, L₃₀₂. In some examples, the diameter of the solid-state electrolyte, L₃₀₁, is greater than the diameter of the positive electrode, L₃₀₂, by 1 μm, 2 μm, 3 μm, 4 μm, 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, 20 μm, 21 μm, 22 μm, 23 μm, 24 μm, 25 μm, 26 μm, 27 μm, 28 μm, 29 μm, 30 μm, 31 μm, 32 μm, 33 μm, 34 μm, 35 μm, 36 μm, 37 μm, 38 μm, 39 μm, 40 μm, 41 μm, 42 μm, 43 μm, 44 μm, 45 μm, 46 μm, 47 μm, 48 μm, 49 μm, 50 μm, 51 μm, 52 μm, 53 μm, 54 μm, 55 μm, 56 μm, 57 μm, 58 μm, 59 μm, 60 μm, 61 μm, 62 μm, 63 μm, 64 μm, 65 μm, 66 μm, 67 μm, 68 μm, 69 μm, 70 μm, 71 μm, 72 μm, 73 μm, 74 μm, 75 μm, 76 μm, 77 μm, 78 μm, 79 μm, 80 μm, 81 μm, 82 μm, 83 μm, 84 μm, 85 μm, 86 μm, 87 μm, 88 μm, 89 μm, 90 μm, 91 μm, 92 μm, 93 μm, 94 μm, 95 μm, 96 μm, 97 μm, 98 μm, 99 μm, or 100 μm. In some examples, the diameter of the solid-state electrolyte, L₃₀₁, is greater than the diameter of the positive electrode, L₃₀₂, by 100 μm, 200 μm, 300 μm, 400 μm, 500 μm, 600 μm, 700 μm, 800 μm, 900 μm, or 1000 μm. In some examples, the diameter of the solid-state electrolyte, L₃₀₁, is greater than the diameter of the positive electrode, L₃₀₂, by 0.1 mm, 0.2 mm, 0.3 mm, 0.4 mm, 0.5 mm, 0.6 mm, 0.7 mm, 0.8 mm, 0.9 mm, or 1.0 mm. In some examples, the diameter of the solid-state electrolyte, L₃₀₁, is greater than the diameter of the positive electrode, L₃₀₂, by 0.1 cm, 0.2 cm, 0.3 cm, 0.4 cm, 0.5 cm, 0.6 cm, 0.7 cm, 0.8 cm, 0.9 cm, 1.0 cm, 1.1 cm, 1.2 cm, 1.3 cm, 1.4 cm, 1.5 cm, 1.6 cm, 1.7 cm, 1.8 cm, 1.9 cm, or 2.0 cm.

In some examples, the diameter of the solid-state electrolyte, L₃₀₁, is greater than the diameter of the negative electrode, L₃₀₅.

In some examples, the diameter of the solid-state electrolyte, L₃₀₁, is greater than either the diameter of the negative electrode, L₃₀₅, or the diameter of the positive electrode, L₃₀₂.

In some examples, the L₃₀₄ is larger than any one of L₃₀₁, L₃₀₂, or L₃₀₅

In some examples, the rectangular or square width of the solid-state electrolyte, L₃₀₁, is greater than either the rectangular width or square width of the negative electrode, L₃₀₅, or of the positive electrode, L₃₀₂.

In some examples, the rectangular or square width of the solid-state electrolyte, L₃₀₁, is greater than the rectangular width or square width of the negative electrode, L₃₀₅.

In some examples, the rectangular or square width of the solid-state electrolyte, L₃₀₁, is greater than the rectangular width or square width of the positive electrode, L₃₀₂.

In some examples, L₃₀₁ is greater than L₃₀₂.

In some examples, L₃₀₁ is greater than L₃₀₅.

In some examples, L₃₀₁ is greater than both L₃₀₂ or L₃₀₅.

In some examples, the electrochemical cell is substantially as shown in FIG. 4A.

FIG. 4A is not drawn to scale. In FIG. 4A, electrochemical cell 400 is illustrated in a cross-sectional view. Electrochemical cell 400 includes a solid-state electrolyte, 401, which is positioned on top of a positive electrode, 402, which is positioned on top of a positive electrode current collector, 404. The solid-state electrolyte may include any solid-state electrolytes set forth herein. In some non-limiting examples, the solid-state electrolyte, 401, has a thickness (i.e., height in the electrochemical stack) from about 1 μm to about 150 μm. In some of these examples, the solid-state electrolyte, 401, has a lateral dimension (i.e., length or width for a square or rectangular shaped form factor) from about 1 cm to about 30 cm. The positive electrode may include any positive electrode active materials set forth herein. In the positive electrode, 402, is either a liquid electrolyte or a gel electrolyte, or both. In some non-limiting embodiments, the positive electrode, 402, has a thickness from about 20 μm to about 250 μm. In some of these examples, the positive electrode, 402, has a lateral dimension (i.e., length or width for a square or rectangular shaped form factor) from about 1 cm to about 30 cm. Forming a seal between the current collector, 404, and the solid-state electrolyte, 401, is a perimeter seal, 403. In some non-limiting embodiments, the perimeter seal, 403, has a thickness from about 20 μm to about 250 μm. In some of these examples, the perimeter seal, 403, has a lateral dimension (i.e., length or width for a square or rectangular shaped form factor) from about 0.5 mm to about 50 mm. Perimeter seal, 403, bonds to the face of current collector, 404, and bonds to the side-edge of the solid-state electrolyte, 401. The seal may also contact side-edge of positive electrode, 402. The seal, 403, is selected from a circular-shaped seal, a ring-shaped seal, a rectangular-shaped seal or a square-shaped seal, depending on the actual form factor of the electrochemical cell, 400. In a coin-cell format, the seal, 403, is a circular-shaped seal or ring-shaped seal. In a pouch-cell format, the seal, 403, is a rectangular-shaped seal or square-shaped seal. Seal, 403, seals the liquid electrolyte or gel electrolyte, or both, in the positive electrode, 402. Solid-state electrolyte, 401, is impermeable to the liquid electrolyte or gel electrolyte, or both, in the positive electrode. In the electrochemical cell, 400, the liquid electrolyte or gel electrolyte, or both, in the positive electrode is prevented from contacting the side of solid-electrolyte, 401, indicated by side A, which is opposite from the side of solid-electrolyte, 401 contacting the positive electrode, 402. In some examples, side A, has a layer of Li metal on it.

In some examples, electrochemical cell, 400, can be a full-cell, which includes a negative electrode, 405, and a negative electrode current collector (not shown). In some examples, the negative electrode, 405, is a lithium metal negative electrode. As the full-cell charges and discharges, the thickness and cross-sectional length of the negative electrode, 405, will vary.

The cross-sectional length of electrochemical cell, 400, is shown as L₄₀₀.

The cross-sectional length of solid-state electrolyte, 401, is shown as L₄₀₁. In a coin-cell format, L₄₀₁ is the diameter of a circular-shaped seal or ring-shaped solid-state electrolyte. In a pouch-cell format, L₄₀₁ is the length or width of a rectangular-shaped seal or square-shaped solid-state electrolyte.

The cross-sectional length of positive electrode, 402, is shown as L₄₀₂. In a coin-cell format, L₄₀₂ is the diameter of a circular-shaped seal or ring-shaped seal. In a pouch-cell format, L₄₀₁ is the length or width of a rectangular-shaped seal or square-shaped seal.

The cross-sectional width of seal, 403, is shown as L₄₀₃. In a coin-cell format, L₄₀₃ is the width of a circular-shaped seal or ring-shaped seal. In a pouch-cell format, L₄₀₃ is the length or width of a rectangular-shaped seal or square-shaped seal. The width is not to be confused with the diameter of the seal, 403, in a coin-cell format. For example, when a coin-cell format is employed, the diameter of seal, 403, is the sum of the width of seal, L₄₀₃ and either the length of the positive electrode, L₄₀₂, or the length of the solid-state electrolyte, L₄₀₁. In some examples, L₄₀₁ and L₄₀₂ are approximately equal. The cross-sectional length of positive electrode current collector, 404, is shown as L₄₀₄. In some non-limiting embodiments, the current collector, 404, has a thickness from about 2 μm to about 25 μm. In some of these examples, the current collector, 404, has a lateral dimension (i.e., length or width for a square or rectangular shaped form factor) from about 1 cm to about 35 cm.

The cross-sectional thickness of electrochemical cell, 400, is shown as H_{cell}. The cross-sectional thickness of solid-state electrolyte, 401, is shown as am. The cross-sectional thickness of positive electrode, 402, is shown as H_{402/403}. The cross-sectional thickness of seal, 403, is shown as H_{402/403}. The cross-sectional thickness of positive electrode current collector, 404, is shown as 11404.

In some examples, seal, 403, extends beyond the edge of the positive electrode current collector, 404, by an overlapping length indicated by L_{E}. In some examples, this amount of overlapping length, L_{E}, is 1, 2, 3, 4, 5, 6, 7, 8, 9, or 10 μm. In some examples, this amount of overlapping length, L_{E}, is 0 μm. In some examples, this amount of overlapping length, L_{E}, is as close to 0 μm as possible.

In some examples, L₄₀₁ is approximately equal to L₄₀₂. In the perimeter seal format shown in FIG. 4A, the sum of H₄₀₁ and H₄₀₂ greater than H₄₀₃.

In some examples, the diameter of the solid-state electrolyte, L₄₀₁, is greater than the diameter of the negative electrode (e.g., Li metal), L₄₀₅. In some examples, the diameter of the solid-state electrolyte, L₁₀₁, is greater than the diameter of the negative electrode (e.g., Li metal), L₄₀₅, by 1 μm, 2 μm, 3 μm, 4 μm, 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, 20 μm, 21 μm, 22 μm, 23 μm, 24 μm, 25 μm, 26 μm, 27 μm, 28 μm, 29 μm, 30 μm, 31 μm, 32 μm, 33 μm, 34 μm, 35 μm, 36 μm, 37 μm, 38 μm, 39 μm, 40 μm, 41 μm, 42 μm, 43 μm, 44 μm, 45 μm, 46 μm, 47 μm, 48 μm, 49 μm, 50 μm, 51 μm, 52 μm, 53 μm, 54 μm, 55 μm, 56 μm, 57 μm, 58 μm, 59 μm, 60 μm, 61 μm, 62 μm, 63 μm, 64 μm, 65 μm, 66 μm, 67 μm, 68 μm, 69 μm, 70 μm, 71 μm, 72 μm, 73 μm, 74 μm, 75 μm, 76 μm, 77 μm, 78 μm, 79 μm, 80 μm, 81 μm, 82 μm, 83 μm, 84 μm, 85 μm, 86 μm, 87 μm, 88 μm, 89 μm, 90 μm, 91 μm, 92 μm, 93 μm, 94 μm, 95 μm, 96 μm, 97 μm, 98 μm, 99 μm, or 100 μm. In some examples, the diameter of the solid-state electrolyte, L₁₀₁, is greater than the diameter of the negative electrode (e.g., Li metal), L₄₀₅, by 100 μm, 200 μm, 300 μm, 400 μm, 500 μm, 600 μm, 700 μm, 800 μm, 900 μm, or 1000 μm. In some examples, the diameter of the solid-state electrolyte, L₁₀₁, is greater than the diameter of the negative electrode (e.g., Li metal), L₄₀₅, by 0.1 mm, 0.2 mm, 0.3 mm, 0.4 mm, 0.5 mm, 0.6 mm, 0.7 mm, 0.8 mm, 0.9 mm, or 1.0 mm. In some examples, the diameter of the solid-state electrolyte, L₁₀₁, is greater than the diameter of the negative electrode (e.g., Li metal), L₄₀₅, by 0.1 cm, 0.2 cm, 0.3 cm, 0.4 cm, 0.5 cm, 0.6 cm, 0.7 cm, 0.8 cm, 0.9 cm, or 1.0 cm.

In some examples, the diameter of the solid-state electrolyte, L₄₀₁, is greater than the diameter of the positive electrode, L₄₀₂. In some examples, the diameter of the solid-state electrolyte, L₄₀₁, is about equal to the diameter of the positive electrode, L₄₀₂. In some examples, the diameter of the solid-state electrolyte, L₄₀₁, is greater than the diameter of the positive electrode, L₄₀₂, by 1 μm, 2 μm, 3 μm, 4 μm, 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, 20 μm, 21 μm, 22 μm, 23 μm, 24 μm, 25 μm, 26 μm, 27 μm, 28 μm, 29 μm, 30 μm, 31 μm, 32 μm, 33 μm, 34 μm, 35 μm, 36 μm, 37 μm, 38 μm, 39 μm, 40 μm, 41 μm, 42 μm, 43 μm, 44 μm, 45 μm, 46 μm, 47 μm, 48 μm, 49 μm, 50 μm, 51 μm, 52 μm, 53 μm, 54 μm, 55 μm, 56 μm, 57 μm, 58 μm, 59 μm, 60 μm, 61 μm, 62 μm, 63 μm, 64 μm, 65 μm, 66 μm, 67 μm, 68 μm, 69 μm, 70 μm, 71 μm, 72 μm, 73 μm, 74 μm, 75 μm, 76 μm, 77 μm, 78 μm, 79 μm, 80 μm, 81 μm, 82 μm, 83 μm, 84 μm, 85 μm, 86 μm, 87 μm, 88 μm, 89 μm, 90 μm, 91 μm, 92 μm, 93 μm, 94 μm, 95 μm, 96 μm, 97 μm, 98 μm, 99 μm, or 100 μm. In some examples, the diameter of the solid-state electrolyte, L₄₀₁, is greater than the diameter of the positive electrode, L₄₀₂, by 100 μm, 200 μm, 300 μm, 400 μm, 500 μm, 600 μm, 700 μm, 800 μm, 900 μm, or 1000 μm. In some examples, the diameter of the solid-state electrolyte, L₄₀₁, is greater than the diameter of the positive electrode, L₄₀₂, by 0.1 mm, 0.2 mm, 0.3 mm, 0.4 mm, 0.5 mm, 0.6 mm, 0.7 mm, 0.8 mm, 0.9 mm, or 1.0 mm. In some examples, the diameter of the solid-state electrolyte, L₄₀₁, is greater than the diameter of the positive electrode, L₄₀₂, by 0.1 cm, 0.2 cm, 0.3 cm, 0.4 cm, 0.5 cm, 0.6 cm, 0.7 cm, 0.8 cm, 0.9 cm, 1.0 cm, 1.1 cm, 1.2 cm, 1.3 cm, 1.4 cm, 1.5 cm, 1.6 cm, 1.7 cm, 1.8 cm, 1.9 cm, or 2.0 cm.

In some examples, the diameter of the solid-state electrolyte, L₄₀₁, is greater than the diameter of the negative electrode, L₄₀₅.

In some examples, the diameter of the solid-state electrolyte, L₄₀₁, is greater than either the diameter of the negative electrode, L₄₀₅, or the diameter of the positive electrode, L₄₀₂.

In some examples, the rectangular or square width of the solid-state electrolyte, L₄₀₁, is greater than either the rectangular width or square width of the negative electrode, L₄₀₅, or of the positive electrode, L₄₀₂.

In some examples, the rectangular or square width of the solid-state electrolyte, L₄₀₁, is greater than the rectangular width or square width of the negative electrode, L₄₀₅.

In some examples, the rectangular or square width of the solid-state electrolyte, L₄₀₁, is greater than the rectangular width or square width of the positive electrode, L₄₀₂.

In some examples, L₄₀₁ is greater than L₄₀₂

In some other examples, L₄₀₁ is equal to L₄₀₂

In some examples, L₄₀₁ is greater than L₄₀₅.

In some examples, L₄₀₁ is greater than both L₄₀₂ or L₄₀₅.

In some examples, the electrochemical cell is substantially as shown in FIG. 4B.

FIG. 4B is not drawn to scale. In FIG. 4B electrochemical cell 400 is illustrated in a cross-sectional view. Electrochemical cell, 400, includes a solid-state electrolyte, 401, which is positioned on top of a positive electrode, 402, which is positioned on top of a positive electrode current collector, 404. In FIG. 4B, these elements, 401, 402, 403, and 404, are shown as spaced apart so that double-sided arrows A, B, and C can indicate the points of contact between seal, 403, and elements, 401, 402, and 404. Forming a seal between the face of the current collector, 404, and side-edge of the solid-state electrolyte, 401, and the side-edge of the positive electrode, 402, is a perimeter seal, 403. The side-edge of 403 bonds with the side-edge of 401, and with the side-edge of 402, the side-edges of which are indicated by the double-sided arrows, A. The face of 403 bonds with the face of 404, the faces of which are indicated by the double-sided arrow, B. The perimeter seal also encloses the liquid electrolyte or gel electrolyte in the positive electrode, 402, and may form a bond from the side-edge of the seal, 403, to the side-edge of the positive electrode, 402.

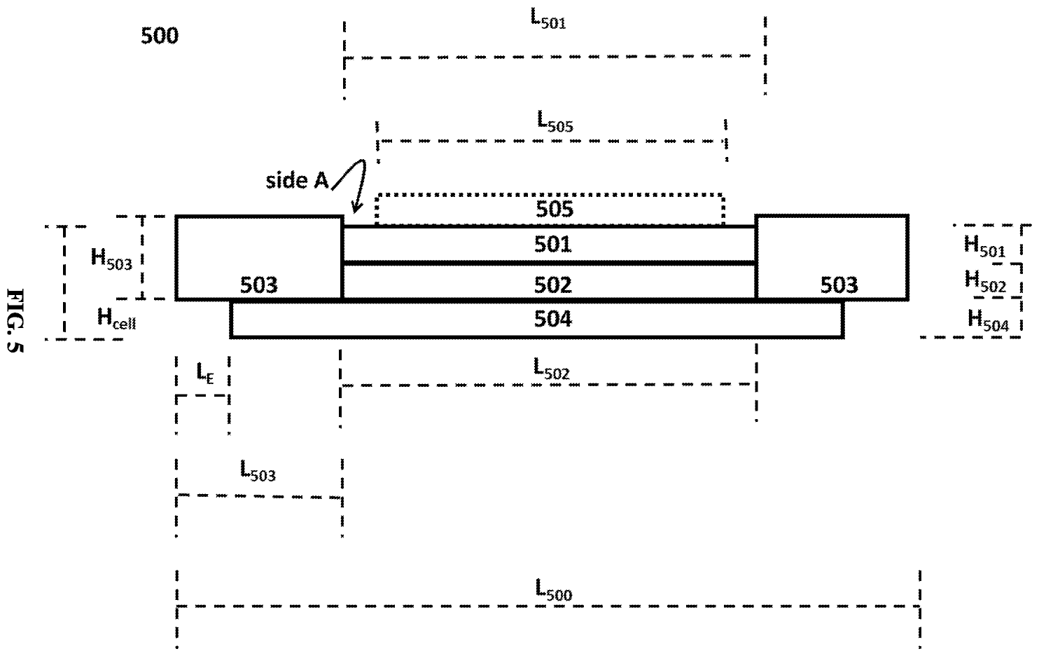

In some examples, the electrochemical cell is substantially as shown in FIG. 5

FIG. 5 is not drawn to scale. In FIG. 5, electrochemical cell 500 is illustrated in a cross-sectional view. Electrochemical cell 500 includes a solid-state electrolyte, 501, which is positioned on top of a positive electrode, 502, which is positioned on top of a positive electrode current collector, 504. The solid-state electrolyte may include any solid-state electrolytes set forth herein. The positive electrode may include any positive electrode active materials set forth herein. In the positive electrode, 502, is either a liquid electrolyte or a gel electrolyte, or both. Forming a seal between the current collector, 504, and the solid-state electrolyte, 501, is a perimeter seal, 503. Perimeter seal, 503, bonds to the face of current collector, 504, and bonds to the side-edge of the solid-state electrolyte, 501. The seal may also contact side-edge of positive electrode, 502. The seal, 503, is selected from a circular-shaped seal, a ring-shaped seal, a rectangular-shaped seal or a square-shaped seal, depending on the actual form factor of the electrochemical cell, 500. In a coin-cell format, the seal, 503, is a circular-shaped seal or ring-shaped seal. In a pouch-cell format, the seal, 503, is a rectangular-shaped seal or square-shaped seal. Seal, 503, seals the liquid electrolyte or gel electrolyte, or both, in the positive electrode, 502. Solid-state electrolyte, 501, is impermeable to the liquid electrolyte or gel electrolyte, or both, in the positive electrode. In the electrochemical cell, 500, the liquid electrolyte or gel electrolyte, or both, in the positive electrode is prevented from contacting the side of solid-electrolyte, 501, indicated by side A, which is opposite from the side of solid-electrolyte, 501 contacting the positive electrode, 502. In some examples, side A, has a layer of Li metal on it.

In some examples, electrochemical cell, 500, can be a full-cell, which includes a negative electrode, 505, and a negative electrode current collector (not shown). In some examples, the negative electrode, 505, is a lithium metal negative electrode. As the full-cell charges and discharges, the thickness and cross-sectional length of the negative electrode, 505, will vary.

The cross-sectional length of electrochemical cell, 500, is shown as L₅₀₀.

The cross-sectional length of solid-state electrolyte, 501, is shown as L₅₀₁. In a coin-cell format, L₅₀₁ is the diameter of a circular-shaped seal or ring-shaped solid-state electrolyte. In a pouch-cell format, L₅₀₁ is the length or width of a rectangular-shaped seal or square-shaped solid-state electrolyte.

The cross-sectional length of positive electrode, 502, is shown as L₅₀₂. In a coin-cell format, L₅₀₂ is the diameter of a circular-shaped seal or ring-shaped seal. In a pouch-cell format, L₅₀₁ is the length or width of a rectangular-shaped seal or square-shaped seal.

The cross-sectional width of seal, 503, is shown as L₅₀₃. In a coin-cell format, L₅₀₃ is the width of a circular-shaped seal or ring-shaped seal. In a pouch-cell format, L₅₀₃ is the length or width of a rectangular-shaped seal or square-shaped seal. The width is not to be confused with the diameter of the seal, 503, in a coin-cell format. For example, when a coin-cell format is employed, the diameter of seal, 503, is the sum of the width of seal, L₅₀₃ and either the length of the positive electrode, L₅₀₂, or the length of the solid-state electrolyte, L₅₀₁. In some examples, L₅₀₁ and L₅₀₂ are approximately equal.

The cross-sectional length of positive electrode current collector, 504, is shown as L₅₀₄.

The cross-sectional thickness of electrochemical cell, 500, is shown as H_{cell}. The cross-sectional thickness of solid-state electrolyte, 501, is shown as H₅₀₁. The cross-sectional thickness of positive electrode, 502, is shown as H₅₀₂. The cross-sectional thickness of seal, 503, is shown as H₅₀₃. The cross-sectional thickness of positive electrode current collector, 504, is shown as H₅₀₄.

In some examples, seal, 503, extends beyond the edge of the positive electrode current collector, 504, by an overlapping length indicated by L_{E}. In some examples, this amount of overlapping length, L_{E}, is 1, 2, 3, 4, 5, 6, 7, 8, 9, or 10 μm. In some examples, this amount of overlapping length, L_{E}, is 0 μm. In some examples, this amount of overlapping length, L_{E}, is as close to 0 μm as possible.

In some examples, L₅₀₁ is approximately equal to L₅₀₂. In the perimeter seal format shown in FIG. 5, the sum of H₅₀₁ and H₅₀₂ is less than H₅₀₃.

In some examples, the diameter of the solid-state electrolyte, L₅₀₁, is greater than the diameter of the negative electrode (e.g., Li metal), L₅₀₅. In some examples, the diameter of the solid-state electrolyte, L₅₀₁, is greater than the diameter of the negative electrode (e.g., Li metal), L₅₀₅, by 50 μm to 1 cm. In some examples, the diameter of the solid-state electrolyte, L₅₀₁, is greater than the diameter of the negative electrode (e.g., Li metal), L₅₀₅, by 1 μm, 2 μm, 3 μm, 4 μm, 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, 20 μm, 21 μm, 22 μm, 23 μm, 24 μm, 25 μm, 26 μm, 27 μm, 28 μm, 29 μm, 30 μm, 31 μm, 32 μm, 33 μm, 34 μm, 35 μm, 36 μm, 37 μm, 38 μm, 39 μm, 40 μm, 41 μm, 42 μm, 43 μm, 44 μm, 45 μm, 46 μm, 47 μm, 48 μm, 49 μm, 50 μm, 51 μm, 52 μm, 53 μm, 54 μm, 55 μm, 56 μm, 57 μm, 58 μm, 59 μm, 60 μm, 61 μm, 62 μm, 63 μm, 64 μm, 65 μm, 66 μm, 67 μm, 68 μm, 69 μm, 70 μm, 71 μm, 72 μm, 73 μm, 74 μm, 75 μm, 76 μm, 77 μm, 78 μm, 79 μm, 80 μm, 81 μm, 82 μm, 83 μm, 84 μm, 85 μm, 86 μm, 87 μm, 88 μm, 89 μm, 90 μm, 91 μm, 92 μm, 93 μm, 94 μm, 95 μm, 96 μm, 97 μm, 98 μm, 99 μm, or 100 μm. In some examples, the diameter of the solid-state electrolyte, L₅₀₁, is greater than the diameter of the negative electrode (e.g., Li metal), L₅₀₅, by 100 μm, 200 μm, 300 μm, 400 μm, 500 μm, 600 μm, 700 μm, 800 μm, 900 μm, or 1000 μm. In some examples, the diameter of the solid-state electrolyte, L₅₀₁, is greater than the diameter of the negative electrode (e.g., Li metal), L₅₀₅, by 0.1 mm, 0.2 mm, 0.3 mm, 0.4 mm, 0.5 mm, 0.6 mm, 0.7 mm, 0.8 mm, 0.9 mm, or 1.0 mm. In some examples, the diameter of the solid-state electrolyte, L₅₀₁, is greater than the diameter of the negative electrode (e.g., Li metal), L₅₀₅, by 0.1 cm, 0.2 cm, 0.3 cm, 0.4 cm, 0.5 cm, 0.6 cm, 0.7 cm, 0.8 cm, 0.9 cm, or 1.0 cm.

In some examples, the diameter of the solid-state electrolyte, L₅₀₁, is greater than the diameter of the positive electrode, L₅₀₂. In some examples, the diameter of the solid-state electrolyte, L₅₀₁, is about equal to the diameter of the positive electrode, L₅₀₂.

In some examples, the diameter of the solid-state electrolyte, L₅₀₁, is greater than the diameter of the negative electrode, L₅₀₅.

In some examples, the diameter of the solid-state electrolyte, L₅₀₁, is greater than either the diameter of the negative electrode, L₅₀₅, or the diameter of the positive electrode, L₅₀₂.

In some examples, the rectangular or square width of the solid-state electrolyte, L₅₀₁, is greater than either the rectangular width or square width of the negative electrode, L₅₀₅, or of the positive electrode, L₅₀₂.

In some examples, the rectangular or square width of the solid-state electrolyte, L₅₀₁, is greater than the rectangular width or square width of the negative electrode, L₅₀₅.

In some examples, the rectangular or square width of the solid-state electrolyte, L₅₀₁, is greater than the rectangular width or square width of the positive electrode, L₅₀₂.

In some examples, L₅₀₁ is greater than L₅₀₂.

In some other examples, L₅₀₁ is equal to L₅₀₂.

In some examples, L₅₀₁ is greater than L₅₀₅.

In some examples, L₅₀₁ is greater than both L₅₀₂ or L₅₀₅.

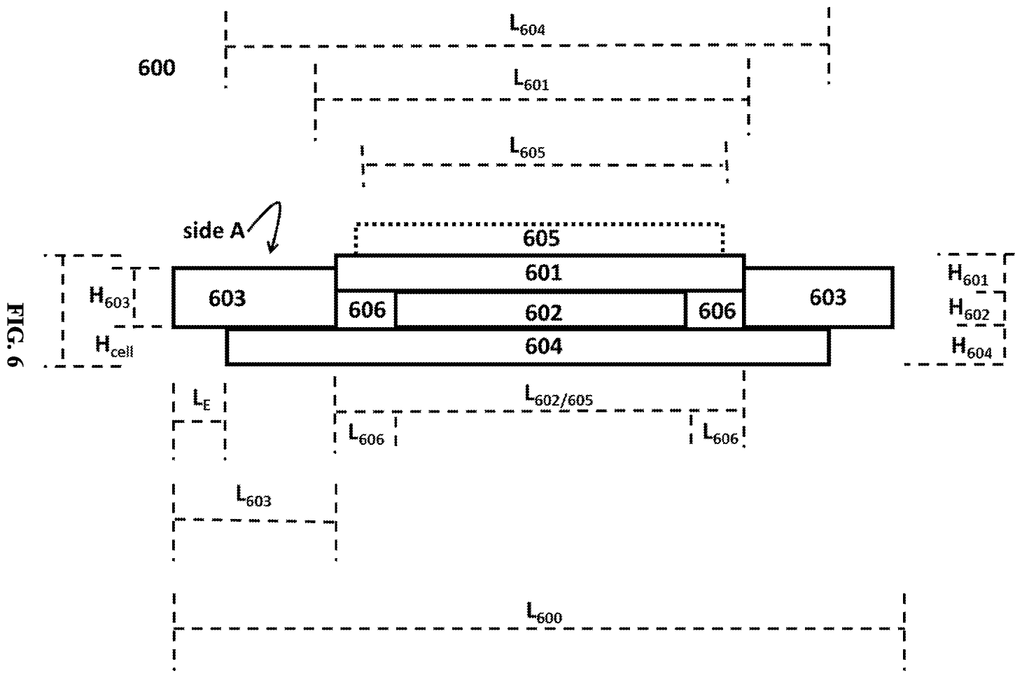

In some examples, the electrochemical cell is substantially as shown in FIG. 6.

FIG. 6 is not drawn to scale. In FIG. 6, electrochemical cell 600 is illustrated in a cross-sectional view. Electrochemical cell 600 includes a solid-state electrolyte, 601, which is positioned on top of a positive electrode, 602, which is positioned on top of a positive electrode current collector, 604. The solid-state electrolyte may include any solid-state electrolytes set forth herein. The positive electrode may include any positive electrode active materials set forth herein. In the positive electrode, 602, is either a liquid electrolyte or a gel electrolyte, or both. In some examples, a liquid electrolyte or a gel electrolyte is located near reservoir 606 in addition to being inside 602. In some examples, a liquid electrolyte is located near reservoir 606 in addition to being inside 602. In some examples, a gel electrolyte is located near reservoir 606 in addition to being inside 602. Forming a seal between the current collector, 604, and the solid-state electrolyte, 601, is a perimeter seal, 603. Perimeter seal, 603, bonds to the face of current collector, 604, and bonds to the side-edge of the solid-state electrolyte, 601. The seal may also contact side-edge of positive electrode, 602, or 606. The seal, 603, is selected from a circular-shaped seal, a ring-shaped seal, a rectangular-shaped seal or a square-shaped seal, depending on the actual form factor of the electrochemical cell, 600. In a coin-cell format, the seal, 603, is a circular-shaped seal or ring-shaped seal. In a pouch-cell format, the seal, 603, is a rectangular-shaped seal or square-shaped seal. Seal, 603, seals the liquid electrolyte or gel electrolyte, or both, in 606 and in the positive electrode, 602. Solid-state electrolyte, 601, is impermeable to the liquid electrolyte or gel electrolyte, or both, in the positive electrode. In the electrochemical cell, 600, the liquid electrolyte or gel electrolyte, or both, in the positive electrode is prevented from contacting the side of solid-electrolyte, 601, indicated by side A, which is opposite from the side of solid-electrolyte, 601 contacting the positive electrode, 602. In some examples, side A, has a layer of Li metal on it.

In some examples, electrochemical cell, 600, can be a full-cell, which includes a negative electrode, 605, and a negative electrode current collector (not shown). In some examples, the negative electrode, 605, is a lithium metal negative electrode. As the full-cell charges and discharges, the thickness and cross-sectional length of the negative electrode, 605, will vary.

The cross-sectional length of electrochemical cell, 600, is shown as L₆₀₀.

The cross-sectional length of solid-state electrolyte, 601, is shown as L₆₀₁. In a coin-cell format, L₆₀₁ is the diameter of a circular-shaped seal or ring-shaped solid-state electrolyte. In a pouch-cell format, L₆₀₁ is the length or width of a rectangular-shaped seal or square-shaped solid-state electrolyte.

The cross-sectional length of positive electrode, 602, is shown as L₆₀₂. In a coin-cell format, L₆₀₂ is the diameter of a circular-shaped seal or ring-shaped seal. In a pouch-cell format, L₆₀₁ is the length or width of a rectangular-shaped seal or square-shaped seal.

The cross-sectional width of seal, 603, is shown as L₆₀₃. In a coin-cell format, L₆₀₃ is the width of a circular-shaped seal or ring-shaped seal. In a pouch-cell format, L₆₀₃ is the length or width of a rectangular-shaped seal or square-shaped seal. The width is not to be confused with the diameter of the seal, 603, in a coin-cell format. For example, when a coin-cell format is employed, the diameter of seal, 603, is the sum of the width of seal, L₆₀₃ and either the length of the positive electrode, L₆₀₂, or the length of the solid-state electrolyte, L₆₀₁. In some examples, L₆₀₁ and L₆₀₂ are approximately equal.

The cross-sectional length of positive electrode current collector, 604, is shown as L₆₀₄.

The cross-sectional length of liquid electrolyte or gel electrolyte reservoir, 606, is shown as L₆₀₂.

The cross-sectional thickness of electrochemical cell, 600, is shown as H_{cell}. The cross-sectional thickness of solid-state electrolyte, 601, is shown as H₆₀₁. The cross-sectional thickness of positive electrode, 602, is shown as H₆₀₂. The cross-sectional thickness of seal, 603, is shown as H₆₀₃. The cross-sectional thickness of positive electrode current collector, 604, is shown as H₆₀₄.

In some examples, seal, 603, extends beyond the edge of the positive electrode current collector, 604, by an overlapping length indicated by L_{E}. In some examples, this amount of overlapping length, L_{E}, is 1, 2, 3, 6, 5, 6, 7, 8, 9, or 10 μm. In some examples, this amount of overlapping length, L_{E}, is 10, 20, 30, 40, 50, 60, 70, 80, 90, or 100 μm. In some examples, this amount of overlapping length, L_{E}, is 0.1, 0.2, 0.3, 0.4, 0.5, 0.6, 0.7, 0.8, 0.9, or 1.0 cm. In some examples, this amount of overlapping length, L_{E}, is from about 50 μm to 1 cm.

In some examples, L₆₀₁ is greater than L₆₀₂. In the perimeter seal format shown in FIG. 6, the sum of H₆₀₁ and H₆₀₂ is greater than H₆₀₃. In other embodiments, such as in FIG. 5, seal 603 can extend above 601 (not shown in FIG. 6 but embraced by the concept disclosed therein).

In some examples, the diameter of the solid-state electrolyte, L₆₀₁, is greater than the diameter of the negative electrode (e.g., Li metal), L₆₀₅. In some examples, the diameter of the solid-state electrolyte, L₆₀₁, is greater than the diameter of the negative electrode (e.g., Li metal), L₆₀₅, by 50 μm to 1 cm. In some examples, the diameter of the solid-state electrolyte, L₆₀₁, is greater than the diameter of the negative electrode (e.g., Li metal), L₆₀₅, by 1 μm, 2 μm, 3 μm, 4 μm, 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, 20 μm, 21 μm, 22 μm, 23 μm, 24 μm, 25 μm, 26 μm, 27 μm, 28 μm, 29 μm, 30 μm, 31 μm, 32 μm, 33 μm, 34 μm, 35 μm, 36 μm, 37 μm, 38 μm, 39 μm, 40 μm, 41 μm, 42 μm, 43 μm, 44 μm, 45 μm, 46 μm, 47 μm, 48 μm, 49 μm, 50 μm, 51 μm, 52 μm, 53 μm, 54 μm, 55 μm, 56 μm, 57 μm, 58 μm, 59 μm, 60 μm, 61 μm, 62 μm, 63 μm, 64 μm, 65 μm, 66 μm, 67 μm, 68 μm, 69 μm, 70 μm, 71 μm, 72 μm, 73 μm, 74 μm, 75 μm, 76 μm, 77 μm, 78 μm, 79 μm, 80 μm, 81 μm, 82 μm, 83 μm, 84 μm, 85 μm, 86 μm, 87 μm, 88 μm, 89 μm, 90 μm, 91 μm, 92 μm, 93 μm, 94 μm, 95 μm, 96 μm, 97 μm, 98 μm, 99 μm, or 100 μm. In some examples, the diameter of the solid-state electrolyte, L₆₀₁, is greater than the diameter of the negative electrode (e.g., Li metal), L₆₀₅, by 100 μm, 200 μm, 300 μm, 400 μm, 500 μm, 600 μm, 700 μm, 800 μm, 900 μm, or 1000 μm. In some examples, the diameter of the solid-state electrolyte, L₆₀₁, is greater than the diameter of the negative electrode (e.g., Li metal), L₆₀₅, by 0.1 mm, 0.2 mm, 0.3 mm, 0.4 mm, 0.5 mm, 0.6 mm, 0.7 mm, 0.8 mm, 0.9 mm, or 1.0 mm. In some examples, the diameter of the solid-state electrolyte, L₆₀₁, is greater than the diameter of the negative electrode (e.g., Li metal), L₆₀₅, by 0.1 cm, 0.2 cm, 0.3 cm, 0.4 cm, 0.5 cm, 0.6 cm, 0.7 cm, 0.8 cm, 0.9 cm, or 1.0 cm.

In some examples, the diameter of the solid-state electrolyte, L₆₀₁, is greater than the diameter of the positive electrode, L₆₀₂. In some examples, the diameter of the solid-state electrolyte, L₆₀₁, is about equal to the sum of the diameter of the positive electrode, L₆₀₂, and the width of the reservoir, 606. In some examples, the diameter of the solid-state electrolyte, L₆₀₁, is greater than the diameter of the positive electrode, L₆₀₂, by 1 μm, 2 μm, 3 μm, 4 μm, 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, 20 μm, 21 μm, 22 μm, 23 μm, 24 μm, 25 μm, 26 μm, 27 μm, 28 μm, 29 μm, 30 μm, 31 μm, 32 μm, 33 μm, 34 μm, 35 μm, 36 μm, 37 μm, 38 μm, 39 μm, 40 μm, 41 μm, 42 μm, 43 μm, 44 μm, 45 μm, 46 μm, 47 μm, 48 μm, 49 μm, 50 μm, 51 μm, 52 μm, 53 μm, 54 μm, 55 μm, 56 μm, 57 μm, 58 μm, 59 μm, 60 μm, 61 μm, 62 μm, 63 μm, 64 μm, 65 μm, 66 μm, 67 μm, 68 μm, 69 μm, 70 μm, 71 μm, 72 μm, 73 μm, 74 μm, 75 μm, 76 μm, 77 μm, 78 μm, 79 μm, 80 μm, 81 μm, 82 μm, 83 μm, 84 μm, 85 μm, 86 μm, 87 μm, 88 μm, 89 μm, 90 μm, 91 μm, 92 μm, 93 μm, 94 μm, 95 μm, 96 μm, 97 μm, 98 μm, 99 μm, or 100 μm. In some examples, the diameter of the solid-state electrolyte, L₆₀₁, is greater than the diameter of the positive electrode, L₆₀₂, by 100 μm, 200 μm, 300 μm, 400 μm, 500 μm, 600 μm, 700 μm, 800 μm, 900 μm, or 1000 μm. In some examples, the diameter of the solid-state electrolyte, L₆₀₁, is greater than the diameter of the positive electrode, L₆₀₂, by 0.1 mm, 0.2 mm, 0.3 mm, 0.4 mm, 0.5 mm, 0.6 mm, 0.7 mm, 0.8 mm, 0.9 mm, or 1.0 mm. In some examples, the diameter of the solid-state electrolyte, L₆₀₁, is greater than the diameter of the positive electrode, L₆₀₂, by 0.1 cm, 0.2 cm, 0.3 cm, 0.4 cm, 0.5 cm, 0.6 cm, 0.7 cm, 0.8 cm, 0.9 cm, 1.0 cm, 1.1 cm, 1.2 cm, 1.3 cm, 1.4 cm, 1.5 cm, 1.6 cm, 1.7 cm, 1.8 cm, 1.9 cm, or 2.0 cm. In some examples, the diameter of the solid-state electrolyte, L₆₀₁, is greater than the diameter of the positive electrode, L₆₀₂, by 20 μm to 2 cm. In some examples, the diameter of the solid-state electrolyte, L₆₀₁, is greater than the diameter of the positive electrode, L₆₀₂, by 50 μm to 2 cm.

In some examples, the diameter of the solid-state electrolyte, L₆₀₁, is greater than the diameter of the negative electrode, L₆₀₅.

In some examples, the diameter of the solid-state electrolyte, L₆₀₁, is greater than either the diameter of the negative electrode, L₆₀₅, or the diameter of the positive electrode, L₆₀₂.

In some examples, the rectangular or square width of the solid-state electrolyte, L₆₀₁, is greater than either the rectangular width or square width of the negative electrode, L₆₀₅, or of the positive electrode, L₆₀₂.

In some examples, the rectangular or square width of the solid-state electrolyte, L₆₀₁, is greater than the rectangular width or square width of the negative electrode, L₆₀₅.

In some examples, the rectangular or square width of the solid-state electrolyte, L₆₀₁, is greater than the sum of the rectangular width or square width of the positive electrode, L₆₀₂, and the width of the reservoir, 606.

In some examples, L₆₀₁ is greater than L₆₀₂.

In some other examples, L₆₀₁ is equal to L₆₀₂.

In some examples, L₆₀₁ is greater than L₆₀₅

In some examples, L₆₀₁ is greater than both L₆₀₂ or L₆₀₅

Certain electrochemical cell systems, methods, and uses are set forth in WO 2018/098494, the publishes version of International PCT Patent Application No. PCT/US17/63523, filed Nov. 28, 2017, entitled PRESSURIZED ELECTROCHEMICAL CELL, in International PCT Patent Application No. PCT/US17/63526, filed Nov. 28, 2017, entitled ACTIVE AND PASSIVE BATTERY PRESSURE MANAGEMENT, and in International PCT Patent Application No. PCT/US17/63397, filed Nov. 28, 2017, entitled PREDICTIVE MODEL FOR ESTIMATING BATTERY STATES. The entire contents these provisional patent applications are herein incorporated by reference in its entirety for all purposes.

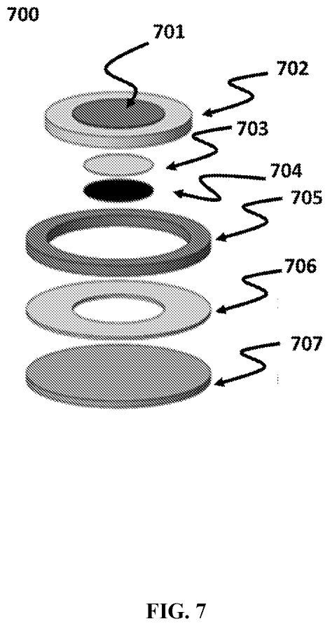

In some examples, the electrochemical cell is substantially as shown in FIG. 7.

FIG. 7 is not drawn to scale. In FIG. 7, electrochemical cell 700 is illustrated with the individual components separated vertically.

Electrochemical cell, 700, includes lithium metal negative electrode, 701, which is positioned on top of a solid-state electrolyte, 702. The solid-state electrolyte, 702, is positioned on top of gel electrolyte, 703, and a positive electrode, 704. The positive electrode, 704, is positioned on top of the positive electrode current collector, 707. Surrounding the electrochemical stack of 702, 703, 704, is a seal, 706. Surrounding the electrochemical stack of 702, 703, 704, and 706 is a pressure ring (e.g., PEEK ring), 705.

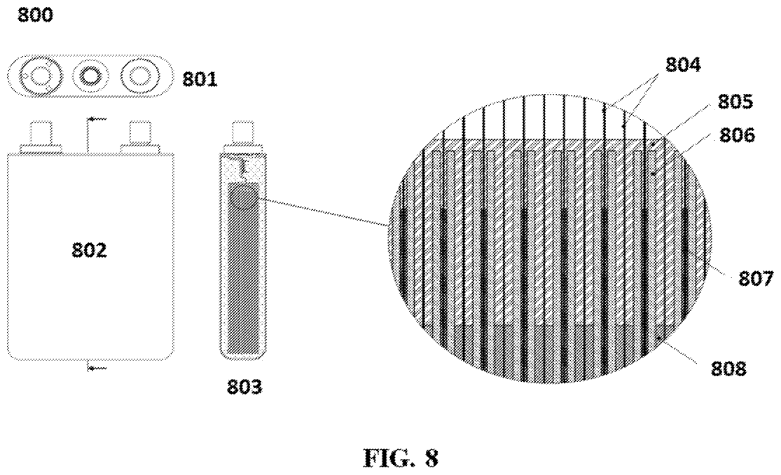

FIG. 8 is not drawn to scale. In FIG. 8, set forth is an example electrochemical can cell, 800. Electrochemical cell, 800, is shown in a top-down view as 801. Electrochemical cell, 800, is shown in a side view as 802. Electrochemical cell, 800, is shown in a side view as 803. Side view, 802, is turned ninety degrees with respect to side view, 803. Side view, 803, is magnified on the right side of FIG. 8. Electrochemical cell, 800, includes foil current collectors, 804. Electrochemical cell, 800, includes a seal, 805. Electrochemical cell, 800, includes foil solid-state electrolyte, 806. Electrochemical cell, 800, includes negative electrode, 807. Electrochemical cell, 800, includes positive electrode, 808.

The instant disclosure is not to be limited to the specific figures and illustrations presented herein but is to be afforded the broadest interpretation consistent with the entire disclosure herein.

### VII. Seal Materials

Set forth herein are seal materials, which may include, but are not limited to, plastomers such as AFFINITY™ EG 8185, EG8100, EG8200, SL8110G, KC8852, VP8770, PF1140, PF1146, PF1162, PL1280, SQ1503, PL1880, PL1881, PL1888, PL1850, PT1450, PT1451, PL1840, PL1845, Thermoplastic olefin, Versify, Escorene PP8213, metallocene-catalyzed isotactic polypropylene (mPP) ethylene-alpha olefin copolymers. The flow and adhesion properties of the seal material may be important.

Set forth herein are seal materials, which may include, but are not limited to, polyolefins such as polyethylene, polypropylene (PP), polymethylpentene, polybutene, polyisobutylene (PIB), ethylene propylene rubber, ethylene propylene diene, resins, and copolymers of the above. A seal may comprise seal materials, wherein seal materials are selected from the group consisting of polyisobutylene (PIB), polyether ether ketone (PEEK), polypropylene, a polyolefin, a resin, and combinations thereof.

The key material parameters for the seal may include (1) compatibility with liquid electrolytes and gel electrolytes; a (2) durometer of between 30 and 150 as measured by ASTM D2240 or ISO 868 (3) adhesion to the separator, electrode, and/or current collector; (4) ability to stop the migration of the liquid electrolyte and gel electrolyte from the positive electrode to negative electrode.

In some examples, including any of the foregoing, the seal is made of a single material. In other embodiments, the seal includes more than a single type of material.

In some examples, including any of the foregoing, the seal is made of polypropylene. The seal may have a hardness of about 30 durometer as measured by ASTM D2240 or ISO 868. In some examples, the seal may have a hardness of about 33 durometer. In some examples, the seal may have a hardness of about 36 durometer. In some examples, the seal may have a hardness of about 39 durometer. In some examples, the seal may have a hardness of about 40 durometer. In some examples, the seal may have a hardness of about 44 durometer. In some examples, the seal may have a hardness of about 48 durometer. In some examples, the seal may have a hardness of about 50 durometer. In some examples, the seal may have a hardness of about 55 durometer. In some examples, the seal may have a hardness of about 60 durometer. In some examples, the seal may have a hardness of about 66 durometer. In some examples, the seal may have a hardness of about 70 durometer. In some examples, the seal may have a hardness of about 77 durometer. In some examples, the seal may have a hardness of about 80 durometer. In some examples, the seal may have a hardness of about 88 durometer. In some examples, the seal may have a hardness of about 90 durometer. In some examples, the seal may have a hardness of about 100 durometer. In some examples, the seal may have a hardness of about 110 durometer. In some examples, the seal may have a hardness of about 120 durometer. In some examples, the seal may have a hardness of about 130 durometer. In some examples, the seal may have a hardness of about 140 durometer. In some examples, the seal may have a hardness of about 150 durometer.

The seal may be made under 0.05-5 MPa at 150-190° C. for 0.1-100 s. The seal should be pressed after vacuum is applied to the cell.

### VIII. Positive Electrode Active Materials

Positive electrode materials include, but are not limited to, the positive electrode active material examples in “Rechargeable batteries: challenges old and new” J Solid State Electrochem. (2012) 16:2019-2029 by J. Goodenough, “Challenges for Rechargeable Li Batteries” Chem. Mater. 22 (2010) 587-603 by J. Goodenough and Y. Kim, “A review of advanced and practical lithium battery materials” J. Mater. Chem. 2011, 21, 9938-9954 by R. Marom et al. The entire contents of each of these publications is incorporated by reference in their entirety for all purposes.

### IX. Methods of Making

In some embodiments, application of a seal material may be via one or more methods, such as casting or application via doctor blade, meyer rod, comma coater, gravure coater, microgravure, reverse comma coater, slot dye, slip, or tape casting. A seal material may also be applied via methods of dipping or spraying.

In some cases, a seal material may be applied via injection or pouring into a mold, wherein the mold may contain some or most of the components of an electrochemical stack. Addition of a seal material into a mold may be done at atmospheric pressure. Addition of a seal material into a mold may be done at lower than atmospheric pressure, such as at less than about 750 mmHg, 700 mmHg, 650 mmHg, 600 mmHg, 550 mmHg, 500 mmHg, 400 mmHg, or lower.

In some embodiments, application of a seal material may be after assembly of an electrochemical stack. In some embodiments, application of a seal material may be before assembly of an electrochemical stack.

The face seal may be made by applying 0.05-5 MPa of pressure at 150-190° C. for 0.1-100 s while the seal is set. The seal should be pressed after vacuum is applied to the cell.

The perimeter seal may be made by applying 0.05-5 MPa of pressure at 150-190° C. for 0.1-100 s while the seal is set. The seal should be pressed after vacuum is applied to the cell.

In some examples, set forth herein is a method of making an electrochemical cell, including the following: (1) providing a positive electrode current collector on a substrate; (2) applying a seal material on the current collector; (3) providing an electrochemical stack on the seal material, wherein the electrochemical stack comprises: (a) a solid-state electrolyte; and (b) a positive electrode comprising a liquid electrolyte or a gel electrolyte; wherein the seal material is impermeable to the liquid electrolyte or the gel electrolyte that bonds to the positive electrode current collector and to the solid-state electrolyte. The method further includes enclosing the cell stack within polyether ether ketone (PEEK); and applying at least 3 pounds per square inch (PSI) to the electrochemical cell.

In some examples, the methods include heating the substrate to at least 50° C.

In some examples, set forth herein is a method of making an electrochemical cell, including the following: providing a positive electrode current collector on a substrate; providing a seal material on the positive electrode current collector; providing a polyether ether ketone (PEEK) enclosure; providing an electrochemical stack on the seal material and within the PEEK enclosure, wherein the electrochemical stack comprises: a solid-state electrolyte; a positive electrode comprising a liquid electrolyte or a gel electrolyte; and a positive electrode current collector; wherein the seal material is impermeable to the liquid electrolyte or the gel electrolyte that bonds to the positive electrode current collector and to the solid-state electrolyte; and applying at least 3 pounds per square inch (PSI) to the electrochemical cell.

### X. Additional Embodiments

In some examples, set forth herein is an electrochemical cell comprising:
a positive electrode current collector;
a positive electrode comprising a liquid electrolyte;
a bilayer solid-state electrolyte having a first layer comprising a sulfide and a second layer comprising a lithium phosphorus sulfur halide;
a negative electrode current collector; and
a seal impermeable to the liquid electrolyte, which seals the interface between the positive electrode current collector and the positive electrode; and which seals the interface between the positive electrode and the first layer of the bilayer solid-state electrolyte;
wherein the first layer is in direct contact with the positive electrode.

In some examples, including any of the foregoing, the sulfide in the first layer is a lithium silicon sulfide, LTS, LXPS, or LXPSO.

In some examples, including any of the foregoing, the second layer is in contact with the negative electrode current collector when the electrochemical cell is fully discharged or is in contact with a layer of lithium on the negative electrode current collector when the electrochemical cell is at least partially charged.

In some examples, including any of the foregoing, the electrochemical cell comprises a layer of lithium in direct contact with and between the bilayer solid-state electrolyte and the negative electrode current collector.

In some examples, including any of the foregoing, the second layer is in direct contact with the layer of lithium.

In some examples, including any of the foregoing, the solid-state electrolyte is impermeable to the liquid electrolyte.

In some examples, including any of the foregoing, the electrochemical cell comprises a negative metal electrode; wherein the second layer is in direct contact with the negative metal electrode.

In some examples, including any of the foregoing, the negative metal electrode is a lithium (Li) metal negative electrode.

In some examples, including any of the foregoing, the seal does not contact the second layer of the bilayer electrolyte.

In some examples, including any of the foregoing, the seal impermeable to the liquid electrolyte seals the interface between the first and second layers of the bilayer electrolyte.

In some examples, including any of the foregoing, the seal is made of a single material.

In some examples, including any of the foregoing, the seal is made of multi-layers of materials.

In some examples, including any of the foregoing, the height of the seal from the positive electrode current collector to where the seal terminates on the bilayer solid-state electrolyte is about 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40 μm.

In some examples, including any of the foregoing, seal has a wall thickness of 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40 mm. In some examples, including any of the foregoing, seal comprises a material selected from the group consisting of polyisobutylene (PIB), polypropylene, polyether ether ketone (PEEK), polypropylene, a polyolefin, and combinations thereof.

In some examples, including any of the foregoing, seal comprises a plastomer.

In some examples, including any of the foregoing, seal has a wall thickness of 0.1 mm. In some examples, including any of the foregoing, seal has a wall thickness of 0.2 mm. In some examples, including any of the foregoing, seal has a wall thickness of 0.3 mm. In some examples, including any of the foregoing, seal has a wall thickness of 0.4 mm. In some examples, including any of the foregoing, seal has a wall thickness of 0.5 mm. In some examples, including any of the foregoing, seal has a wall thickness of 0.6 mm. In some examples, including any of the foregoing, seal has a wall thickness of 0.7 mm. In some examples, including any of the foregoing, seal has a wall thickness of 0.8 mm. In some examples, including any of the foregoing, seal has a wall thickness of 0.9 mm. In some examples, including any of the foregoing, seal has a wall thickness of 1.0 mm.

In some examples, including any of the foregoing, seal has a wall thickness of 1 mm. In some examples, including any of the foregoing, seal has a wall thickness of 2 mm. In some examples, including any of the foregoing, seal has a wall thickness of 3 mm. In some examples, including any of the foregoing, seal has a wall thickness of 4 mm. In some examples, including any of the foregoing, seal has a wall thickness of 5 mm. In some examples, including any of the foregoing, seal has a wall thickness of 6 mm. In some examples, including any of the foregoing, seal has a wall thickness of 7 mm. In some examples, including any of the foregoing, seal has a wall thickness of 8 mm. In some examples, including any of the foregoing, seal has a wall thickness of 9 mm. In some examples, including any of the foregoing, seal has a wall thickness of 10 mm.

In some examples, including any of the foregoing, seal has a wall thickness of 11 mm. In some examples, including any of the foregoing, seal has a wall thickness of 12 mm. In some examples, including any of the foregoing, seal has a wall thickness of 13 mm. In some examples, including any of the foregoing, seal has a wall thickness of 14 mm. In some examples, including any of the foregoing, seal has a wall thickness of 15 mm. In some examples, including any of the foregoing, seal has a wall thickness of 16 mm. In some examples, including any of the foregoing, seal has a wall thickness of 17 mm. In some examples, including any of the foregoing, seal has a wall thickness of 18 mm. In some examples, including any of the foregoing, seal has a wall thickness of 19 mm. In some examples, including any of the foregoing, seal has a wall thickness of 20 mm.

In some examples, including any of the foregoing, seal has a wall thickness of 21 mm. In some examples, including any of the foregoing, seal has a wall thickness of 22 mm. In some examples, including any of the foregoing, seal has a wall thickness of 23 mm. In some examples, including any of the foregoing, seal has a wall thickness of 24 mm. In some examples, including any of the foregoing, seal has a wall thickness of 25 mm. In some examples, including any of the foregoing, seal has a wall thickness of 26 mm. In some examples, including any of the foregoing, seal has a wall thickness of 27 mm. In some examples, including any of the foregoing, seal has a wall thickness of 28 mm. In some examples, including any of the foregoing, seal has a wall thickness of 29 mm. In some examples, including any of the foregoing, seal has a wall thickness of 30 mm.

In some examples, including any of the foregoing, seal has a wall thickness of 31 mm. In some examples, including any of the foregoing, seal has a wall thickness of 32 mm. In some examples, including any of the foregoing, seal has a wall thickness of 33 mm. In some examples, including any of the foregoing, seal has a wall thickness of 34 mm. In some examples, including any of the foregoing, seal has a wall thickness of 35 mm. In some examples, including any of the foregoing, seal has a wall thickness of 36 mm. In some examples, including any of the foregoing, seal has a wall thickness of 37 mm. In some examples, including any of the foregoing, seal has a wall thickness of 38 mm. In some examples, including any of the foregoing, seal has a wall thickness of 39 mm. In some examples, including any of the foregoing, seal has a wall thickness of 40 mm.

In some examples, including any of the foregoing, seal has a wall thickness of 41 mm. In some examples, including any of the foregoing, seal has a wall thickness of 42 mm. In some examples, including any of the foregoing, seal has a wall thickness of 43 mm. In some examples, including any of the foregoing, seal has a wall thickness of 44 mm. In some examples, including any of the foregoing, seal has a wall thickness of 45 mm. In some examples, including any of the foregoing, seal has a wall thickness of 46 mm. In some examples, including any of the foregoing, seal has a wall thickness of 47 mm. In some examples, including any of the foregoing, seal has a wall thickness of 48 mm. In some examples, including any of the foregoing, seal has a wall thickness of 49 mm. In some examples, including any of the foregoing, seal has a wall thickness of 50 mm.

In some examples, including any of the foregoing, the seal is bonded to the side of the positive electrode.

In some examples, including any of the foregoing, the liquid electrolyte is sealed within the positive electrode.

In some examples, including any of the foregoing, the electrochemical cell is a coin cell and the seal is a circular ring.

In some examples, including any of the foregoing, the electrochemical cell comprises a disc-shaped solid state electrolyte and a disc-shaped positive electrode, and wherein the diameter of the disc-shaped solid state electrolyte is at least 0.25 times larger than the diameter of the disc-shaped positive electrode.

In some examples, including any of the foregoing, the electrochemical cell is a prismatic cell and the seal is a shape selected from the group consisting of a square frame and a rectangular frame.

In some examples, including any of the foregoing, the solid-state electrolyte is larger than the width of the positive electrode.

In some examples, including any of the foregoing, the solid-state electrolyte is at least 1.1 times larger than the width of the positive electrode.

In some examples, including any of the foregoing, the solid-state electrolyte is larger than the length of the positive electrode.

In some examples, including any of the foregoing, the solid-state electrolyte is at least 0.1 mm larger than the length of the positive electrode.

In some examples, including any of the foregoing, the liquid electrolyte is a gel electrolyte.

In some examples, including any of the foregoing, the liquid electrolyte comprises a lithium salt, a polymer, and a solvent.

In some examples, including any of the foregoing, the lithium salt is selected from the group consisting of LiPF₆, LiBOB, LiBETI, LiTFSi, LiBF₄, LiClO₄, LiAsF₆, LiFSI, LiI, and a combination thereof.

In some examples, including any of the foregoing, the polymer is selected from the group consisting of polyacrylonitrile (PAN), polypropylene, polyethylene oxide (PEO), polymethyl methacrylate (PMMA), polyvinyl chloride (PVC), polyvinyl pyrrolidone (PVP), polyethylene oxide poly(allyl glycidyl ether) PEO-AGE, polyethylene oxide 2-methoxyethoxy)ethyl glycidyl ether (PEO-MEEGE), polyethylene oxide 2-methoxyethoxy)ethyl glycidyl poly(allyl glycidyl ether) (PEO-MEEGE-AGE), polysiloxane, polyvinylidene fluoride (PVDF), polyvinylidene fluoride hexafluoropropylene (PVDF-HFP), ethylene propylene (EPR), nitrile rubber (NPR), styrene-butadiene-rubber (SBR), polybutadiene polymer, polybutadiene rubber (PB), polyisobutadiene rubber (PIB), polyisoprene rubber (PI), polychloroprene rubber (CR), acrylonitrile-butadiene rubber (NBR), polyethyl acrylate (PEA), polyvinylidene fluoride (PVDF), and polyethylene.

In some examples, including any of the foregoing, the solvent is selected from the group consisting of ethylene carbonate (EC), diethylene carbonate or diethyl carbonate (DC), dimethyl carbonate (DMC), ethyl-methyl carbonate (EMC), tetrahydrofuran (THF), γ-Butyrolactone (GBL), fluoroethylene carbonate (FEC), sulfolane, fluoromethyl ethylene carbonate (FMEC), trifluoroethyl methyl carbonate (F-EMC), fluorinated 3-(1,1,2,2-tetrafluoroethoxy)-1,1,2,2-tetrafluoropropane (F-EPE), fluorinated cyclic carbonate (F-AEC), propylene carbonate (PC), dioxolane, acetonitrile (ACN), acetophenone, isophorone, benzonitrile, dimethyl sulfate, prop-1-ene-1,3-sultone (PES), dimethyl sulfoxide (DMSO), ethyl-methyl carbonate, ethyl acetate, methyl butyrate, dimethyl ether (DME), diethyl ether, propylene carbonate, dioxolane, glutaronitrile, gamma butyl-lactone, nitrile solvent is selected from adiponitrile, acetonitrile, benzonitrile, butanedinitrile, butyronitrile, decanenitrile, ethoxyacetonitrile, fluoroacetonitrile, glutaronitrile, hexanenitrile, heptanenitrile, heptanedinitrile, iso-butyronitrile, malononitrile, methoxyacetonitrile, nitroacetonitrile, nonanenitrile, nonanedinitrile, octanedinitrile, octanenitrile, propanenitrile, pentanenitrile, pentanedinitrile, sebaconitrile, succinonitrile, and combinations thereof.

In some examples, including any of the foregoing, the positive electrode comprises a liquid electrolyte which comprises:
a solvent selected from the group consisting of ethylene carbonate (EC), propylene carbonate (PC), dimethyl carbonate (DMC), methylene carbonate, and combinations thereof
a polymer selected from the group consisting of PVDF-HFP and PAN; and
a lithium salt selected from the group consisting of LiPF₆, LiBOB, and

LiTFSi.

In some examples, including any of the foregoing, the positive electrode comprises a liquid electrolyte which comprises:
a lithium salt selected from the group consisting of LiPF₆, LiBOB, LiTFSi, LiBF₄, LiClO₄, LiAsF₆, LiFSI, LiI, and a combination thereof and
a solvent selected from the group consisting of ethylene carbonate (EC), diethylene carbonate, diethyl carbonate, dimethyl carbonate (DMC), ethyl-methyl carbonate (EMC), tetrahydrofuran (THF), γ-Butyrolactone (GBL), fluoroethylene carbonate (FEC), fluoromethyl ethylene carbonate (FMEC), trifluoroethyl methyl carbonate (F-EMC), sulfolane, fluorinated 3-(1,1,2,2-tetrafluoroethoxy)-1,1,2,2-tetrafluoropropane/1,1,2,2-Tetrafluoro-3-(1,1,2,2-tetrafluoroethoxy)propane (F-EPE), fluorinated cyclic carbonate (F-AEC), propylene carbonate (PC), dioxolane, acetonitrile (ACN), succinonitrile, adiponitrile, hexanedinitrile, pentanedinitrile, acetophenone, isophorone, benzonitrile, dimethyl sulfate, dimethyl sulfoxide (DMSO) ethyl-methyl carbonate, ethyl acetate, methyl butyrate, dimethyl ether (DME), diethyl ether, propylene carbonate, dioxolane, glutaronitrile, gamma butyl-lactone, and combinations thereof.

In some examples, including any of the foregoing, the positive electrode further comprises a polymer selected from the group consisting of polyacrylonitrile (PAN), polypropylene, polyethylene oxide (PEO), polymethyl methacrylate (PMMA), polyvinyl chloride (PVC), polyvinyl pyrrolidone (PVP), polyethylene oxide poly(allyl glycidyl ether) PEO-AGE, polyethylene oxide 2-methoxyethoxy)ethyl glycidyl ether (PEO-MEEGE), polyethylene oxide 2-methoxyethoxy)ethyl glycidyl poly(allyl glycidyl ether) (PEO-MEEGE-AGE), polysiloxane, polyvinylidene fluoride (PVDF), polyvinylidene fluoride hexafluoropropylene (PVDF-HFP), rubbers, ethylene propylene (EPR), nitrile rubber (NPR), styrene-butadiene-rubber (SBR), polybutadiene polymer, polybutadiene rubber (PB), polyisobutadiene rubber (PIB), polyisoprene rubber (PI), polychloroprene rubber (CR), acrylonitrile-butadiene rubber (NBR), polyethyl acrylate (PEA), polyvinylidene fluoride (PVDF), polyethylene (e.g., low density linear polyethylene), and combinations thereof.

In some examples, including any of the foregoing, the polymer is polyacrylonitrile (PAN) or polyvinylidene fluoride hexafluoropropylene (PVDF-HFP).

In some examples, including any of the foregoing, the lithium salt is selected from LiPF₆, LiBOB, LiTFSi, and combinations thereof.

In some examples, including any of the foregoing, the lithium salt is LiPF₆ at a concentration of 0.5 M to 2M.

In some examples, including any of the foregoing, the lithium salt is LiTFSI at a concentration of 0.5 M to 2M

In some examples, including any of the foregoing, the lithium is present at a concentration from 0.01 M to 10 M.

In some examples, including any of the foregoing, the solvent is a 1:1 w/w mixture of EC:PC.

In some examples, including any of the foregoing, the positive electrode comprises a lithium intercalation material, a lithium conversion material, or both a lithium intercalation material and a lithium conversion material.

In some examples, including any of the foregoing, the intercalation material is selected from the group consisting of a nickel manganese cobalt oxide (NMC), a nickel cobalt aluminum oxide (NCA), Li(NiCoAl)O₂, a lithium cobalt oxide (LCO), a lithium manganese cobalt oxide (LMCO), a lithium nickel manganese cobalt oxide (LMNCO), a lithium nickel manganese oxide (LNMO), Li(NiCoMn)O₂, LiMn₂O₄, LiCoO₂, and LiMn₂₋ₐNiₐO₄, wherein a is from 0 to 2, or LiMPO₄, wherein M is Fe, Ni, Co, or Mn.

In some examples, including any of the foregoing, the lithium conversion material is selected from the group consisting of FeF₂, NiF₂, FeOₓF₃₋₂ₓ, FeF₃, MnF₃, CoF₃, CuF₂ materials, alloys thereof, and combinations thereof.

In some examples, including any of the foregoing, the first or second layer of the bilayer solid-state electrolyte further comprises a member selected from the group consisting of Tin (Sn), germanium (Ge), arsenic (As), silicon (Si), chlorine (CO, bromine (Br), and a combination thereof.

In some examples, including any of the foregoing, the first layer of the bilayer solid-state electrolyte further comprises a member selected from the group consisting of Tin (Sn), germanium (Ge), arsenic (As), silicon (Si), chlorine (CO, bromine (Br), and a combination thereof.

In some examples, including any of the foregoing, the sulfide in the first layer is selected from the group consisting of xLi₂S:y SiS₂, wherein x and y are each independently a number from 0 to 1, and wherein x+y=1, LSS, LGPS, LSTPS, and LSPS.

In some examples, including any of the foregoing, the second layer is selected from the group consisting of LPSX, wherein X═I, Br, Cl, or F, and LPSX has the formula: aLi₂S:bP₂S₅:cLiX wherein 30≤a≤60, 10≤b≤40, 10≤c≤50.

The electrochemical cell of any one of embodiments 1-18 and 21-46, wherein the solid-state separator is rectangular shaped.

The electrochemical cell of any one of embodiments 1-20 and 26-46, wherein the solid-state separator is disc-shaped.

In some examples, including any of the foregoing, the positive electrode is rectangular shaped.

In some examples, including any of the foregoing, the positive electrode is disc-shaped.

In some examples, including any of the foregoing, the geometric surface area of the positive electrode and the geometric surface area solid-state separator are substantially the same.

In some examples, including any of the foregoing, one edge of the positive electrode layer is 10 cm in length.

In some examples, including any of the foregoing, one edge of the solid-state separator layer is 10 cm in length.

In some examples, including any of the foregoing, the thickness of the positive electrode layer is about 10 μm to about 500 μm.

In some examples, including any of the foregoing, the thickness of the positive electrode layer is about 100 μm.

In some examples, including any of the foregoing, the thickness of the solid-state separator layer is about 10 μm to about 200 μm.

In some examples, including any of the foregoing, the thickness of the solid-state separator layer is about 20 μm.

In some examples, including any of the foregoing, the thickness of the positive electrode current collector or negative electrode current collector is about 5 μm to about 200 μm.

In some examples, including any of the foregoing, the thickness of the positive electrode current collector or negative electrode current collector is about 10 μm.

In some examples, including any of the foregoing, the diameter, length or width of the solid-state electrolyte is greater than the diameter, length or width of the lithium metal negative electrode.

In some examples, including any of the foregoing, the diameter, length or width of the solid-state electrolyte is greater than the diameter, length or width of the positive electrode.

In some examples, including any of the foregoing, the diameter, length or width of the solid-state electrolyte is greater than the diameter, length or width of the negative electrode.

In some examples, including any of the foregoing, the solid-state electrolyte has raised edges.

In some examples, including any of the foregoing, the solid-state electrolyte has tapered edges.

In some examples, including any of the foregoing, the solid-state electrolyte has coated edges.

In some examples, including any of the foregoing, the coated edges comprise a coating selected from parylene, polypropylene, polyethylene, alumina, Al₂O₃, ZrO₂, TiO₂, SiO₂, a binary oxide, La₂Zr₂O₇, a lithium carbonate species, and a glass, wherein the glass is selected from SiO₂—B₂O₃, or Al₂O₃.

In some examples, including any of the foregoing, the positive or negative electrode current collector is made of a material selected from the group consisting of carbon (C)-coated nickel (Ni), nickel (Ni), copper (Cu), aluminum (Al), stainless steel, Palladium (Pd), and Platinum (Pt).

In some examples, including any of the foregoing, the positive electrode current collector is an Al metal current collector.

In some examples, including any of the foregoing, the positive electrode current collector is an C-coated Ni metal current collector.

In some examples, set forth herein is a rechargeable battery comprising an electrochemical cell set forth herein.

In some examples, set forth herein is an electric vehicle comprising a rechargeable battery set forth herein.

In some examples, set forth herein is a process for making an electrochemical cell, comprising: providing a bilayer solid-state electrolyte having a first layer comprising a sulfide and a second layer comprising a lithium phosphorus sulfur halide on a substrate; wherein the second layer is in direct contact with the substrate;
providing a first seal around and in contact with the bilayer solid-state electrolyte;
   wherein the seal covers the edges of the solid-state electrolyte;
providing a positive electrode comprising a liquid electrolyte on top of the solid-state electrolyte;
pressing the positive electrode comprising a liquid electrolyte onto the solid-state electrolyte and first seal;
applying a second seal around the first seal; and
applying at least 3 pounds per square inch (PSI) to the electrochemical cell.

In some examples, including any of the foregoing, the sulfide in the first layer is a lithium silicon sulfide.

In some examples, including any of the foregoing, the substrate is heated to at least 50° C.

In some examples, including any of the foregoing, prior to providing a positive electrode comprising a liquid electrolyte on top of the solid-state electrolyte, the process comprises providing a gel electrolyte on top of the solid-state electrolyte.

In some examples, including any of the foregoing, the first seal is made of PIB.

In some examples, including any of the foregoing, the second seal is made of polyether ether ketone (PEEK)

In some examples, including any of the foregoing, the substrate is a negative electrode current collector.

In some examples, including any of the foregoing, the first layer is in direct contact with the positive electrode;

In some examples, including any of the foregoing, casting comprises flowing the second seal.

In some examples, including any of the foregoing, the seal material is impermeable to the liquid electrolyte and seals the interface between the positive electrode current collector and the positive electrode and the interface between the positive electrode and the first layer of the bilayer solid-state electrolyte.

### XI. Examples

Reagents, chemicals, and materials were commercially purchased unless specified otherwise to the contrary.

Pouch cell containers were purchased from Showa Denko.

The Electrochemical potentiostat used was Arbin potentiostat. Electrical impedance spectroscopy (EIS) was performed with a Biologic VMP3, VSP, VSP-300, SP-150, or SP-200.

### Example 1 Making an Electrochemical Cell Having a Solid Electrolyte

A series of electrochemical cells were prepared as follows.

First, a solid-state electrolyte film of lithium-stuffed garnet was prepared.

Operation 1: A cubic phase lithium-stuffed garnet powder, characterized as Li₇La₃Zr₂O₁₂—(X)Al₂O₃, wherein X is from 0 to 1 (i.e., of lithium-stuffed garnet), was prepared. A mixture of chemical precursors to Li₇La₃Zr₂O₁₂—(X)Al₂O₃, wherein X is from 0 to 1, was provided in a non-aqueous solvent and then dried to from a powder. The powder was calcined to form cubic phase Li₇La₃Zr₂O₁₂—(X)Al₂O₃, wherein Xis from 0 to 1.

Operation 2: Green films were prepared by casting a slurry which included the calcined cubic phase Li₇La₃Zr₂O₁₂—(X)Al₂O₃, wherein X is from 0 to 1, prepared in Operation 1. The resulting green films were sintered at above 800° C. for 4-24 hours to yield sintered films of 10 μm-200 μm thickness.

Operation 3: Lithium metal was applied to one side of the sintered film of lithium-stuffed garnet. The thickness of the applied lithium metal was 6 μm-90 μm.

The resulting sintered film of lithium-stuffed garnet with lithium metal applied to one side was assembled into a variety of electrochemical cell formats, each electrochemical cell having a cathode and a catholyte in the cathode. The cathodes each had 4 mAh/cm² loading of active material on aluminum foil; the cathode active region was 90-120 μm thick and had approximately 70 vol % active material of NMC 622 with particle size dso 6 μm-20 μm. The catholyte included a carbon additive and PVDF-HFP and PVDF polymers as binders. The cathode was calendered and swollen with a liquid electrolyte catholyte comprising the solvent ethylene-carbonate and 1M LiPF₆. A nickel foil negative electrode current collector was attached to the lithium metal anode. In some electrochemical cells, a PEEK seal was applied around the cathode to contain the catholyte in the cathode. The electrochemical cells with a seal included either (a) 100 μm thick PEEK ring of 22 mm outer diameter and 6 mm inner diameter around the cathode making a face seal to the separator; of (b) a PEEK ring of 22 mm outer diameter and 11 mm inner diameter making an edge seal to the separator. PEEK rings were adhered using a polyolefin primer/adhesive. The electrochemical stack was vacuum sealed inside a pouch cell with tabs leading outside the pouch cell and pressurized for electrochemical testing.

### Example 2 Testing an Electrochemical Cell Having a Cathode Seal

The series of electrochemical cells from Example 1 were tested as follows.

The cells were cycled at C/3 rate, at 45° C. for 60 cycles.

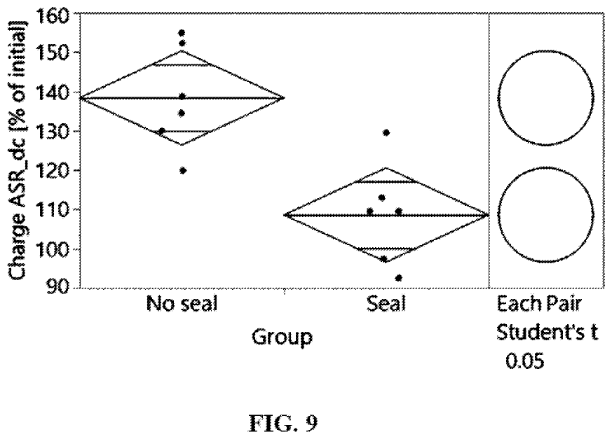

The cells were analysed using electrical impedance spectroscopy (EIS). The cells with a PEEK seal had markedly lower increase in area-specific resistance (ASR) over the first ten cycles when compared to cells that had no seal, as shown in FIG. 9. The samples with a seal had an average of 10% increase in resistance, while the samples without a seal had an average of nearly 40% increase in resistance; a statistical comparison of samples in this test showed highly significant results (p=0.0014).

### Example 3 Making an Electrochemical Cell Having a Cathode Seal for a Bilayer Solid-State Electrolyte

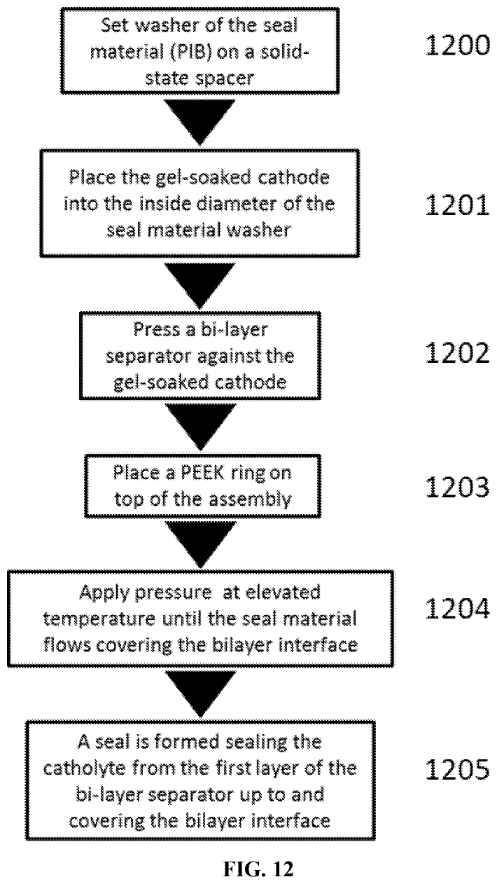

Referring to FIG. 12, an exemplary electrochemical cell is made by the following method: in operation 1 (1200 in FIG. 12), a washer of seal material (PIB) is set on a solid-state (SS) spacer. In operation 2 (1201 in FIG. 12), a cathode (with added liquid electrolyte, i.e., gel-soaked) is placed into the inside diameter of the seal material washer on the SS spacer. In operation 3 (1202 in FIG. 12), a bi-Layer LSS/LPSI separator is pressed against the gel-soaked cathode and seal washer on the SS plate. In operation 4 (1203 in FIG. 12), a PEEK ring is placed on top of the assembly. In operation 5 (1204 in FIG. 12), a weight (e.g., 3 lbs) is placed on the assembly at elevated temperature (e.g., 50° C.). The PEEK displaces the seal material (PIB) between the PEEK and bilayer separator. Displaced seal material (PIB) flows past LPSI/LSS interface, forming a seal in the last operation ((1205 in FIG. 12)).

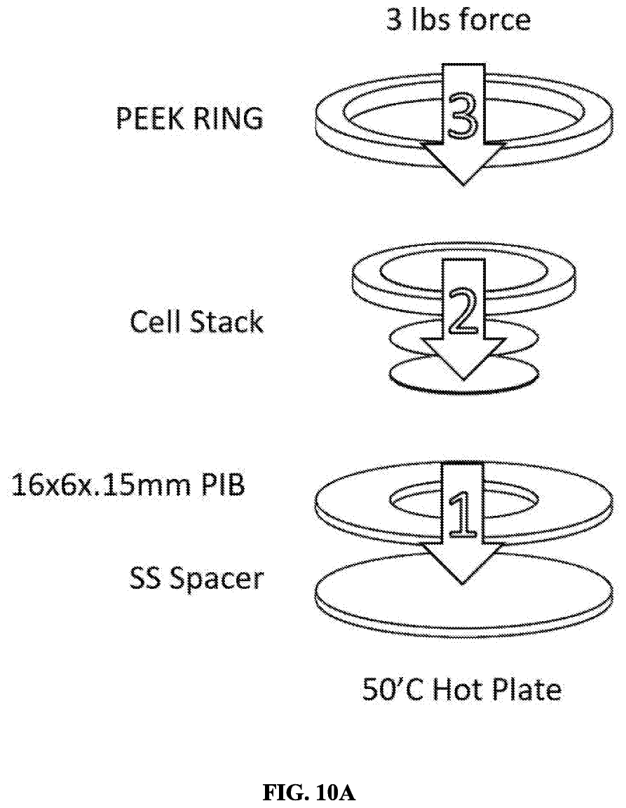

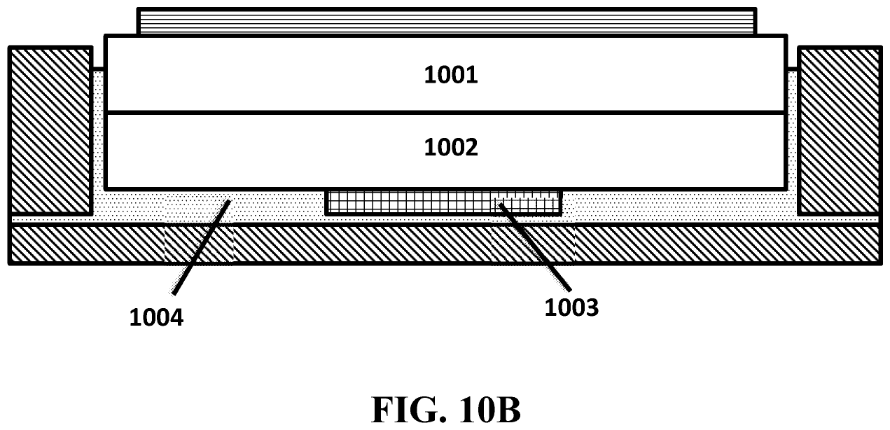

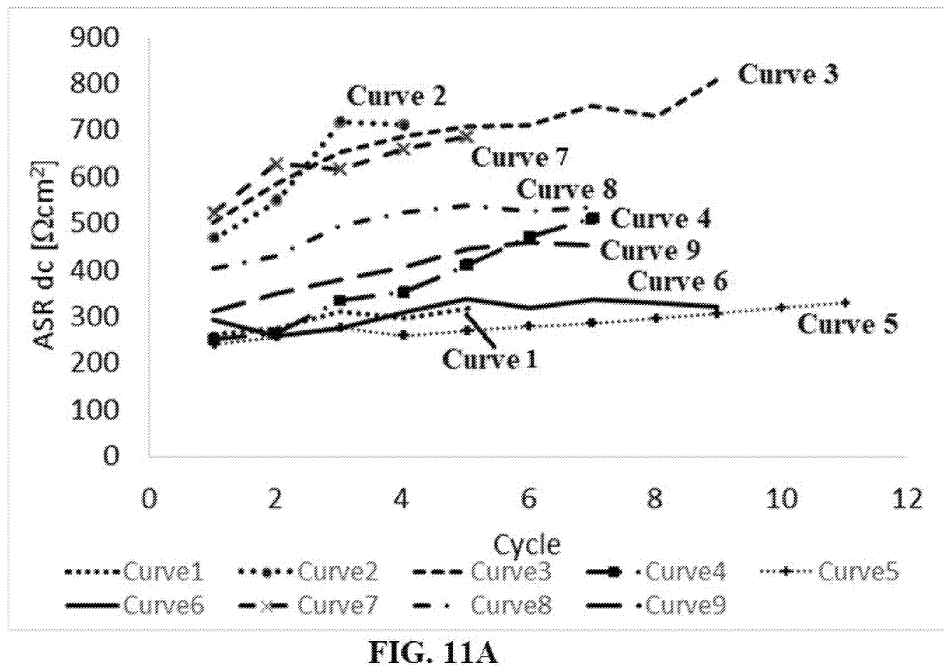

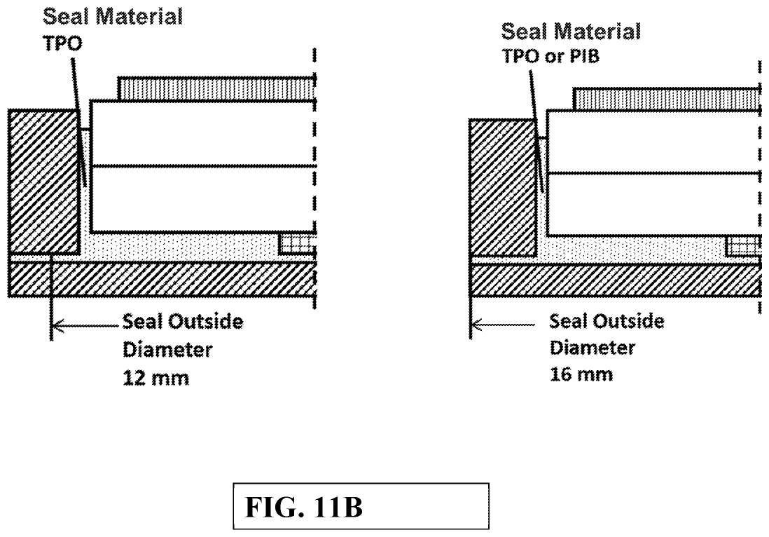

This results in a seal which seals the liquid electrolyte in the cathode from leaking around the solid state electrolyte. The seal contains the liquid electrolyte by sealing the perimeter of the adjoining faces of the cathode and bi-layer LSS/LPSI separator. This seal is shown in FIG. 10B and FIG. 11B. FIG. 10B shows a bi-layer LSS/LPSI separator which is labeled 1001/1002. 1001 is LPSI and 1002 is LSS. In direct contact with the LSS, 1002, is a cathode with a gel catholyte, labeled as 1003. Sealing this cathode is seal 1004. Seal 1004 seals the edge of the cathode with the liquid electrolyte in the cathode. Seal 1004 also seals the face of LSS, 1002. Seal 1004 also seals the interface between LSS, 1002, and LPSI, 1001.

A related process is shown in FIG. 10A. In FIG. 10A, a washer of seal material (PIB) is set on a solid-state (SS) spacer. A gel cathode (with added liquid electrolyte) is placed into the inside diameter of the seal material washer on the SS spacer. A bi-Layer separator is pressed against the gel-soaked cathode and seal washer on the SS plate. This forms the Cell Stack in Example 3. A PEEK ring is placed on top of the assembly. A weight (e.g., 3 lbs) is then placed on the assembly at elevated temperature (e.g., 50° C.).

### Example 4 Using an Electrochemical Cell Having a Cathode Seal for a Bilayer Solid-State Electrolyte

A series of electrochemical cells were prepared according to the process in Example 3 and FIG. 12. In one configuration, the seal material washer was a thermoplastic olefin (TPO). In a second configuration, the seal material washer was PIB. The seal outside diameter was either 12 mm or 16 mm. These configurations are shown in FIG. 11B. Each electrochemical cell included the following: The cathode included NMC active material and was 100 μm thick. The anode was lithium metal that was 30 μm thick. The cathode included 200 μl of a liquid electrolyte catholyte that included 1.0 M LiPF₆ in 3:7 EC:EMC (vol)+2 wt % FEC.

The electrochemical cells were tested according to the following protocol.

The pellet cell was electrochemically cycled on an Arbin instrument, between 3.2-4.2V (v. Li metal). The electrochemical stack was discharged and charged at current rates of C/10, with current applied for a 40 minute pulse with a 10 minute rest, and a maximum of a 1 hour hold at the top of charge. The electrochemical cycling was performed at 45° C.

Voltage and impedance were monitored during the test. A plot of area-specific resistance (ASR) as a function of cycle number is shown in FIG. 11A. The TPO-12 mm-sample's performance is show in curve 1. TPO-16 mm-sample performance is show in curve 2, curve 3, and curve 4. PIB-16 mm-sample performance is show in curves 5 and 6. TPO 12 mm sample performance is show in curve 7, curve 8, and curve 9.

The embodiments and examples described above are intended to be merely illustrative and non-limiting. Those skilled in the art will recognize or will be able to ascertain using no more than routine experimentation, numerous equivalents of specific compounds, materials and procedures. All such equivalents are considered to be within the scope and are encompassed by the appended claims.

What is claimed is:

1. An electrochemical stack, comprising a solid-state electrolyte;
a positive electrode comprising a liquid electrolyte or a gel electrolyte;
a positive electrode current collector; and
a seal impermeable to the liquid electrolyte or the gel electrolyte that bonds to the positive electrode current collector and to the solid-state electrolyte.

2. The electrochemical stack of claim 1, wherein the seal contains the liquid electrolyte or the gel electrolyte in the positive electrode.

3. The electrochemical stack of claim 1 or 2, wherein the solid-state electrolyte is impermeable to the liquid electrolyte or the gel electrolyte.

4. The electrochemical stack of any one of claims 1-3, wherein the solid-state electrolyte has tapered edges.

5. An electrochemical cell comprising at least one or more electrochemical stacks of any one of claims 1-4.

6. An electrochemical cell, comprising:
a container;
at least one electrochemical stack in the container, the electrochemical stack comprising at least:
a solid-state electrolyte;
a positive electrode comprising a liquid electrolyte or a gel electrolyte;
a positive electrode current collector; and
a seal impermeable to the liquid electrolyte or the gel electrolyte that bonds to the positive electrode current collector and to the solid-state electrolyte, wherein the seal is not bonded to the container.

7. The electrochemical cell of claim 6, wherein the seal comprises a material selected from the group consisting of polyisobutylene (PIB), polyether ether ketone (PEEK), polypropylene (PP), a polyolefin, and combinations thereof.

8. The electrochemical cell of claim 6 or 7, wherein the seal comprises a top layer and a bottom layer, and wherein the top layer of the seal and the bottom layer of the seal comprise the same material.

9. The electrochemical cell of claim 8, wherein the seal further comprises a middle layer, and wherein the middle layer of the seal is a different material than the top layer or bottom layer.

10. The electrochemical cell of claim 8 or 9, wherein the top layer and the bottom layer comprise PIB.

11. A battery comprising at least one electrochemical cell of any one of claims 6-10.

12. The electrochemical cell of any one of claims 6-11, wherein the seal has a hardness of 30-150 durometer.

13. A device comprising an electrochemical cell of any one of claim 6-12.

14. A method of making an electrochemical cell, comprising:
providing a positive electrode current collector and an electrochemical cell stack on a substrate;
applying a seal material on to the positive electrode current collector;
wherein the electrochemical stack comprises:
a solid-state electrolyte;
a positive electrode comprising a liquid electrolyte or a gel electrolyte;
wherein the seal material is impermeable to the liquid electrolyte or the gel electrolyte, and wherein the seal material bonds to the positive electrode current collector and to the solid-state electrolyte;
enclosing the cell stack within a pressure ring; and
applying at least 3 pounds per square inch (PSI) to the electrochemical cell.

15. The method of claim 14, wherein the electrochemical stack further comprises a negative electrode current collector.

16. The method of claim 14 or 15, wherein the electrochemical stack further comprises a lithium metal negative electrode.

17. The method of any one of claims 14-16, comprising applying the seal material after assembling the electrochemical stack.

18. The method of any one of claims 14-17, wherein applying the seal material comprises spraying the seal material.

19. The method of any one of claims 14-17, wherein applying the seal material comprises coating the seal material.

20. The method of any one of claims 14-17, wherein applying the seal material is comprises injection molding.

21. The method of claim 20, wherein the injection molding occurs at a pressure lower than atmospheric pressure.

22. The method of claim 21, wherein the injection molding occurs at a minimum pressure of 0.00001 atm.

23. The method of any one of claims 14-22, wherein the seal material is in contact with the solid-state electrolyte.

24. The method of any one of claims 14-23, wherein the seal material is selected from the group consisting of polyisobutylene (PIB), polyether ether ketone (PEEK), polypropylene, a polyolefin, and combinations thereof.

25. The method of any one of claims 14-23, wherein the seal material is selected from the group consisting of polyisobutylene (PIB), polyether ether ketone (PEEK), and combinations thereof.

26. The method of any one of claims 14-25, wherein the pressure ring comprises polyether ether ketone (PEEK).

27. The method of any one of claims 14-26, comprising heating the substrate to at least 50° C.

28. A method of making an electrochemical cell, comprising:
providing a positive electrode current collector on a substrate;
applying a seal material on the positive electrode current collector;
providing a pressure ring;
providing an electrochemical stack on the seal material and within the pressure ring,
wherein the electrochemical stack comprises:
a solid-state electrolyte;
a positive electrode comprising a liquid electrolyte or a gel electrolyte; and
wherein the seal material is impermeable to the liquid electrolyte or the gel electrolyte that bonds to the positive electrode current collector and to the solid-state electrolyte; and
applying at least 3 pounds per square inch (PSI) to the electrochemical cell.

29. The method of claim 28, wherein the pressure ring comprises polyether ether ketone (PEEK).

30. The method of claim 28 or 29, wherein the electrochemical stack further comprises a negative electrode current collector.

31. The method of any one of claims 28-30, wherein the electrochemical stack further comprises a lithium metal negative electrode.
